(19) United States
(12) Patent Application Publication
(10) Pub. No.: US 2014/0025605 A1
(43) Pub. Date: Jan. 23, 2014

(54) DATABASE FOR RISK DATA PROCESSING

(71) Applicant: Transcon Securities Pty Ltd, Melbourne (AU)

(72) Inventor: Geoffrey Gordon Salter, South Yarra (AU)

(73) Assignee: Transcon Securities Pty Ltd, Melbourne (AU)

(21) Appl. No.: 14/034,022

(22) Filed: Sep. 23, 2013

Related U.S. Application Data
(63) Continuation of application No. 11/628,379, filed on Jul. 18, 2007.

(30) Foreign Application Priority Data
Jun. 1, 2004 (AU) 2004903030
Jun. 11, 2004 (AU) 2004903040

(51) Int. Cl. G06Q 40/06

(52) U.S. Cl. CPC G06Q 40/06
USPC 705/36 R

(57) ABSTRACT

A database system for risk data processing is disclosed. The database system includes a database storage configured to store a group of data items stored in a first portion of the database and one or more benchmark sets of data items stored in a second portion of the database storage. The system further includes a database interface configured to provide access to the database storage. The system also includes a processor configured to perform risk data processing.

### CROSS REFERENCE TO RELATED APPLICATIONS

This application is a continuation of U.S. patent application Ser. No. 11/628,379 filed on Jul. 18, 2007 which claims priority to and is a U.S. National Phase filing of PCT International Application Number PCT/AU2005/000776, filed on Jun. 1, 2005, designating the United States of America and published in the English language, which claims priority under 35 U.S.C. §119 to Australian Patent Application Number 2004903030, filed on Jun. 1, 2004 and to Australian Patent Application Number 2004903040, filed on Jun. 11, 2004. The disclosures of the above-described applications are hereby expressly incorporated by reference in their entireties. Any and all priority claims identified in the Application Data Sheet, or any correction thereto, are hereby incorporated by reference under 37 C.F.R. §1.57.

### BACKGROUND

1. Field

The present invention relates to a database for processing risk data.

2. Description of Related Technology

Risk is involved in any decision when the outcome of that decision is not certain. Different people are comfortable with different levels of risk. A person's risk tolerance is the level of risk within which he or she is comfortable in making a decision.

Risk aversion typically prevents an investor, for example, from achieving what they would have otherwise achieved if the outcome of a financial decision was certain. Conversely, risk aversion typically prevents a person from exposing themselves to levels of risk beyond his or her risk tolerance level. An investor, for example, thereby faces a double challenge. Firstly, in making an accurate and meaningful assessment of their willingness to accept risk as they perceive it. Secondly, in evaluating both what he already has in place and the alternatives now offered to him in terms of his risk tolerance.

Financial planners, for example, can assist in making investment decisions that maximize financial gain whilst not exceeding a risk tolerance level. In order to properly do this, the financial planner needs to assess the risk tolerance of the investor and make financial decisions that achieve good results without exceeding the risk tolerance of the investor. Making an accurate assessment of an individual's risk tolerance is a challenge because of the intangible nature of the attitudes, value, motivation and preferences it entails and because of the potential for miscommunication when discussing such intangibles. For example, an investor may be disappointed when they miss out on an opportunity to make money because the financial planner determined that an investment was beyond their risk tolerance level when, in fact, the investor would have taken the risk if their risk tolerance level was better understood.

Master Trusts and Wrap Account are examples of software platforms that financial planners typically use to assist them in making decisions on their client's investment portfolios. These software platforms provide qualitative and quantitative analysis tools for financial planners and offer services such as:
1. Client basic database systems;
2. Portfolio constructions of fund managers;
3. Investment research on underlying fund managers;
4. Back room administrative service;
5. Monthly newsletter;
6. Consolidation of client's reports; and
7. Custodial collection of asset based fees.

The mentioned software platforms may not adequately address the above-described double challenge of an investor.

### SUMMARY OF CERTAIN INNOVATIVE ASPECTS

It is generally desirable to overcome, or ameliorate, one or more of the above described disadvantages, or to at least provide a useful alternative.

In accordance with another aspect of the present invention, there is provided a system for analysing risk associated with an investment portfolio of an investor, said system including means for use in generating a user interface for display on a user terminal, said user interface showing a distribution of assets of each investment of the investment portfolio over one or more asset classes and showing the distribution of assets over said one or more asset classes of a benchmark risk category representing the risk tolerance level of the investor.

Preferably, each asset class of the one or more asset classes of a distribution of assets of an investment is shown as a proportion of the investor's assets allocated to the respective investment.

Preferably, said user interface shows the sum of the distribution of assets in each asset class of said asset classes of the investments of the investment portfolio.

In accordance with another aspect of the present invention, there is provided a system for managing an investment portfolio of an investor, said system including the above described system for analysing and including means for use in addling an investment to investment portfolio.

In accordance with another aspect of the present invention, there is provided a system for managing an investment portfolio of an investor, said system including the above described system for analysing and including means for use in removing an investment from the investment portfolio.

In accordance with another aspect of the present invention, there is provided a system for creating an investment portfolio for an investor, said system for performing the steps of: (a) categorizing the investor as one of a plurality of benchmark risk categories; (b) generating user interface data for display of a user interface on a user terminal, the user interface showing a plurality of investments and including means for selecting investments for inclusion in the investment portfolio; (c) generating further user interface data for display of another user interface on said user terminal, said another user interface showing the distribution of assets of each investment of the investment portfolio over one or more asset classes and also showing a distribution of assets over said one or more asset classes of said benchmark risk category representing the risk tolerance level of the investor.

Preferably, each asset class of the one or more asset classes of a distribution of assets of an investment is shown as a proportion of the investor's assets allocated to the respective investment.

In accordance with another aspect of the present invention, there is provided a computer program for analysing risk associated with an investment portfolio of an investor, said program for performing the step of generating a user interface for display on a user terminal, said user interface showing the distribution of assets of each investment of the investment portfolio over one or more asset classes and also showing a distribution of assets over said one or more asset classes of a benchmark risk category representing the risk tolerance level of the investor.

Preferably, each asset class of the one or more asset classes of a distribution of assets of an investment is shown as a proportion of the investor's assets allocated to the respective investment.

Preferably, said user interface shows the sum of the distribution of assets in each asset class of said asset classes of the investments of the investment portfolio.

In accordance with another aspect of the present invention, there is provided a computer program for managing an investment portfolio of an investor, said computer program for performing the steps of the above described computer program and performing the step of addling an investment to investment portfolio.

In accordance with another aspect of the present invention, there is provided a computer program for managing an investment portfolio of an investor, said computer program for performing the steps of the above described computer program and performing the step of removing an investment from the investment portfolio.

In accordance with another aspect of the present invention, there is provided a computer program for creating an investment portfolio for an investor, said computer program for performing the steps of: (a) categorizing the investor as one of a plurality of benchmark risk categories; (b) generating user interface data for display of a user interface on a user terminal, the user interface showing a plurality of investments and including means for selecting investments for inclusion in the investment portfolio; (c) generating further user interface data for display of another user interface on said user terminal, said another user interface showing the distribution of assets of each investment of the investment portfolio over one or more asset classes and also showing the distribution of assets over said one or more asset classes of said benchmark risk category representing the risk tolerance level of the investor.

In accordance with another aspect of the present invention, there is provided a computer readable data storage medium, including the above described computer program stored thereon.

In accordance with one aspect of the present invention, there is provided a method of analysing risk associated with an investment portfolio of an investor, including the steps of: (a) arranging investments of the investment portfolio to show a distribution of assets of each investment of said investments over one or more asset classes; and (b) determining the degree to which the distribution of assets over said one or more asset classes of said investments corresponds to the distribution of assets over said one or more asset classes of a benchmark risk category representing the risk tolerance level of the investor.

Preferably, each asset class of the one or more asset classes of a distribution of assets of an investment is shown as a proportion of the investor's assets allocated to the respective investment.

Preferably, said step of determining includes the step of determining the degree to which the sum of the distribution of assets in each asset class of said asset classes of the investments of the investment portfolio corresponds to the distribution of assets over each corresponding asset class of the asset classes of the benchmark risk category.

In accordance with another aspect of the present invention, there is provided a method of managing an investment portfolio of an investor, including the steps of: (a) analysing the risk associated with the investment portfolio by performing the above described method; and (b) changing one or more of the investments in response to said step of analysing so that the distribution of assets over said one or more asset classes of said investments of the investment portfolio corresponds more closely, or less closely, to the distribution of assets over said one or more asset classes of the benchmark risk category of the investor.

In accordance with another aspect of the present invention, there is provided a method of managing an investment portfolio of an investor, including the steps of: (a) analysing the risk associated with the investment portfolio by performing the above described method of analysing; and (b) changing the proportion of investor's assets allocated to each investment of the investment portfolio so that the distribution of assets over said one or more asset classes of said investments corresponds more closely, or less closely, to the distribution of assets over said one or more asset classes of the benchmark risk category of the investor.

In accordance with another aspect of the present invention, there is provided a method of creating an investment portfolio for an investor, including the steps of: (a) categorizing the investor as one of a plurality of benchmark risk categories; (b) selecting a plurality of investments for the investment portfolio; and (c) analysing the risk associated with the investment portfolio by performing the above described method of analysing, wherein said one of a plurality of benchmark risk categories represents to the risk tolerance level of the investor.

In accordance with another aspect of the present invention, there is provided a method of creating an investment portfolio for an investor, including the steps of: (a) categorizing the investor as one of a plurality of benchmark risk categories; (b) selecting a plurality of investments for the investment portfolio; and (c) managing the investment portfolio by performing the above described method of managing, wherein said one of a plurality of benchmark risk categories represents to the risk tolerance level of the investor.

In accordance with yet another aspect of the invention, there is provided An analysis process, including comparing a distribution of assets of investments of an investment portfolio over one or more asset classes with a distribution of assets over said one or more asset classes associated with a benchmark risk category representing a risk tolerance level of the investor.

Advantageously, preferred embodiments of the present invention reduce risk involved in financial planning by increasing an investor's understanding of the level of risk associated with their investment portfolio.

### BRIEF DESCRIPTION OF THE DRAWINGS

Preferred embodiments are hereafter described, by way of non-limiting example only, with reference to the accompanying drawings in which:

FIG. 1 is a diagrammatic illustration of a preferred embodiment of the financial management system connected to a network;

FIG. 2 is a diagrammatic illustration of the financial management system shown in FIG. 1;

FIG. 3 is a diagrammatic illustration of the director and file structure of the web application of the financial management system shown in FIG. 1;

FIG. 4 is a dataflow diagram of the financial management system shown in FIG. 1;

FIG. 5 is a dataflow diagram of preferred embodiment of a financial management system for managed funds;

FIG. 6 is flow diagram showing steps executed by the financial management system shown in FIG. 5;

FIG. 7 is a flow diagram of the risk profile interface of the financial management system shown in FIG. 5;

FIG. 8 is a screen shot of the performance spreadsheet generated by the financial management system shown in FIG. 5;

FIG. 9 is a screen shot of the performance spreadsheet generated by the financial management system shown in FIG. 5;

FIG. 10 is a screen shot of the performance spreadsheet generated by the financial management system shown in FIG. 5;

FIG. 11 is a screen shot of the performance spreadsheet generated by the financial management system shown in FIG. 5;

FIG. 12 is a screen shot of the performance spreadsheet generated by the financial management system shown in FIG. 5;

FIG. 13 is a screen shot of the performance spreadsheet generated by the financial management system shown in FIG. 5;

FIG. 14 is a screen shot of the performance spreadsheet generated by the financial management system shown in FIG. 5;

FIG. 15 is a screen shot of the risk and asset allocation spreadsheet generated by the financial management system shown in FIG. 5;

FIG. 16 is a screen shot of the risk and asset allocation spreadsheet generated by the financial management system shown in FIG. 5;

FIG. 17 is a screen shot of the risk and asset allocation spreadsheet generated by the financial management system shown in FIG. 5;

FIG. 18 is a screen shot of the risk and asset allocation spreadsheet generated by the financial management system shown in FIG. 5;

FIG. 19 is a screen shot of the risk and asset allocation spreadsheet generated by the financial management system shown in FIG. 5;

FIG. 20 is a screen shot of the risk and asset allocation spreadsheet generated by the financial management system shown in FIG. 5;

FIG. 21 is a screen shot of the risk and asset allocation spreadsheet generated by the financial management system shown in FIG. 5;

FIG. 22 is a screen shot of the portfolio construction interface generated by the financial management system shown in FIG. 5;

FIG. 23 is a screen shot of the portfolio construction interface shown in FIG. 22;

FIG. 24 is a screen shot of the forecast interface generated by the financial management system shown in FIG. 5;

FIG. 25 is a screen shot generated by the financial management system shown in FIG. 5 showing fund managers ranked in accordance with a performance indicator;

FIG. 26 is a screen shot generated by the financial management system shown in FIG. 5 showing fund managers ranked in accordance with a performance indicator;

FIG. 27 is a screen shot generated by the financial management system shown in FIG. 5 showing fund managers ranked in accordance with a performance indicator;

FIG. 28 is a screen shot generated by the financial management system shown in FIG. 5 showing fund managers ranked in accordance with a risk indicator;

FIG. 29 is a screen shot generated by the financial management system shown in FIG. 5 showing fund managers ranked in accordance with a risk indicator;

FIG. 30 is a screen shot generated by the financial management system shown in FIG. 5 showing fund managers ranked in accordance with a risk indicator;

FIG. 31 is a screen shot generated by the financial management system shown in FIG. 5 showing fund managers ranked in accordance with a statistical analysis indicator;

FIG. 32 is a screen shot generated by the financial management system shown in FIG. 5 showing fund managers ranked in accordance with a statistical analysis indicator;

FIG. 33 is a screen shot generated by the financial management system shown in FIG. 5 showing fund managers ranked in accordance with a statistical analysis indicator;

FIG. 34 is a screen shot generated by the financial management system shown in FIG. 5 showing fund managers ranked in accordance with a statistical analysis indicator;

FIG. 35 is a flow diagram showing the flow of code involved in the portfolio construction interface shown in FIG. 22;

FIG. 36 is a screen shot of a portfolio construction interface generated by an alternative embodiment of the financial management system shown in FIG. 5;

FIG. 37 is a screen shot of an Analyst's Report Interface generated by the alternative financial management system shown in FIG. 36;

FIG. 38 is a screen shot of an Income Yield Report Interface generated by the alternative financial management system shown in FIG. 36;

FIG. 39 is a screen shot of a Market Watch Interface generated by the alternative financial management system shown in FIG. 36;

FIG. 40 is a screen shot of another Market Watch Interface generated by the alternative financial management system shown in FIG. 36;

FIG. 41 is a graphical representation of a macro economic indicator generated by a Macro Economic Forecasting Interface of an alternative embodiment of the financial management system;

FIG. 42 is another graphical representation of a macro economic indicator generated by a Macro Economic Forecasting Interface of an alternative embodiment of the financial management system;

FIG. 43 is another graphical representation of a macro economic indicator generated by a Macro Economic Forecasting Interface of an alternative embodiment of the financial management system;

FIG. 44 is another graphical representation of a macro economic indicator generated by a Macro Economic Forecasting Interface of an alternative embodiment of the financial management system;

FIG. 45 is another graphical representation of a macro economic indicator generated by a Macro Economic Forecasting Interface of an alternative embodiment of the financial management system;

FIG. 46 is another graphical representation of a macro economic indicator generated by a Macro Economic Forecasting Interface of an alternative embodiment of the financial management system;

FIG. 47 is another graphical representation of a macro economic indicator generated by a Macro Economic Forecasting Interface of an alternative embodiment of the financial management system;

FIG. 48 is a screen shot of a Selection Spreadsheet Interface generated by an alternative embodiment of the financial management system shown in FIG. 5;

FIG. 49 is a screen shot of a Portfolio construction Interface generated by the alternative embodiment of the financial management system of FIG. 48;

FIG. 50 is a screen shot of a Selection Spreadsheet Interface generated by an alternative embodiment of the financial management system shown in FIG. 5;

FIG. 51 is a screen shot of a Portfolio construction Interface generated by the alternative embodiment of the financial management system of FIG. 50;

FIG. 52 is a screen shot of a further part of the Portfolio construction Interface shown in FIG. 51;

FIG. 53 is a screen shot of a questionnaire generated by another preferred embodiment of the computer system;

FIG. 54 is another screen shot of the questionnaire shown in FIG. 53;

FIG. 55 is yet another screen shot of the questionnaire shown in FIG. 53;

FIG. 56 is yet another screen shot of the questionnaire shown in FIG. 53;

FIG. 57 is yet another screen shot of the questionnaire shown in FIG. 53;

FIG. 58 is yet another screen shot of the questionnaire shown in FIG. 53;

FIG. 59 is yet another screen shot of the questionnaire shown in FIG. 53;

FIG. 60 is yet another screen shot of the questionnaire shown in FIG. 53;

FIG. 61 is yet another screen shot of the questionnaire shown in FIG. 53;

FIG. 62 is yet another screen shot of the questionnaire shown in FIG. 53;

FIG. 63 is a screen shot of a results display generated by the computer system;

FIG. 64 is a screen shot of a Funds display of a Portfolio display generated by the computer system;

FIG. 65 is another screen shot of the Funds display shown in FIG. 64;

FIG. 66 is another screen shot of the Funds display shown in FIG. 64;

FIG. 67 is another screen shot of the Funds display shown in FIG. 64;

FIG. 68 is another screen shot of the Funds display shown in FIG. 64;

FIG. 69 is another screen shot of the Funds display shown in FIG. 64;

FIG. 70 is another screen shot of the Funds display shown in FIG. 64;

FIG. 71 is another screen shot of the Funds display shown in FIG. 64;

FIG. 72 is another screen shot of the Funds display, shown in FIG. 64;

FIG. 73 is another screen shot of the Funds display shown in FIG. 64;

FIG. 74 is another screen shot of the Funds display shown in FIG. 64;

FIG. 75 is another screen shot of the Funds display shown in FIG. 64;

FIG. 76 is another screen shot of the Funds display shown in FIG. 64;

FIG. 77 is another screen shot of the Funds display shown in FIG. 64;

FIG. 78 is another screen shot of the Funds display shown in FIG. 64;

FIG. 79 is a screen shot of a Shares display of the portfolio display shown in FIG. 64;

FIG. 80 is another screen shot of the Shares display shown in FIG. 79;

FIG. 81 is another screen shot of the Shares display shown in FIG. 79;

FIG. 82 is another screen shot of the Shares display shown in FIG. 79;

FIG. 83 is a screen shot of a Macro display page of the portfolio display shown in FIG. 64;

FIG. 84 is a screen shot of another Macro display page of the portfolio display shown in FIG. 64;

FIG. 85 is a screen shot of another Macro display page of the portfolio display shown in FIG. 64;

FIG. 86 is a screen shot of another Macro display page of the portfolio display shown in FIG. 64;

FIG. 87 is a screen shot of an asset allocation display of the portfolio construction interface of the portfolio display shown in FIG. 64;

FIG. 88 is another screen shot of the asset allocation display shown in FIG. 87;

FIG. 89 is another screen shot of the asset allocation display shown in FIG. 87;

FIG. 90 is a screen shot of a client profile display of the portfolio construction interface of the portfolio display shown in FIG. 64;

FIG. 91 is another screen shot of the client profile display shown in FIG. 90;

FIG. 92 is another screen shot of the client profile display shown in FIG. 90;

FIG. 93 is a screen shot of a Fee Structure display of the portfolio construction interface of the portfolio display shown in FIG. 64;

FIG. 94 is another screen shot of the Fee Structure display shown in FIG. 93;

FIG. 95 is another screen shot of the Fee Structure display shown in FIG. 93;

FIG. 96 is a screen shot of an Income Report display of the portfolio construction interface of the portfolio display shown in FIG. 64;

FIG. 97 is another screen shot of the Income Report display shown in FIG. 96;

FIG. 98 is another screen shot of the Income Report display shown in FIG. 96;

FIG. 99 is a screen shot of a Client Scenario display of the portfolio construction interface of the portfolio display shown in FIG. 64;

FIG. 100 is a screen shot of a Spreadsheet display of the portfolio construction interface of the portfolio display shown in FIG. 64;

FIG. 101 is a further screen shot of the Income Report display shown in FIG. 100;

FIG. 102 is a screen shot of a Projected Earnings Rate display of the portfolio construction interface of the portfolio display shown in FIG. 64;

FIG. 103 is another screen shot of the Projected Earnings Rate display shown in FIG. 102;

FIG. 104 is a screen shot of a Snail Trail display of the portfolio construction interface of the portfolio display shown in FIG. 64;

FIG. 105 is a further screen shot of the Snail Trail display shown in FIG. 104;

FIG. 106 is a screen shot of an Analysis Report display of the portfolio construction interface of the portfolio display shown in FIG. 64;

FIG. 107 is a further screen shot of the Analysis Report display shown in FIG. 106;

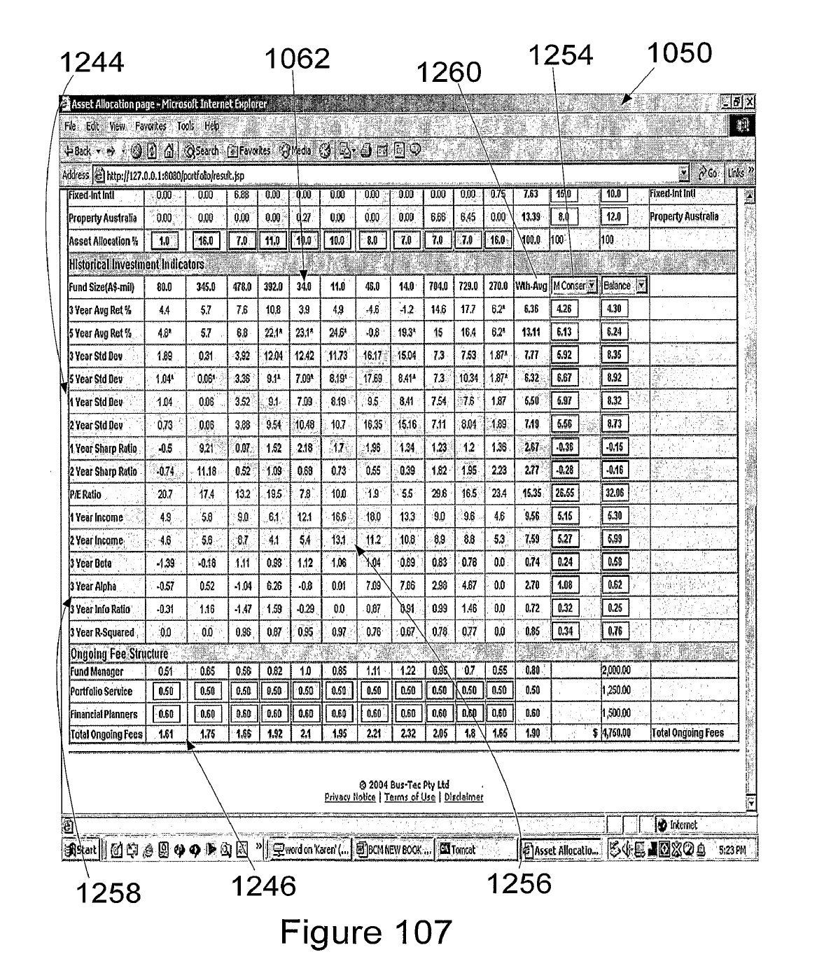

FIG. 108 is a screen shot of another Analysis Report display of the portfolio construction interface of the portfolio display shown in FIG. 64;

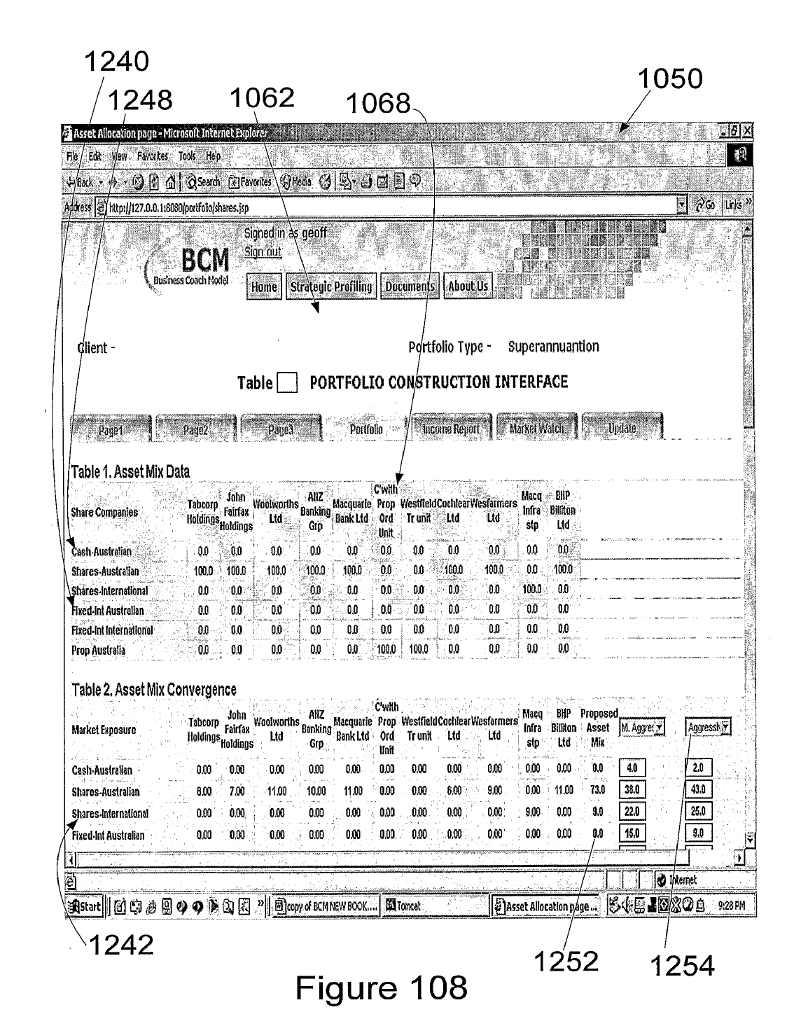

FIG. 109 is a further screen shot of the Analysis Report display shown in FIG. 108;

FIG. 110 is a further screen shot of the Analysis Report display shown in FIG. 108; and

FIG. 111 is a screen shot of Market Watch display of the portfolio construction interface of the portfolio display shown in FIG. 64.

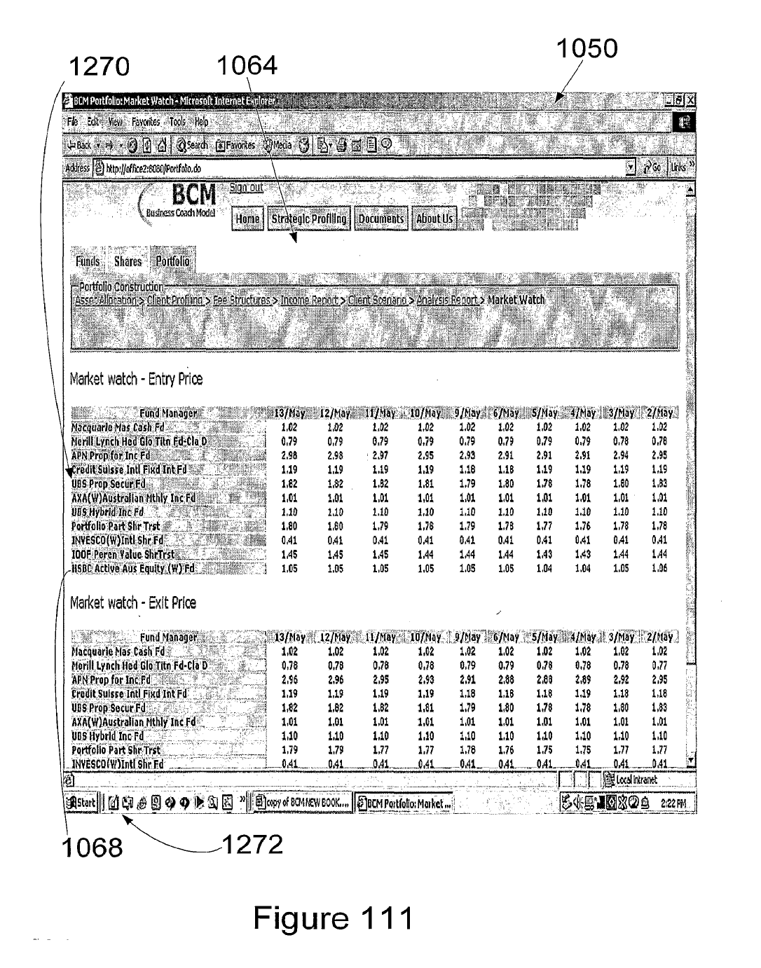

### DETAILED DESCRIPTION OF CERTAIN ILLUSTRATIVE EMBODIMENTS

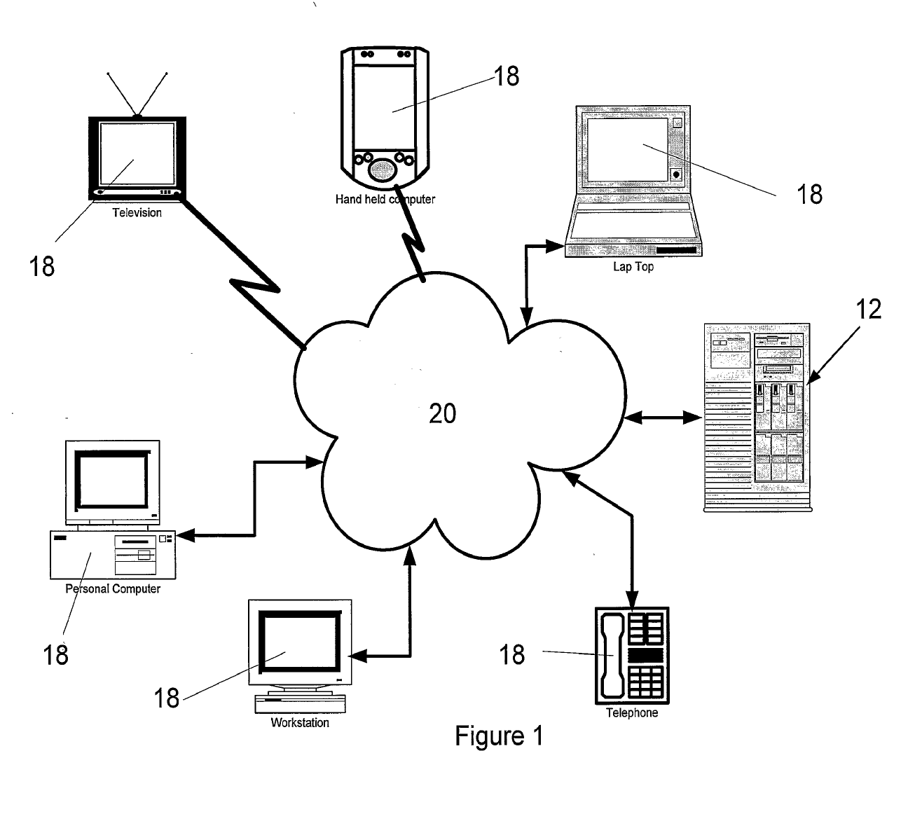

The financial management system 10 (hereafter referred to as the system 10), shown in FIG. 1, is used to divide the assets of the investments of an investment portfolio into a number of asset classes and, for each asset class, compare the combined percentage of assets of the investments with a benchmark that represents the investor's risk tolerance for each respective asset class. The system 10 is also used to distribute the investor's assets over the investments of the investment portfolio. A financial planner can use the system 10 to determine how closely an investment portfolio corresponds to an investor's benchmark risk tolerance. The system 10 allows the financial planner to adjust an investment portfolio to more closely, or less closely as the case may be, correspond to the investor's benchmark by changing the investments, or by changing the distribution of the investor's assets over the investments.

The system 10 is used to create and/or manage an investment portfolio. The system 10 is also used to forecast the performance of an investment portfolio over a predetermined period of time.

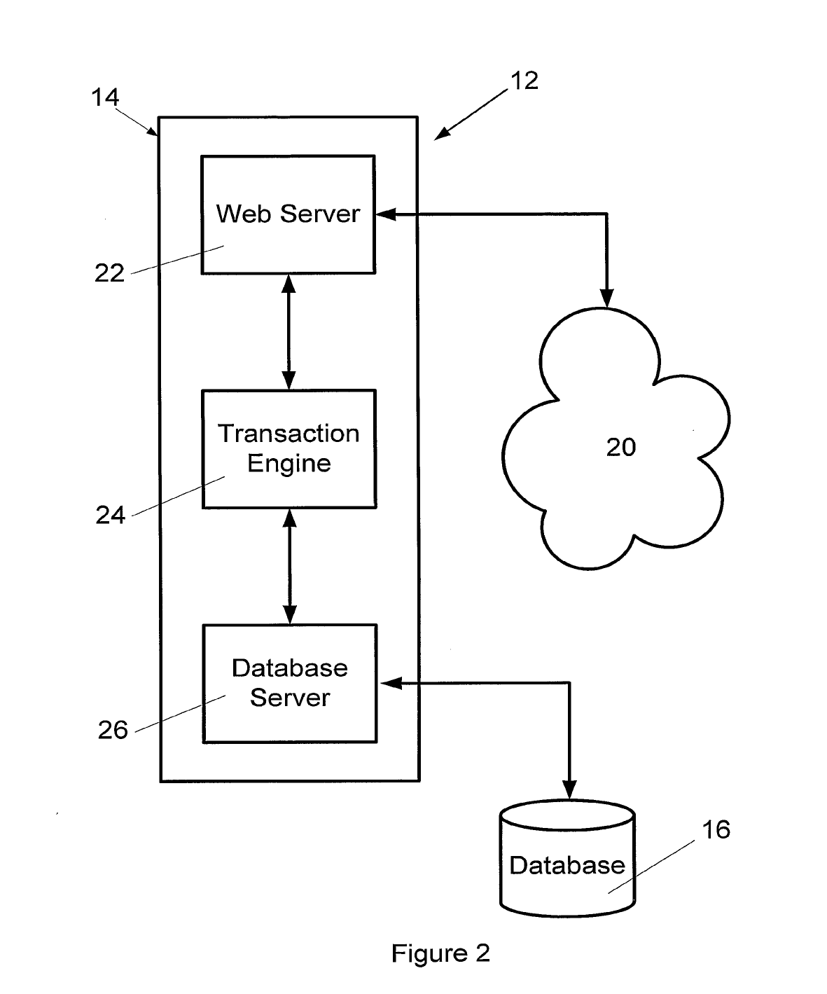

The system 10 is provided by a computer system 12 that includes a server 14 in communication with a database 16, as shown in FIG. 2. The computer system 12 is able to communicate with equipment 18 of members, or users, of the system 10 over a communications network 20 using standard communication protocols. The equipment 18 of the members can be a variety of communications devices such as personal computers; interactive televisions; hand held computers etc. The communications network 20 may include the Internet, telecommunications networks and/or local area networks.

The components of the computer system 12 can be configured in a variety of ways. The components can be implemented entirely by software to be executed on standard computer server hardware, which may comprise one hardware unit or different computer hardware units distributed over various locations, some of which may require the communications network 20 for communication. A number of the components or parts thereof may also be implemented by application specific integrated circuits (ASICs). It will be apparent from the description of the system 10, and its operation below, that the most practical implementation of the components of the computer system 12 is a software implementation. Alternative methods of providing system displays and information can also be used, for example WML pages for mobile telephones, and interactive voice response (IVR) systems for connection to standard fixed telephones or voice over IP terminals.

The server 14 of the computer system 12 includes a web server 22, a transaction engine 24, a database server 26. The web server 22 is software stored on the server 14 that allows the computer system 12 to serve static and dynamic web pages of the web application. The web server 22 allows members of the system 10 to access web pages created and stored on the computer system 12 via their respective terminals 18. The web pages published by the web server 22 are dynamic and are populated by data provided by the transaction engine 24 of the computer system 12.

The database server 26 is software stored on the computer system 12 that allows the computer system 12 to manage the database 16. The database server 26 reads, writes, maintains and secures data on the database 16. The database server 26 maintains data in the database for all members of the system 10. The database 16 is maintained preferably on hard disk storage of the server 14 of the computer system 12.

The transaction engine 24 is software that processes data received by the web server 26 from users of the system 10 via their terminals 18 and is able to retrieve and store data on the database 16 via the database server 26. The transaction engine 24 communicates with the web server 22 and database server 26 to execute data transactions for the system 10 and thereby provides dynamic content for the web pages provided by the web server 22, as described below.

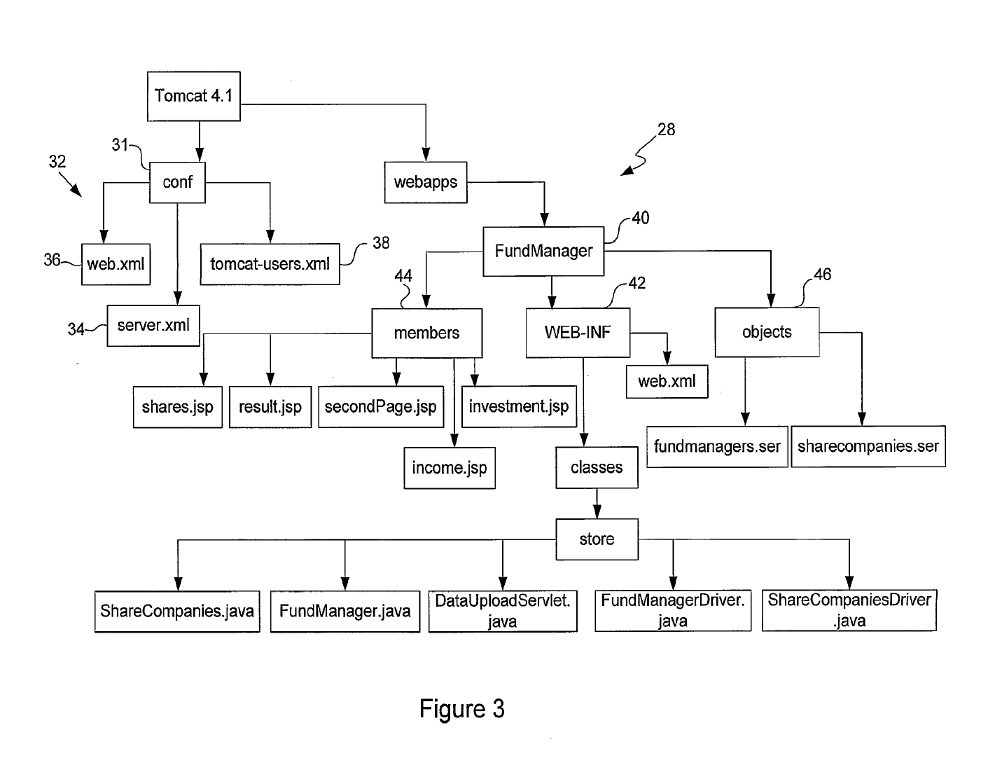

The computer system 12 uses Tomcat 4.1 as the servlet web container for the web application. An exemplary directory and file structure 28 for the web application is shown in FIG. 3. The conf directory 31 includes three XML configuration files 32 that are used to configure the servlet web container of the web application. The serve.xml file 34 configures the web application path and sets the address of the host web server 22. The web.xml file 36 is used to configure servlets and other resources that make up the web application. The tomcat-users. xml file 38 includes authentic user names and corresponding passwords.

The FundManager directory 40 includes three main directories. The Web-inf directory 42 includes the Java files required to implement the web application. The objects directory 44 includes all of the servlet files. The members directory 46 includes the JSP files required for the display of following interfaces of the web application:
1. Risk Profile Interface 50.
2. Indicator Ranking Interface 56.
3. Selection Spreadsheet Interface 58.
4. Portfolio Construction Interface 60.

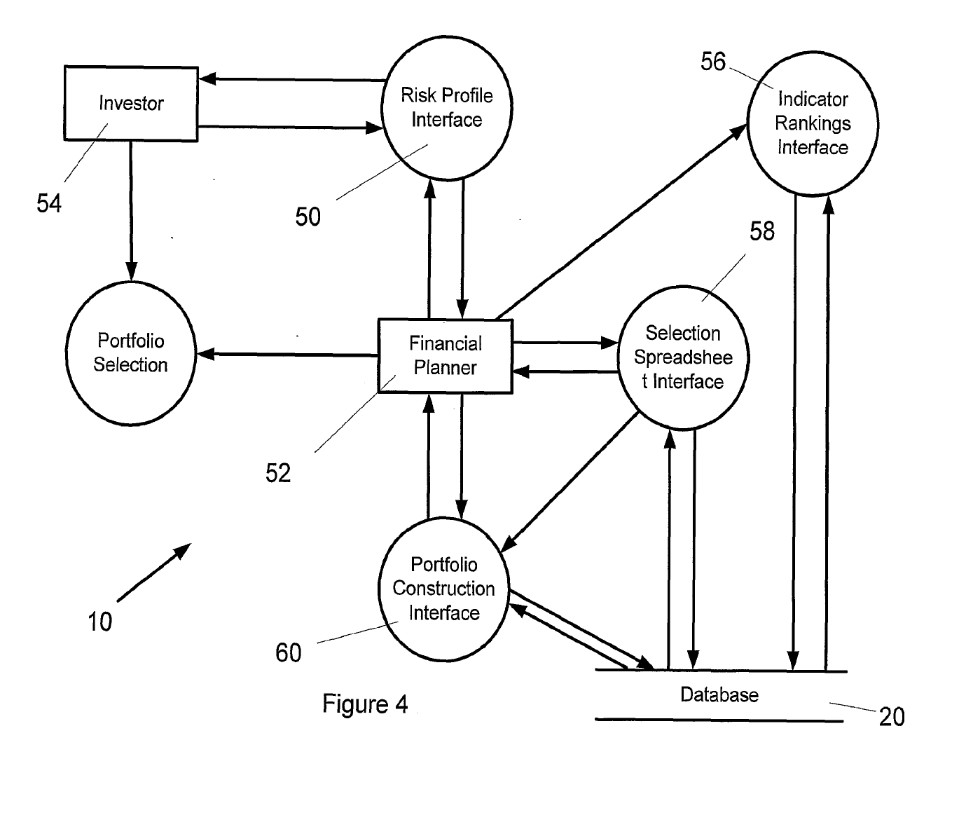

The dataflow between these interfaces of the system 10 is shown in FIG. 4. The Risk Profile Interface 50 is used by the financial planner 52 to determine the risk tolerance level an investor 54 and assign a benchmark risk category to the investor 54. The Indicator Ranking Interface 56 is used to review investments in different economic sectors, where the investments are ranked in accordance with performance and risk indicators. The Selection Spreadsheet Interface 58 can be used to select the investments of an investment portfolio.

The Portfolio Construction Interface 60 displays the investments of an investment portfolio in a table. The table divides the assets of each investment into a number of asset classes and shows the percentage of asset allocation for each of these investments in each of these classes. For example, where the investments are fund managers, the table the percentage of asset allocation for each investment in each of the following asset classes:
1. Cash—Australian.
2. Shares—Australian.
3. Shares—International.
4. Fixed Interest—Australian.
5. Fixed Interest—International.
6. Property—Australian.

Platinum International Fund Managers, for example, may have 14% of their assets in Australian Cash; 78% of their assets in International Shares; and 8% of their assets in Australian Fixed Interest.

The table generated by the Portfolio Construction Interface 60 displays the combined percentage of assets in each class for the investments of the investment portfolio. The table also displays a percentage of assets in each class for the benchmark risk category of the investor.

A financial planner and/or an investor can compare the combined percentage of assets in each class with the percentage of assets in each class of the benchmark risk category. Both the investor and the financial planner are thereby aware of the how closely the investment portfolio corresponds to the investor's benchmark risk category. The portfolio construction interface allows the financial planner 52 to change the investment portfolio to more closely, or less closely as the case may be, follow the percentage of asset allocation of the benchmark risk category. The portfolio construction interface 60 also allows the financial planner 52 to distribute the investor's assets as a percentage amongst the selected investments of the investment portfolio. The financial planner can thereby control how closely the investment portfolio corresponds to the benchmark.

The system 10 is hereafter described by way of reference to managed funds. However, it would be understood by those skilled in the relevant art that the system 10 is equally applicable to other investment types, such as direct shares, and combinations thereof.

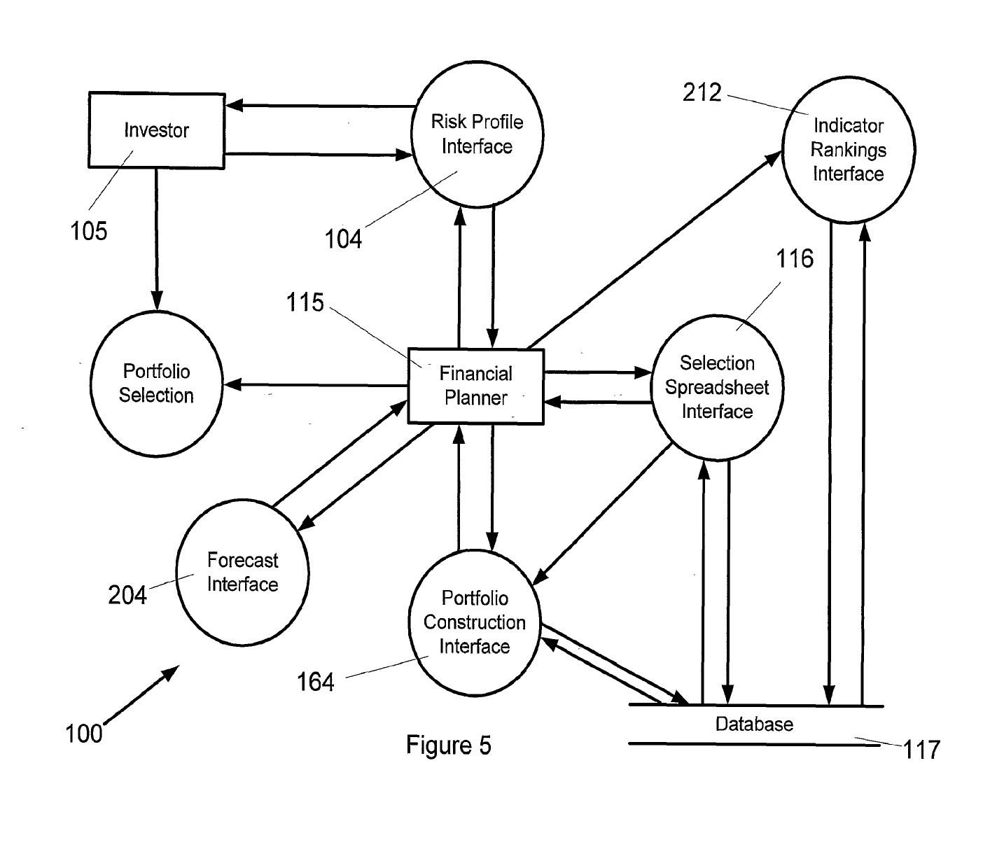

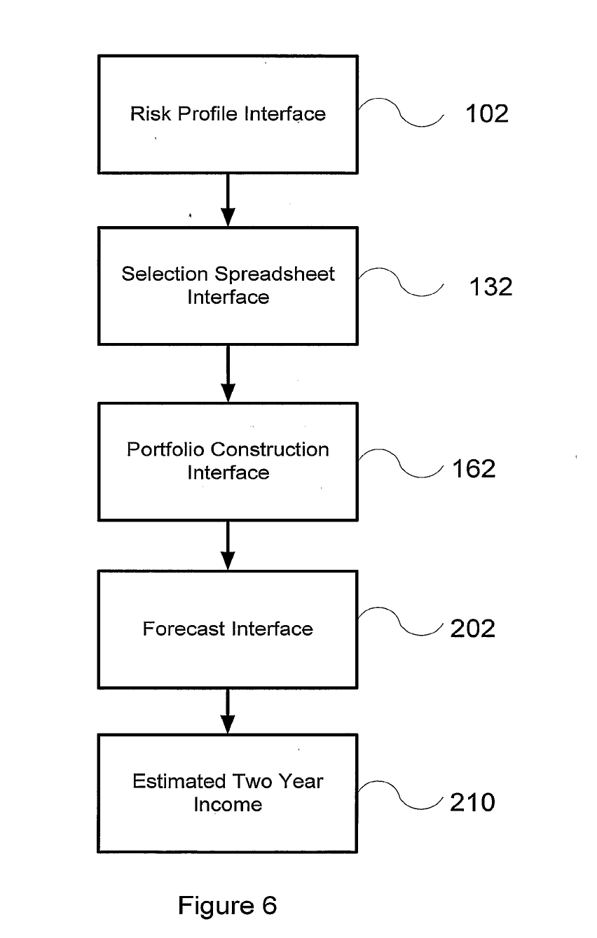

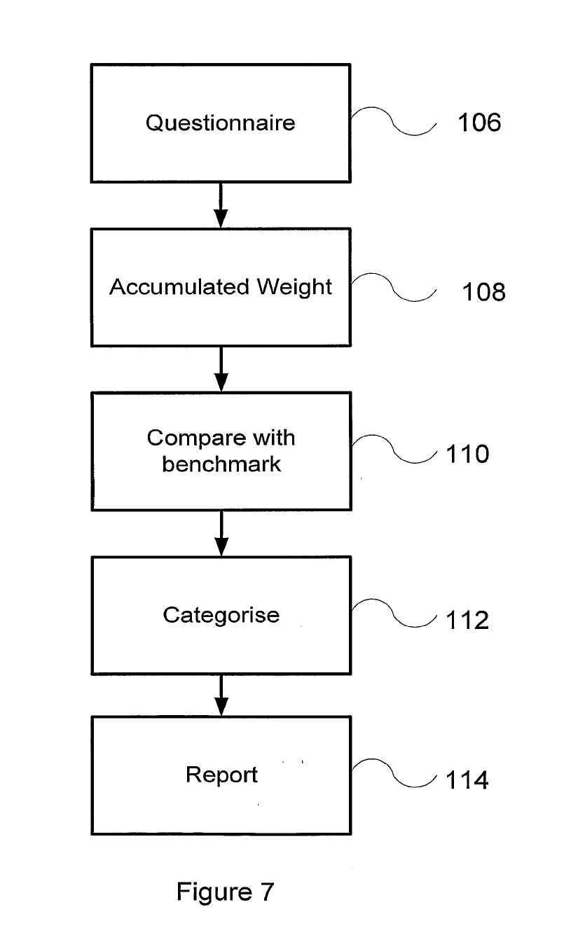

The fund manager system 100 (also referred to as the fund manager web application 100) shown if FIG. 5 executes the steps shown in FIG. 6. The system 100 generates, at step 102, a risk profile interface 104 that executes the steps shown in FIG. 7.

The risk profile interface 104 presents, at step 106, the investor 105 with a questionnaire (not shown) that includes a series of questions that are designed identify the risk tolerance level of the investor 105. The questions are directed towards the investor's attitudes, values and experiences in investing. The answers to each question are weighted and the risk profile interface 104 determines, at step 108, the accumulated weight of the investor's answers. The risk profile interface 104 compares, at step 110, the investor's accumulated weight to the accumulated weight ranges of predetermined benchmark risk categories. The risk portfolio interface 104 categorizes, at step 112, the investor 105 as being a certain benchmark risk category if his or her accumulated weight falls within the range of that benchmark risk category. Set out below are exemplary benchmark risk categories, together with the associated ranges of scores to which they apply:

1. Conservative (0 to 20 points)
Conservative investor. The kind of investor who likes to wear braces and a belt at the same time. Security is of paramount importance. Wants to secure income invested in long term guaranteed Fixed Interest Securities for safeguard of capital.
2. Moderately Conservative (20 to 40 points)
Low risk investor. Performance for stable income stream with some modest growth for preservation of capital. Overall portfolio medium to long term capital security and low volatility.
3. Balance (40 to 60 points)
Flies a little higher, but still keeps one foot on the ground. Can see the benefits of investing funds with caution but has an eye to good returns. May already have investments and is considering either starting, or adding to, an investment portfolio.

### 4. Moderately Aggressive (60 to 80)

Play both ends against the middle. Willing to trade off some security in order to achieve above average returns. Not a complete stranger to investing. However, would welcome some guidance as to how to achieve a reasonable return without unnecessary risk. May prefer, for example, to access equities through a trust structure.

### 5. Aggressive (80 to 100)

Not afraid to take risks to achieve what could be well above average returns. The equity and property markets hold few qualms and investing overseas is clearly an option.

On completion of the questionnaire, the Risk Portfolio Interface 104 generates, at step 114, a report on the risk tolerance level of the investor 105. The financial planner 112 can use this information to select investments from the selection spreadsheet interface 116.

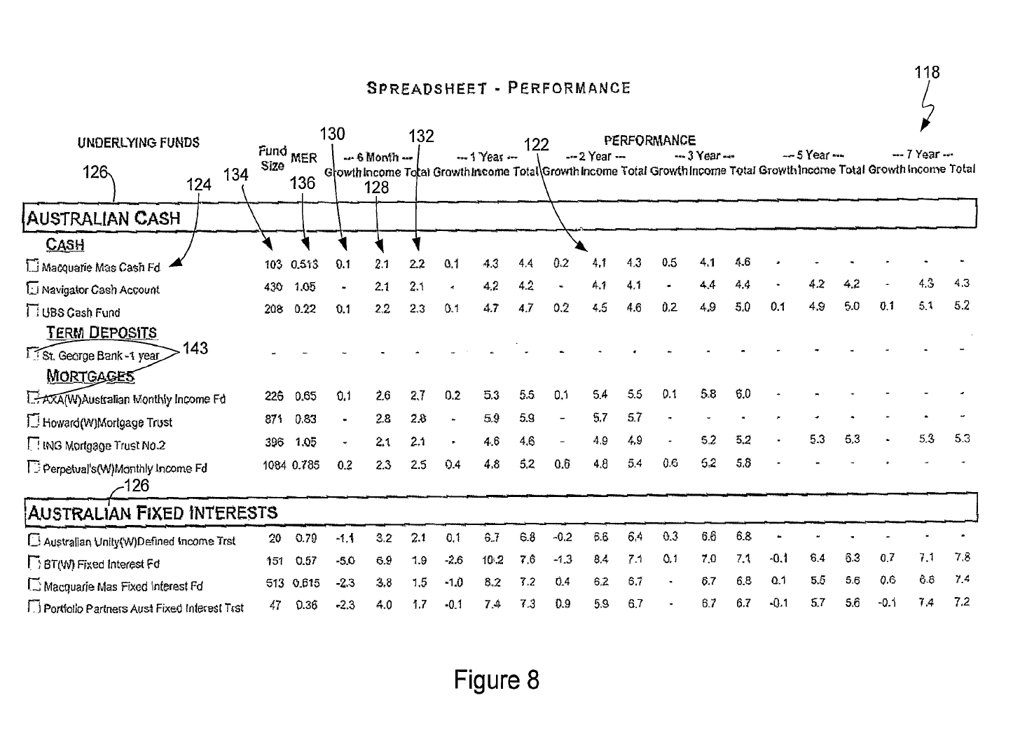

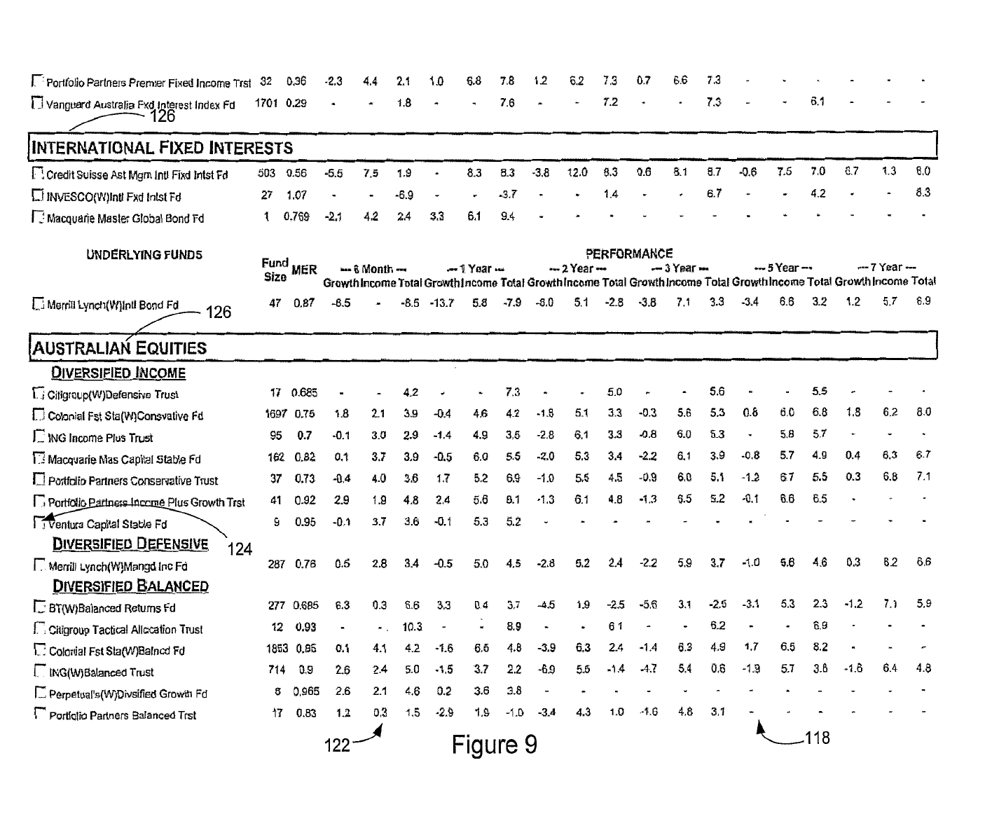

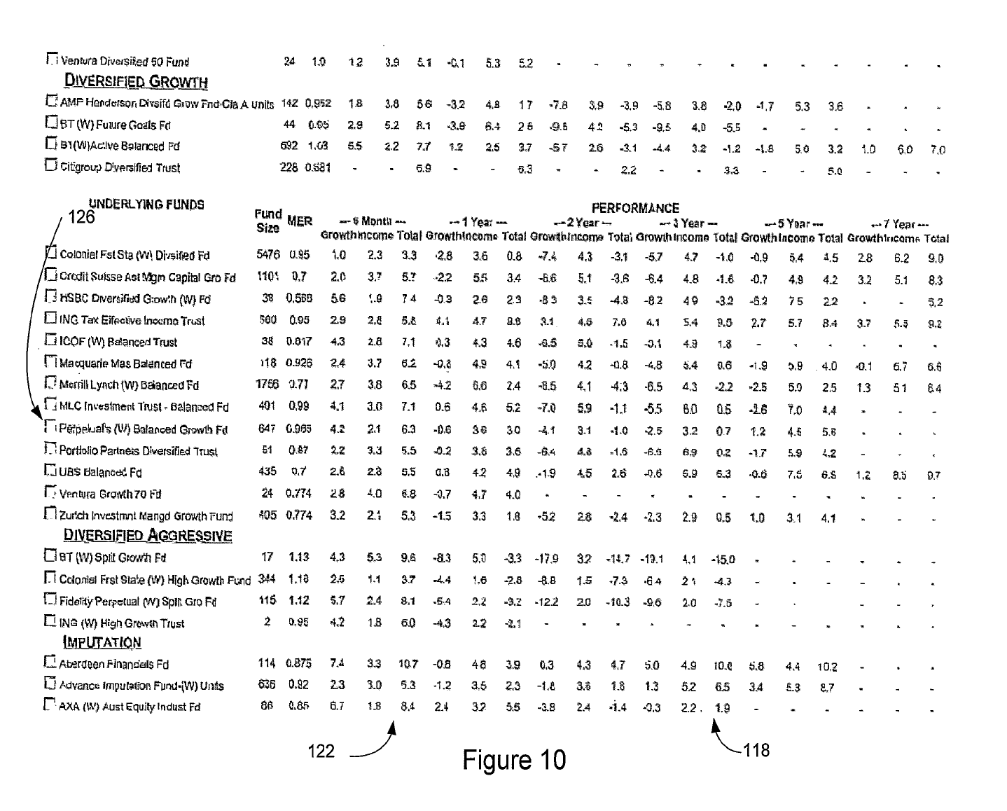

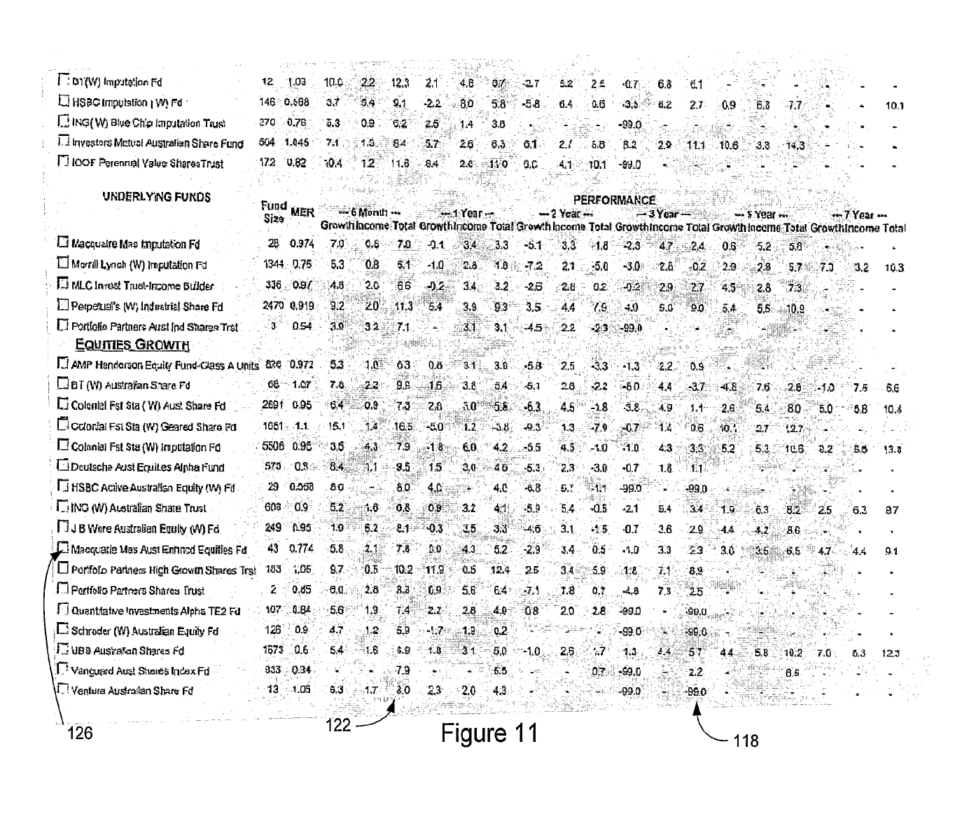

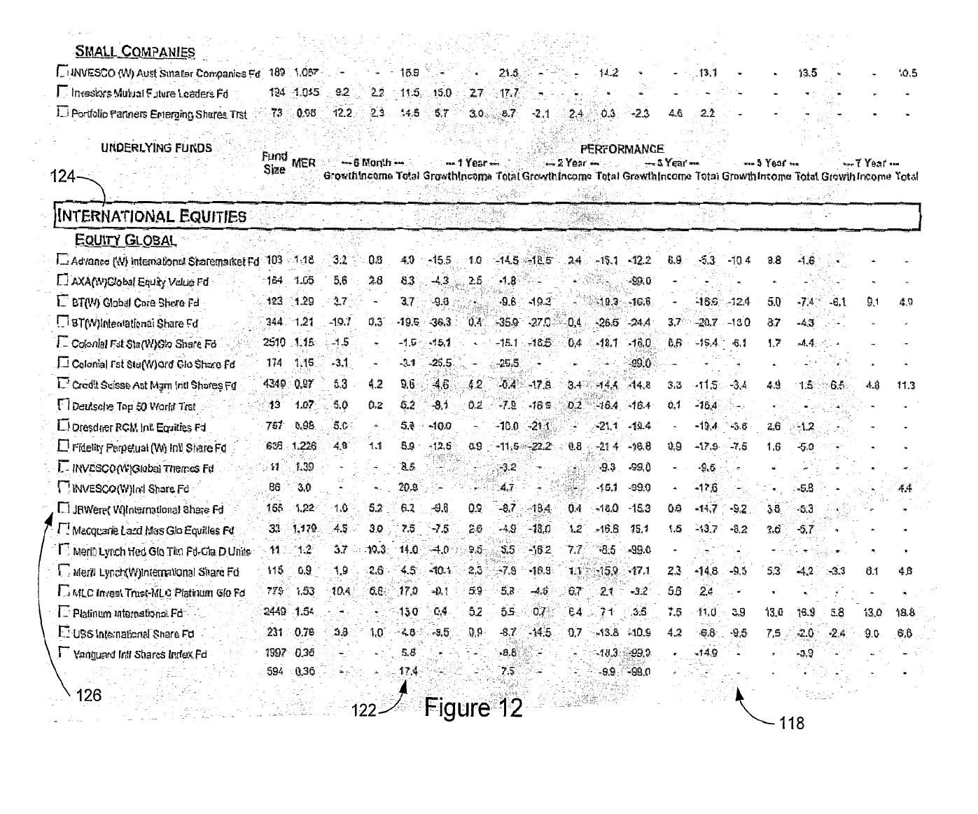

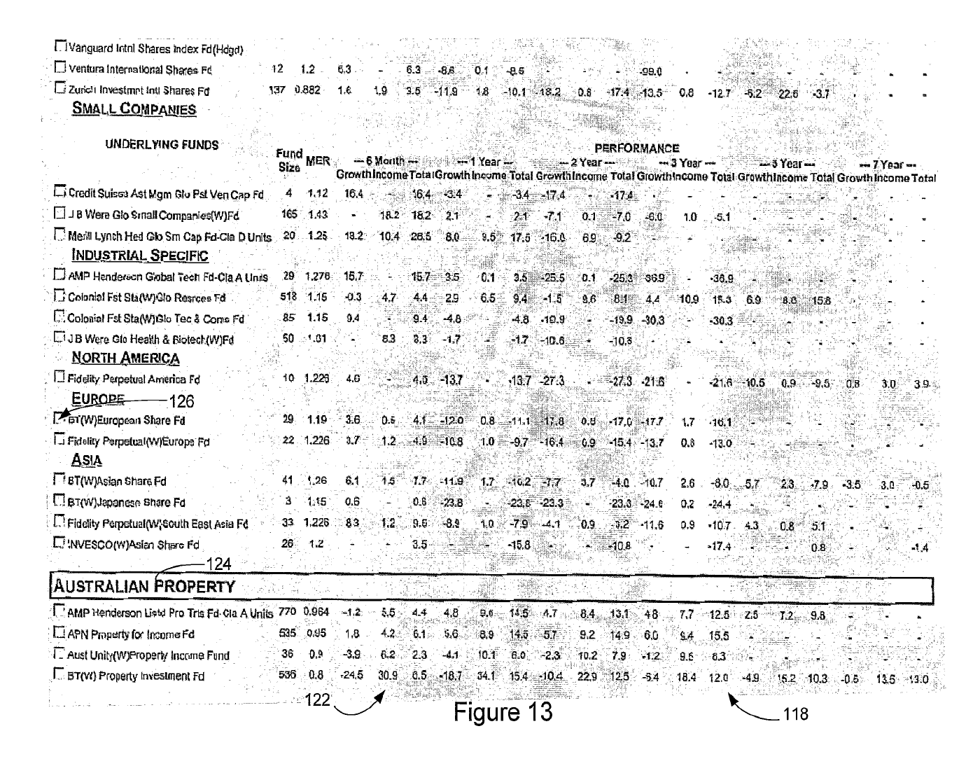

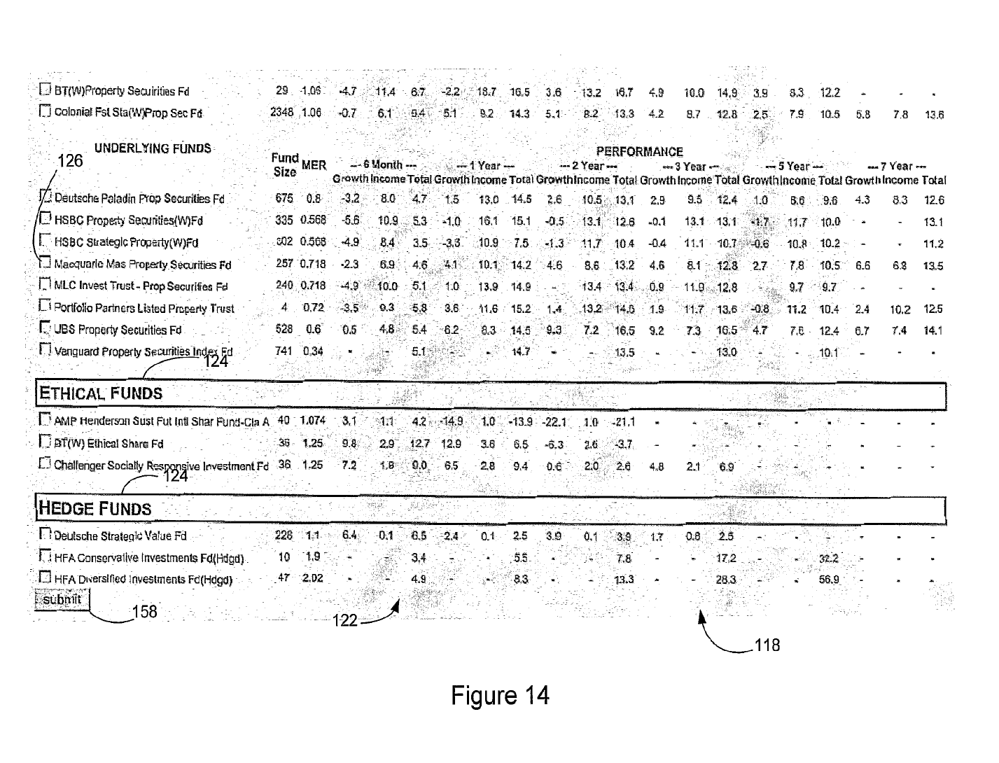

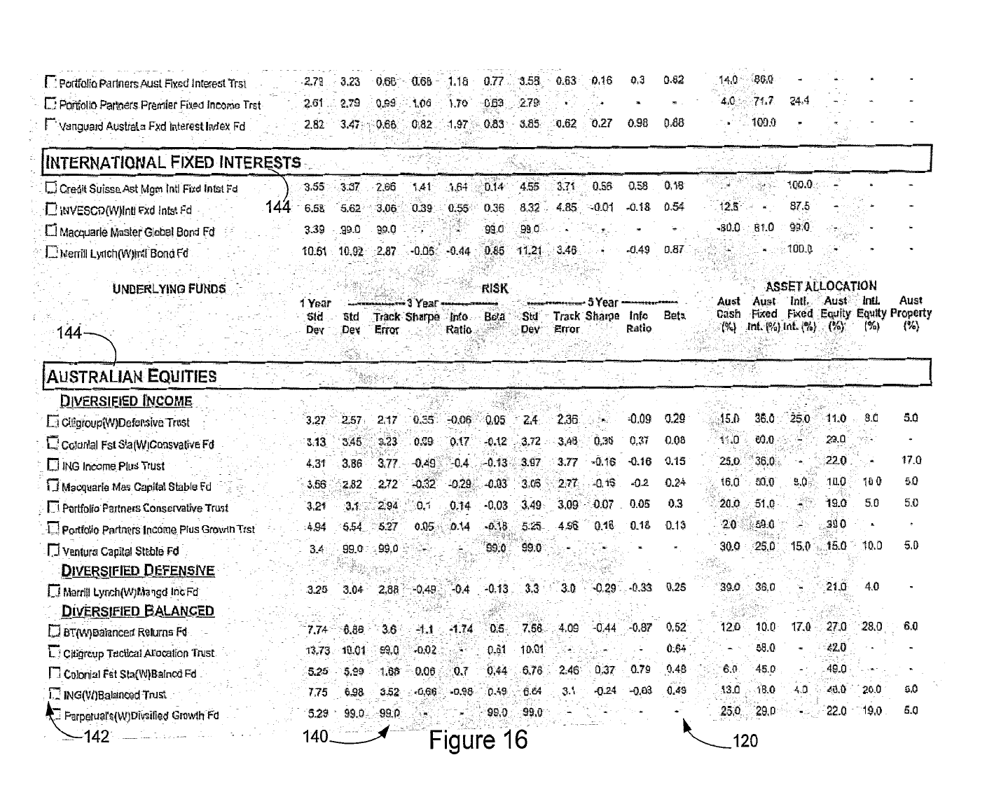

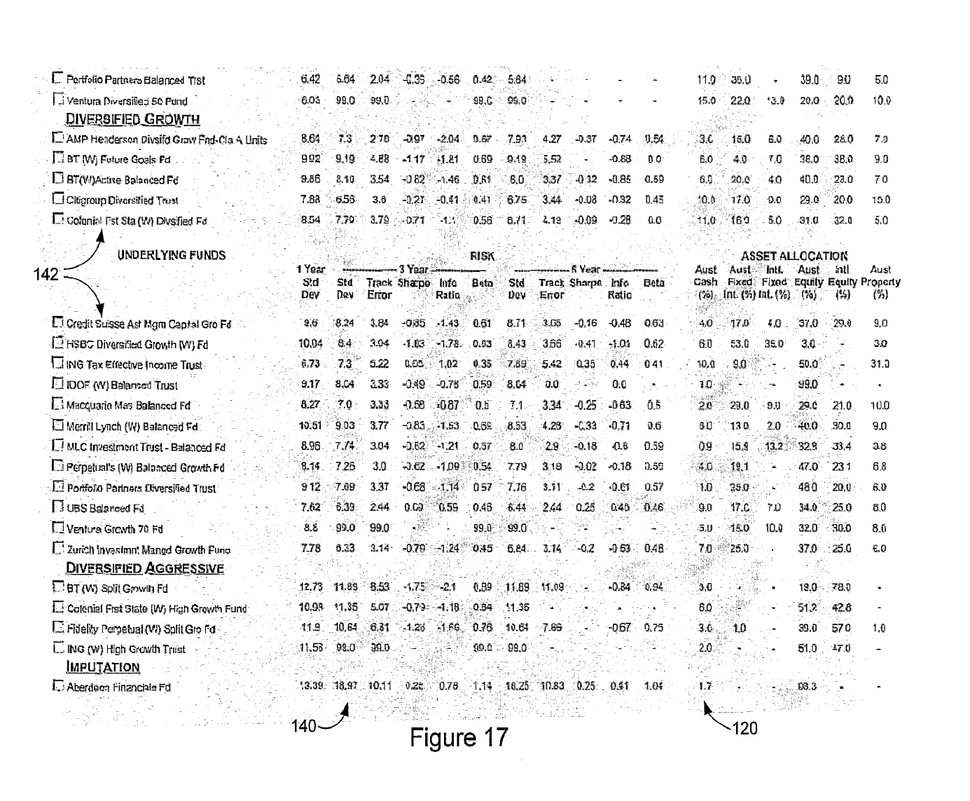

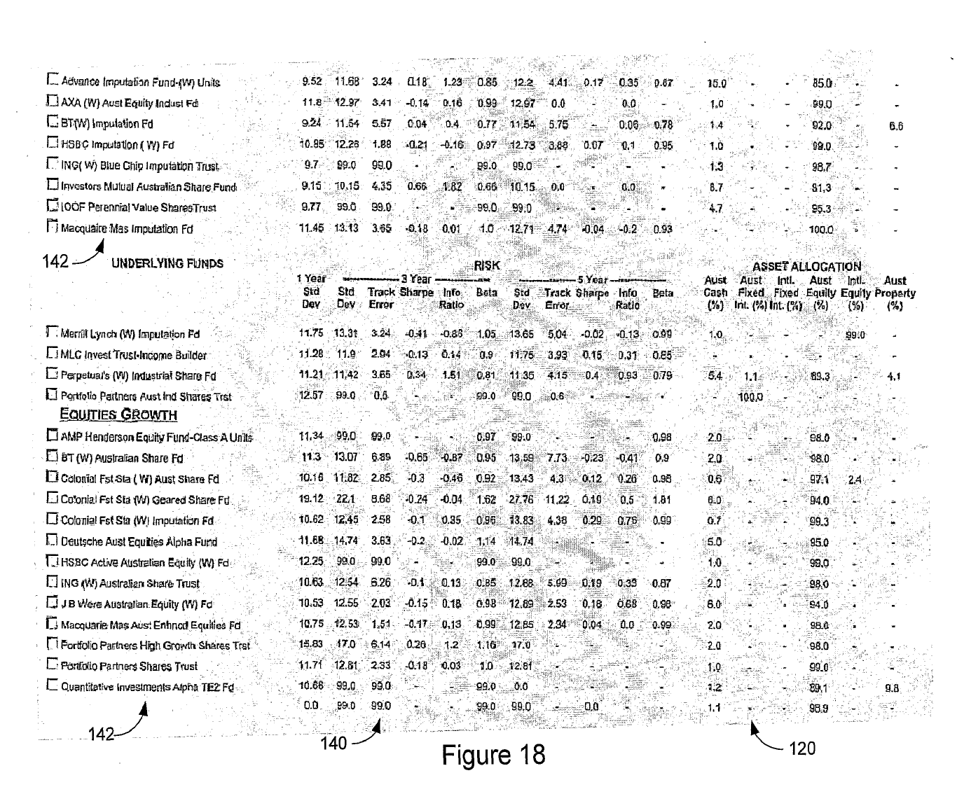

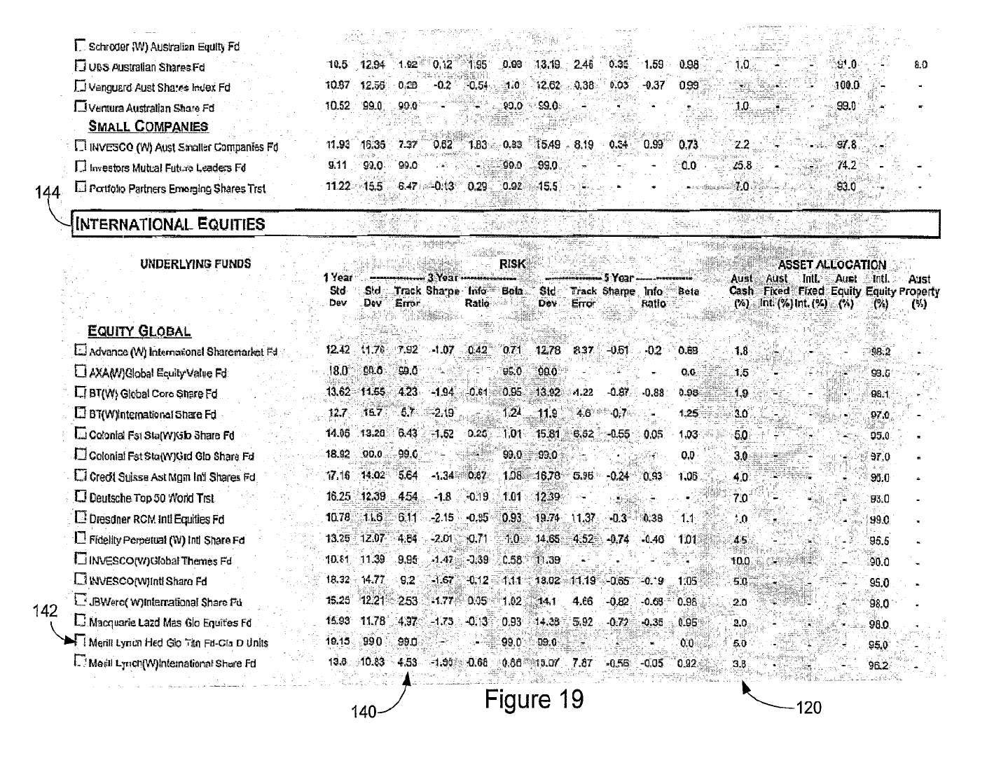

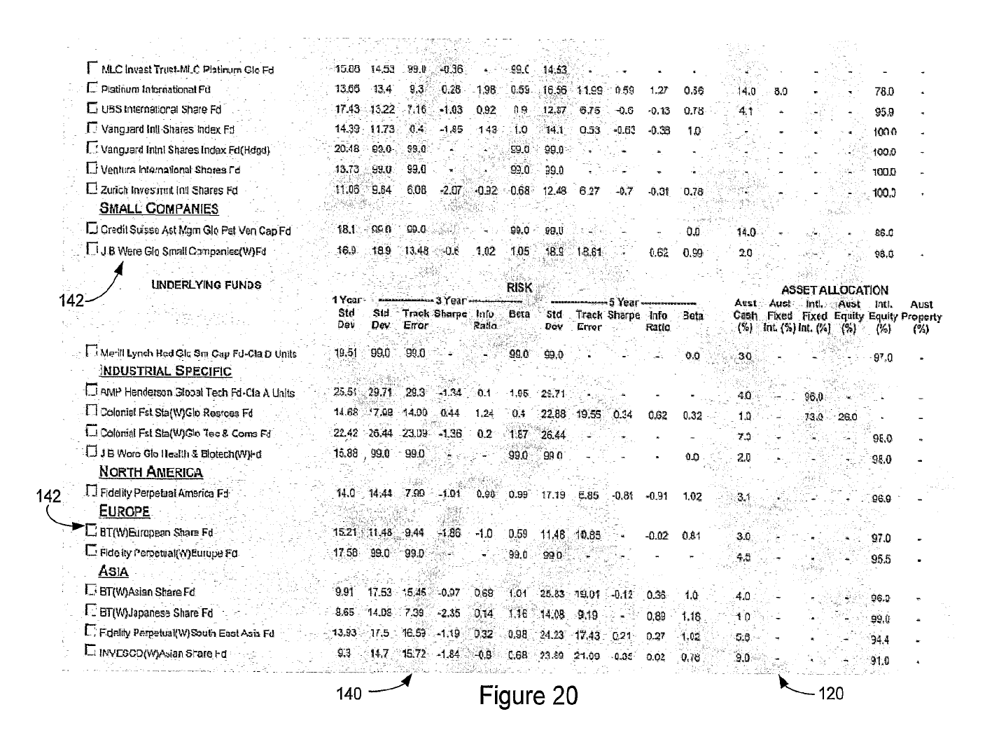

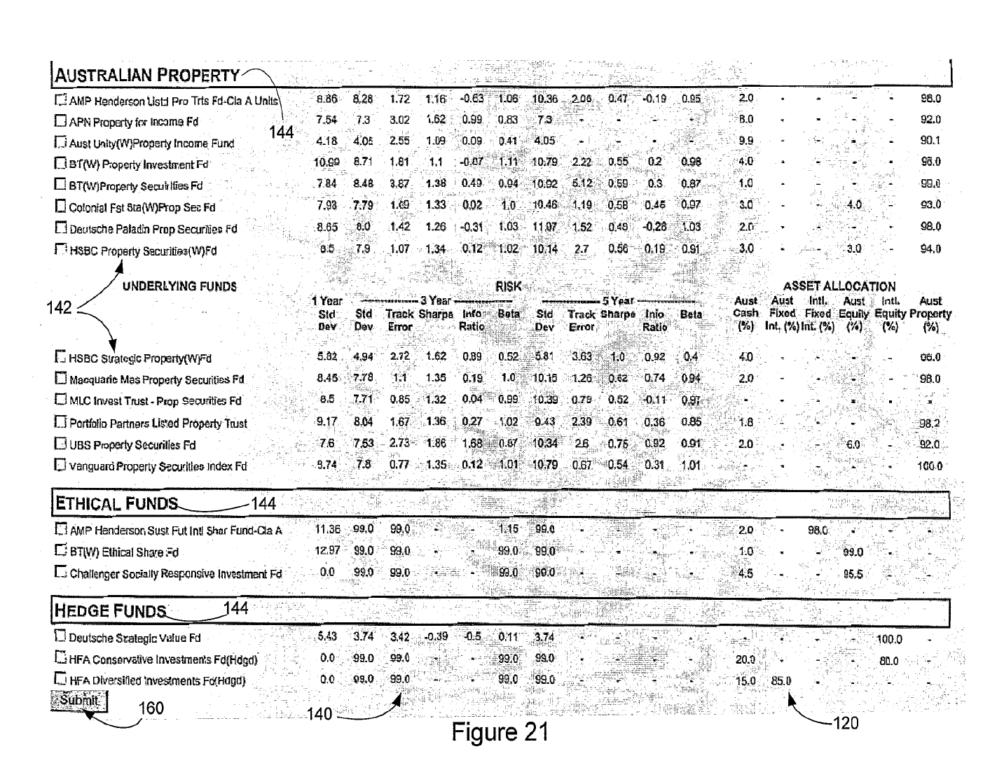

The risk profile interface 102 includes a function button that, when executed by the financial planner, generates, at step 132, the selection spreadsheet interface 116. The system 100 extracts data from the database 117 and displays the data in the form of the following two spreadsheets shown in FIGS. 8 to 14 and 15 to 21 respectively:
1. Performance Spreadsheet 118.
2. Risk and Asset Allocation Spreadsheet 120.

The performance spreadsheet 118 is divided into economic sectors 126 (also referred to as asset classes 126). Each asset class 126 includes a list of fund managers 124 that have assets in the relevant asset class 126. The performance spreadsheet 118 displays data 122 on the following indicators for the fund managers 124 in each economic sector 126:
a. Income 128.
b. Growth 130.
c. Total Return 132.

The performance spreadsheet shows data 122 for each fund manager 136 for each of the above indicators, based on each fund manager's performance over the past six months, one year, three years, five years and seven years. The performance ranking spreadsheet 134 also includes statistics on the fund size 134 and the management expenses ratio (MER) 136 for each of the fund managers 124. The fund size 134 indicates the worth of a particular fund manager 124, while the MER 136 indicates the expenses of the fund manager 124.

The risk and asset allocation spreadsheet 120 displays data 140 indicating the risk associated the various fund managers 142 for each economic sector 144. The risk and asset allocation spreadsheet 120 includes statistics 140 on the following risk indicators for each of the fund managers 142:
a. Standard deviation 146.
b. Sharpe Ratio 148.
c. Beta 150
d. Alpha 152.
e. Tracking Error 154.
f. Information Ratio 156.
g. R Squared 158.

The selection spreadsheet 116 provides statistical information 122,140 to assist the financial planner 115 in selecting fund managers 30 for the investor 105. On review of the information generated by the selection spreadsheet 16, the financial planner 12 selects the fund managers 124,142 that he or she deems to be appropriate. The selection is made by marking checkboxes 143 adjacent each of the selected fund managers. The financial planner 115 submits his or her selection of fund managers by clicking on the “submit” ‘function button 158,160 on each of the spreadsheets 118,120 respectively. On submission of this data, the system 100 generates, at step 162, a portfolio construction interface 164.

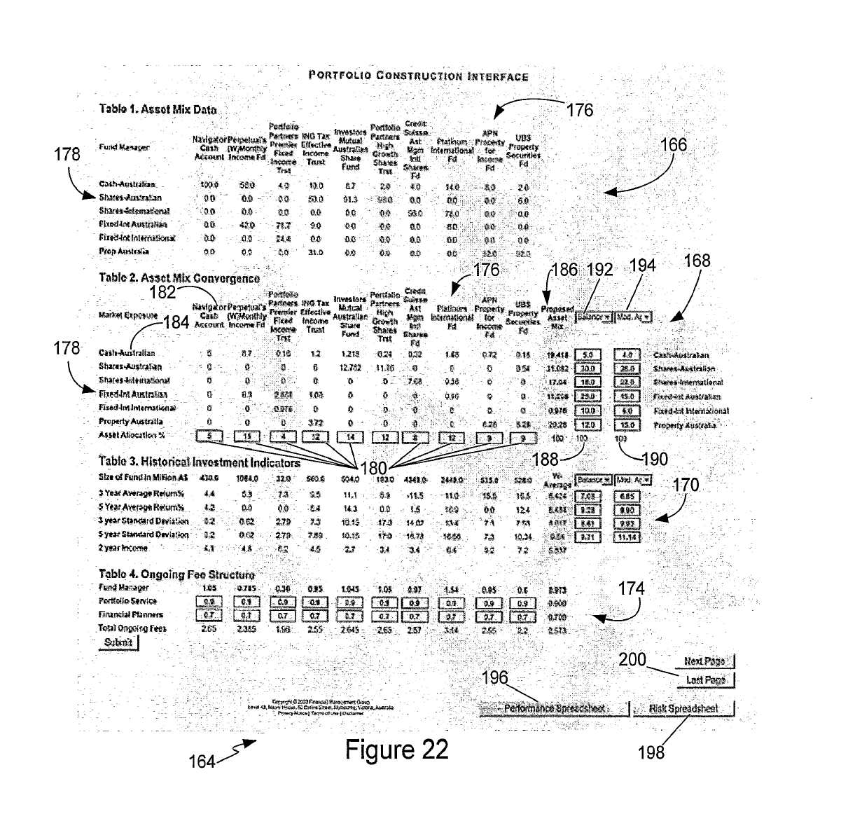

The Portfolio Construction Interface 164 shown in FIG. 22 displays the fund managers 48 selected by the financial planner 115 using the selection spreadsheet interface 132 in the following tables:
1. Asset Mix Data 166.
2. Asset Mix Convergence 168.
3. Historical Investment Indicators 170.
4. Ongoing Fee Structure 172.

The Asset Mix Data table 166 includes a column for each of the fund managers 176 selected by the financial planner 115 and a row for each of the following asset classes:
a. Cash—Australian
b. Shares—Australian
c. Shares—International
d. Fixed Interest—Australian
e. Fixed Interest—International
f. Property—Australian

The asset mix data table 166 shows the distribution of assets over the above asset classes for each selected fund manager.

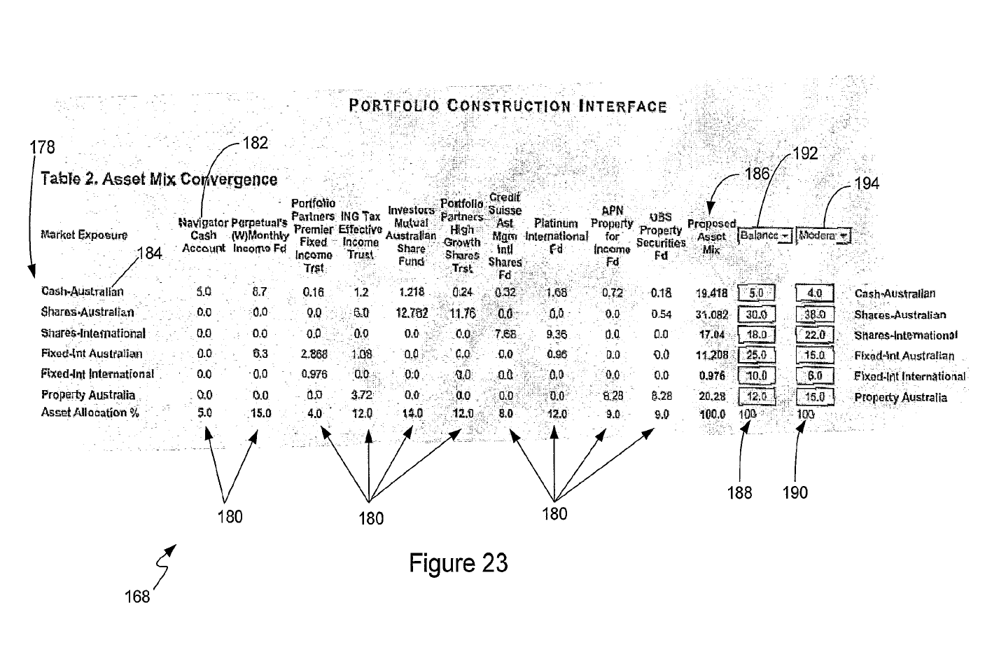

The asset mix convergence table 168, also shown in FIG. 23, includes a column for each of the selected fund managers and a row for each of the above asset classes. In addition, the asset mix convergence table includes a row of data boxes 180, one for each of the selected fund managers 176. The financial planner 115 can allocate a percentage of the investor's assets to a selected fund managers 176 by entering the desired percentage into the respective fund manager's data box 180. One hundred percent of the investor's assets are allocated to the selected fund managers 176 in the described manner.

For each selected fund manager 176, the asset mix convergence table 168 shows the distribution of assets in each mentioned asset class multiplied by the percentage of the investor's assets allocated to the relevant fund manager 176. For example, the asset mix data table 166 indicates that the Navigator Cash Account fund manager 182 allocates 100% of its assets to the asset class Cash—Australian 184. The asset mix convergence table 168 indicates that the Navigator Cash Account fund manager 182 was allocated 5% of the investor's assets by the financial planner 115. The asset mix convergence table 168 also indicates that 100% of the 5% of assets allocated to the Navigator Cash Account fund manager 182 was allotted to the Cash—Australian asset class 184.

The asset mix convergence table 168 also includes a column 186 that, for each asset class, shows the sum of the entries across the table 168 for each of the selected fund managers 176. Thus, the rows of the proposed asset mix column 186 show the distribution of assets of the investment portfolio over the above mentioned asset classes 178, where the distribution is weighed by the investor's asset allocation to each of the selected fund managers 176.

In addition, the asset mix convergence table 168 includes two columns 188,190 that each indicate benchmark asset distributions over the asset classes 178 for respective benchmark risk categories. The benchmark risk category of each of these columns 188,190 can be selected from respective drop down lists 192,194 of the asset mix convergence table 168.

The financial planner 115 can display the values for the mentioned classes 178 for the benchmark risk category of the investor 105 using the first drop down window 192, for example. The financial planner 115 can then compare these values with the values in the proposed asset mix column 186. In addition, the financial planner 115 can display the values for the mentioned asset classes 178 for another benchmark risk category using the second drop down window 194.

The financial planner 115 and/or the investor 105 can compare the values of the proposed asset mix column 186 with the values of the asset classes of the investor's benchmark risk category. The financial planner 115 and/or the investor 105 can thereby observe how closely the proposed asset mix of the investment portfolio corresponds to the asset mix of the relevant benchmark risk category. The financial planner 115 can change the selected fund managers 176 to increase, or decrease as the case may be, the degree to which the proposed asset mix corresponds to the benchmark risk category.

The plurality of data boxes 180 allow the financial planner 115 to apportion a percentage of the investor's assets to each of the selected fund managers 176. The financial planner 115 can change the proposed asset mix of the selected fund managers 176 by changing the percentage of assets allocated to each of the selected fund managers 176.

The degree to which the proposed asset mix column 186 corresponds to the values of the classes of the benchmark risk category of the investor 105 indicates how closely the proposed investment portfolio corresponds to the benchmark risk category of the investor. In observing this, both the financial planner 115 and the investor 105 are aware of the risk associated with the investment portfolio. This risk is presented to the financial planner 115 by the Portfolio Construction Interface 164 and can be changed to suit the specific risk tolerance of the investor.

The historical investment indicator table 170 provides a means by which the financial planner 115 can compare the weighted average return and risk values of the selected fund managers 176 with the benchmark risk categories. The data presented in this table 170 allows the financial planner 115 to identify long-term themes in the market. On consideration of this data, if the financial planner 115 finds that the risk is too high, or some part of the asset allocation is higher than expected, then he or she can adjust the asset allocation values entered into the asset mix convergence table 168.

The ongoing fee structure table 174 displays the ongoing fees associated with the investment portfolio. The ongoing fee structure table 174 includes the fees for each of the selected fund managers 176. The ongoing fee structure table 174 also includes data boxes that allow the financial planner 115 to enter a portfolio service charge and a financial planner fee for each of the selected fund managers 176. The ongoing fee structure table 174 displays a summary of fees associated with each selected fund manager 176.

The financial planner 115 can change the selected fund managers 176 by executing either the Performance Spreadsheet function button 196 or the Risk and Allocation Spreadsheet function button 198. On execution of the Performance Spreadsheet function button 196, the system 100 generates the Performance Spreadsheet 118 shown in FIGS. 8 to 14. The financial planner is able to cancel previous fund manager selections and add additional fund managers by clearing and marking checkboxes 143 associated with each of the listed fund managers.

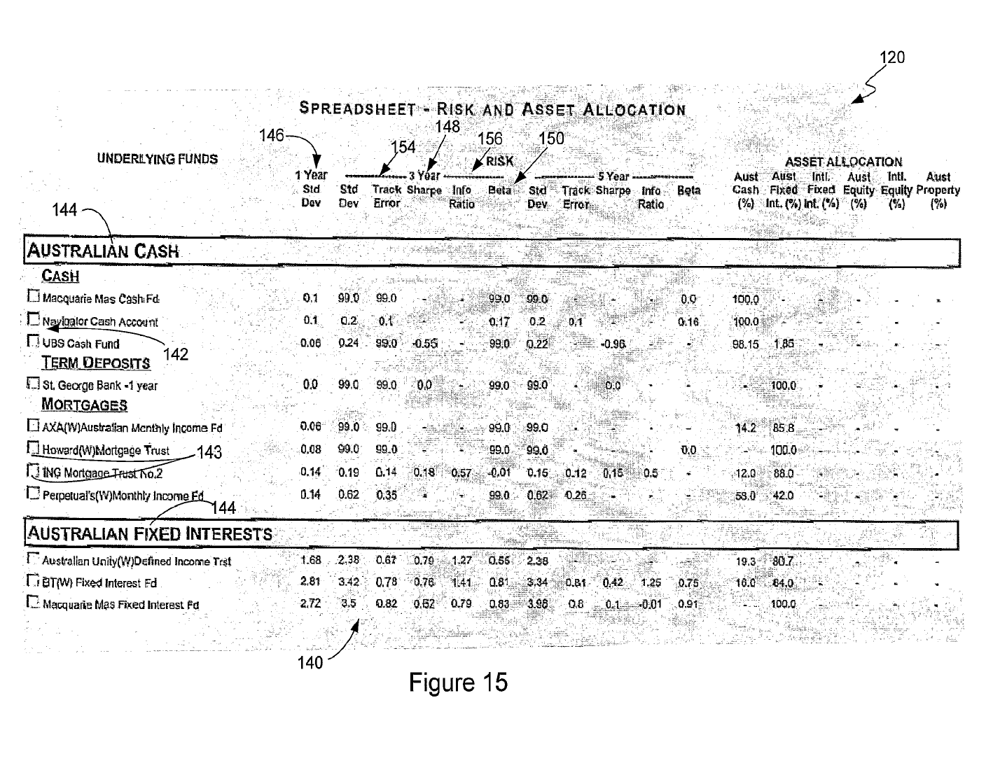

On execution of the Risk and Asset Allocation Spreadsheet function button 198, the system 100 generates the Risk and Allocation Spreadsheet 120 shown in FIGS. 15 to 21. The financial planner is able to cancel previous fund manager selections and add additional fund managers by clearing and marking checkboxes 143 associated with each of the listed fund managers.

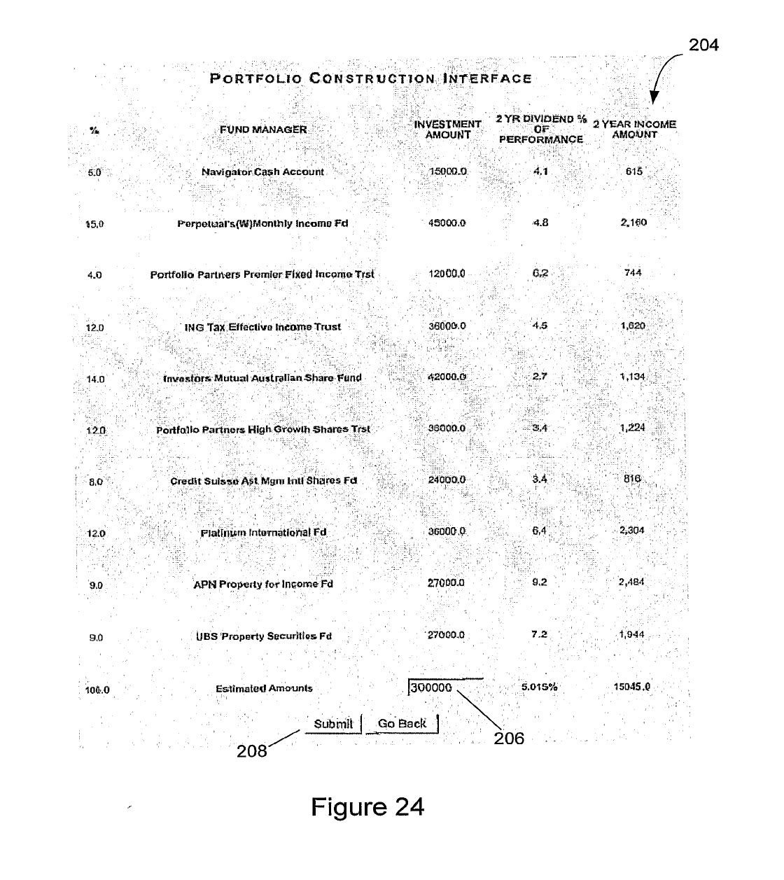

Once the financial planner 115 is satisfied that he or she has selected the right fund managers 176 for the investment portfolio and adequately adjusted the proposed asset mix column to satisfy the investor's risk objectives, then the financial planner 115 executes the last page function button 200 and the system 100 generates, at step 202, the forecast interface 204 shown in FIG. 24. The forecast interface 204 includes a data box 206 that allows the financial planner 115 to enter the monetary amount of the assets that the investor 105 wishes to invest in the investment portfolio. On execution of the “submit” function button 208, the forecast interface 204 generates, at step 210, an estimate of the projected income of the investment portfolio over a period of two years, for example. The forecast interface 204 generates this data using the two year performance values of the selected fund managers 176.

The system 100 can generate an Indicator Ranking Interface 212 to evaluate the performance of the fund managers. The Indicator Ranking Interface 212 extracts data from the database 117 on fund managers for a nominated economic sector and displays the data in the form of one of the following spreadsheets:
1. Performance Ranking.
2. Risk Ranking.
3. Statistical Analysis.

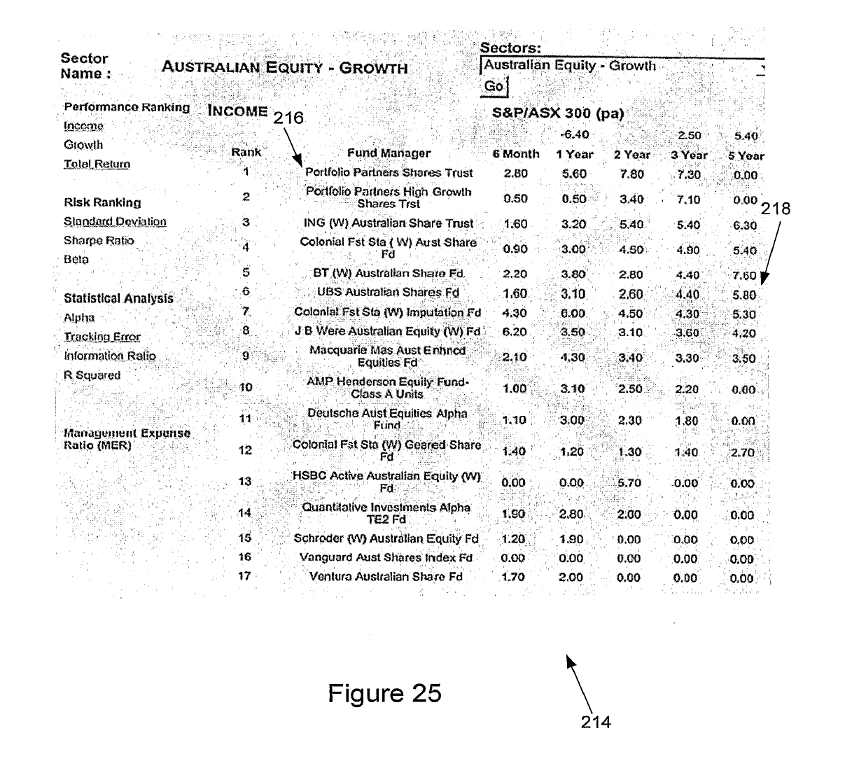

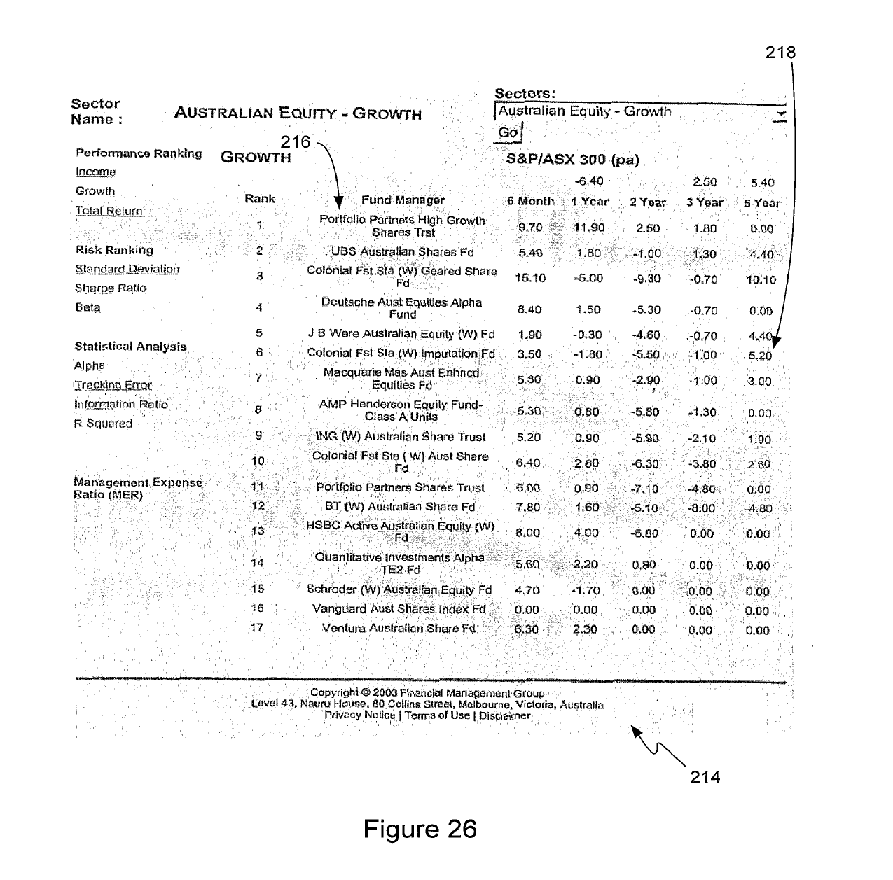

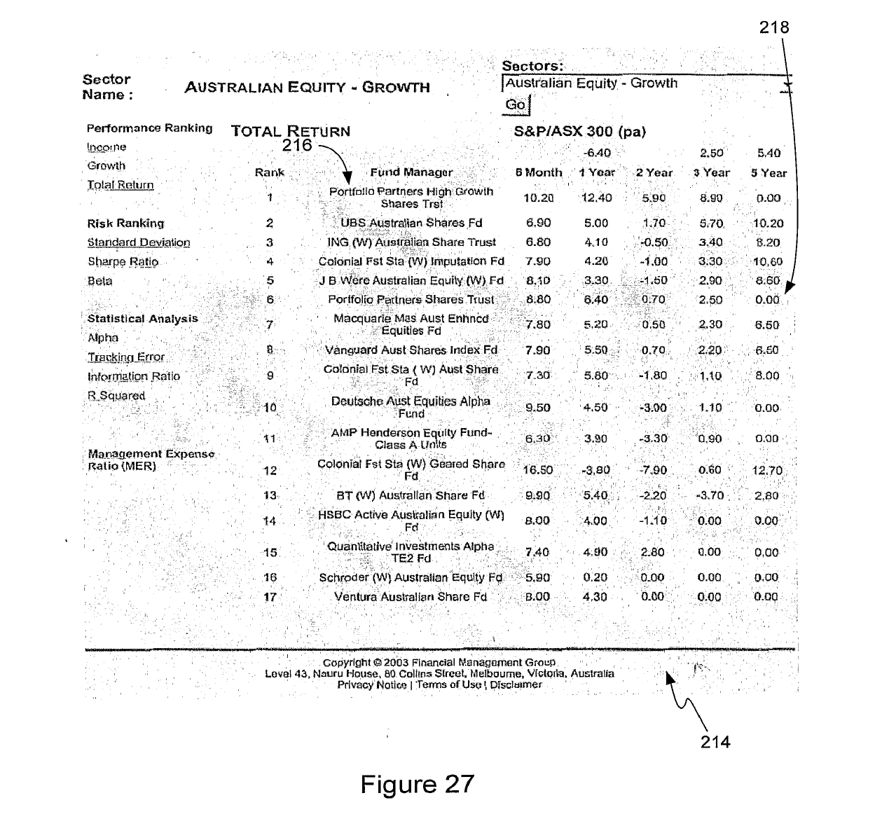

The performance ranking spreadsheet 214, shown in FIGS. 25 to 27, displays fund managers 216 for the Australian Equity-Growth Sector. FIGS. 25 to 27 list the fund managers 216 in accordance with their relative performance based on the following indicators:
a. Income.
b. Growth.
c. Total Return.

FIGS. 25 to 27 show data 218 for each fund manager 216 for each of the above indicators respectively. Data on each fund manager's performance over the past six months, one year, three years, five years and seven years is shown.

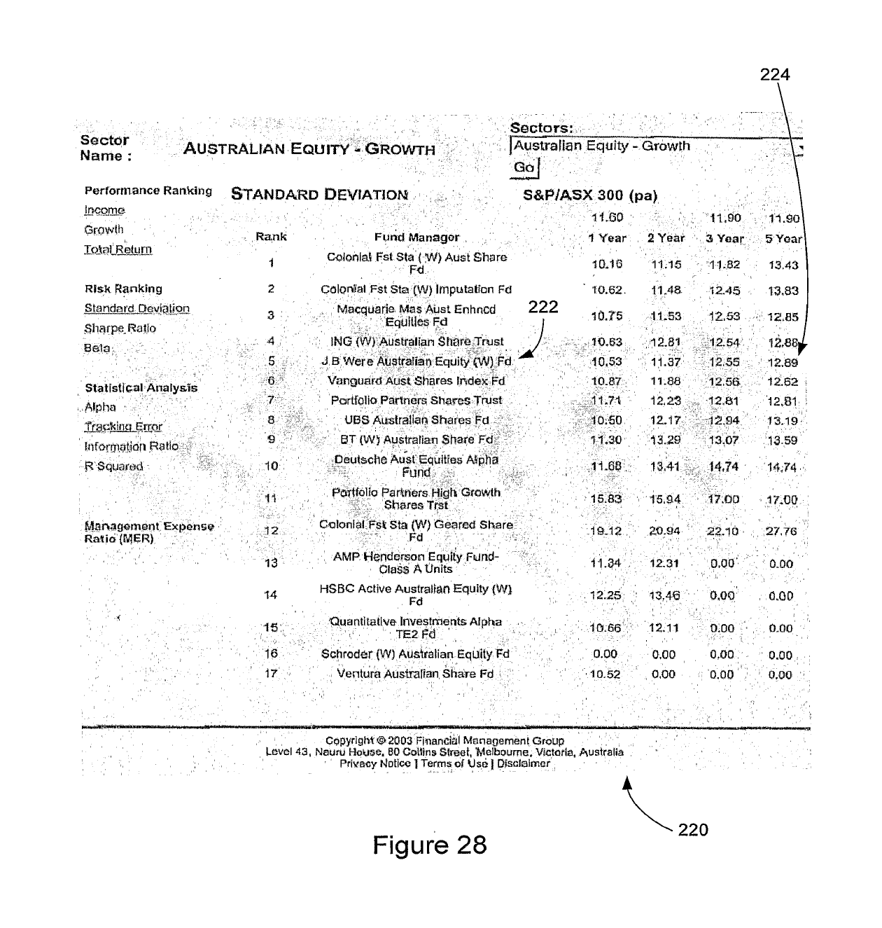

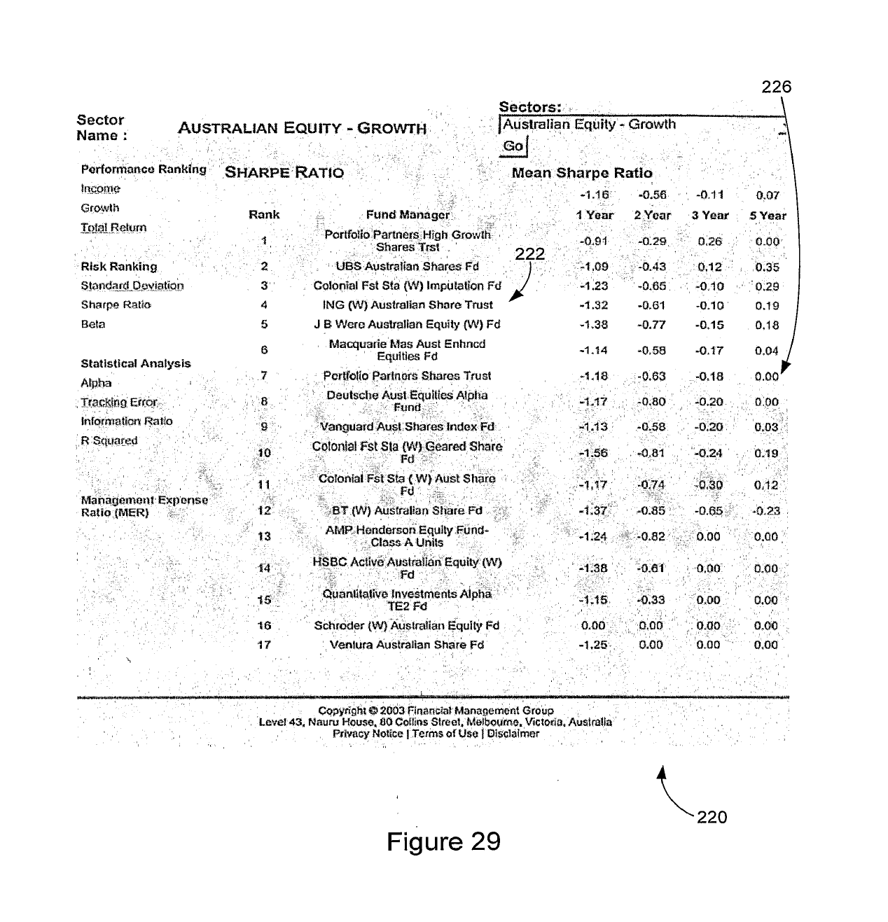

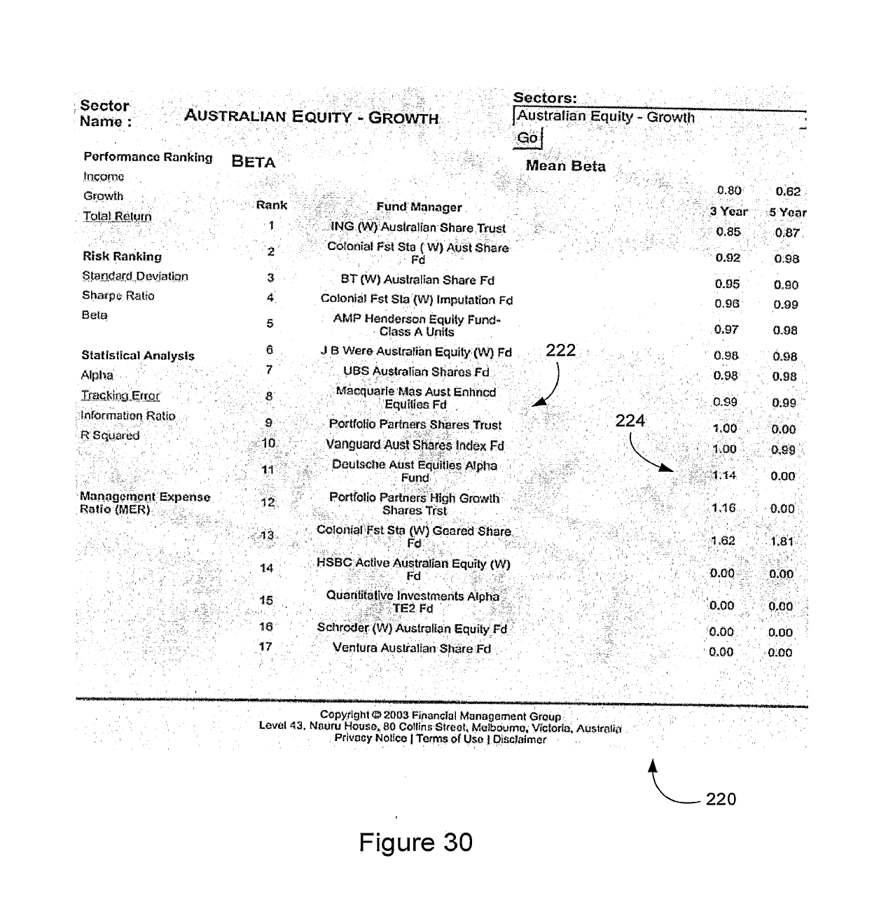

The risk ranking spreadsheet 220, shown in FIGS. 28 to 30, includes statistics on the following indicators for each of the fund managers 222:
a. Standard deviation 224.
b. Sharpe Ratio 226.
c. Beta 228

FIGS. 28 to 30 show the fund managers 220 ranked by each of the above indicators respectively. The statistics generated by the Indicator Ranking Interface 212 for the Standard Deviation 224 and Sharpe Ratio 226 indicators are based on the fund managers performance over the past one year, two years, three year and five years. The statistics generated by the Indicator Ranking Interface 212 for the Beta 228 indicators is based on the fund managers performance over the past three year and five years.

The statistical analysis spreadsheet 230 that includes statistics on the following indicators for each of the fund managers 232:
a. Alpha 234.
b. Tracking Error 236.
c. Information Ratio 238.
d. R Squared 240.

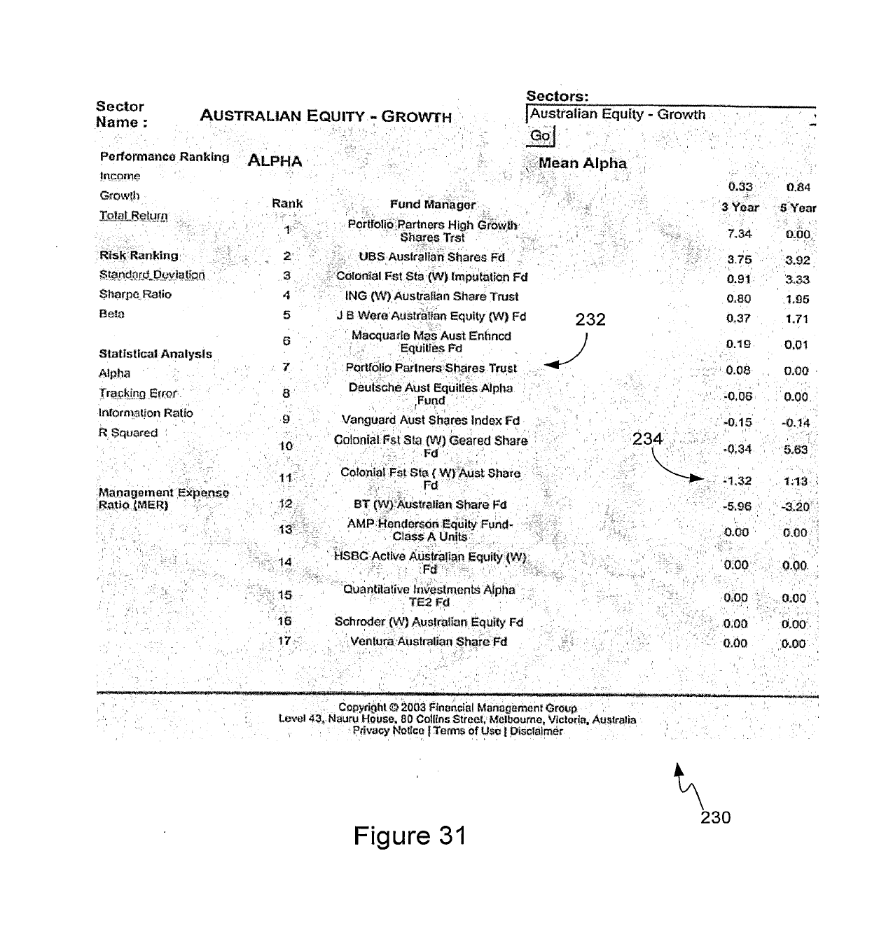

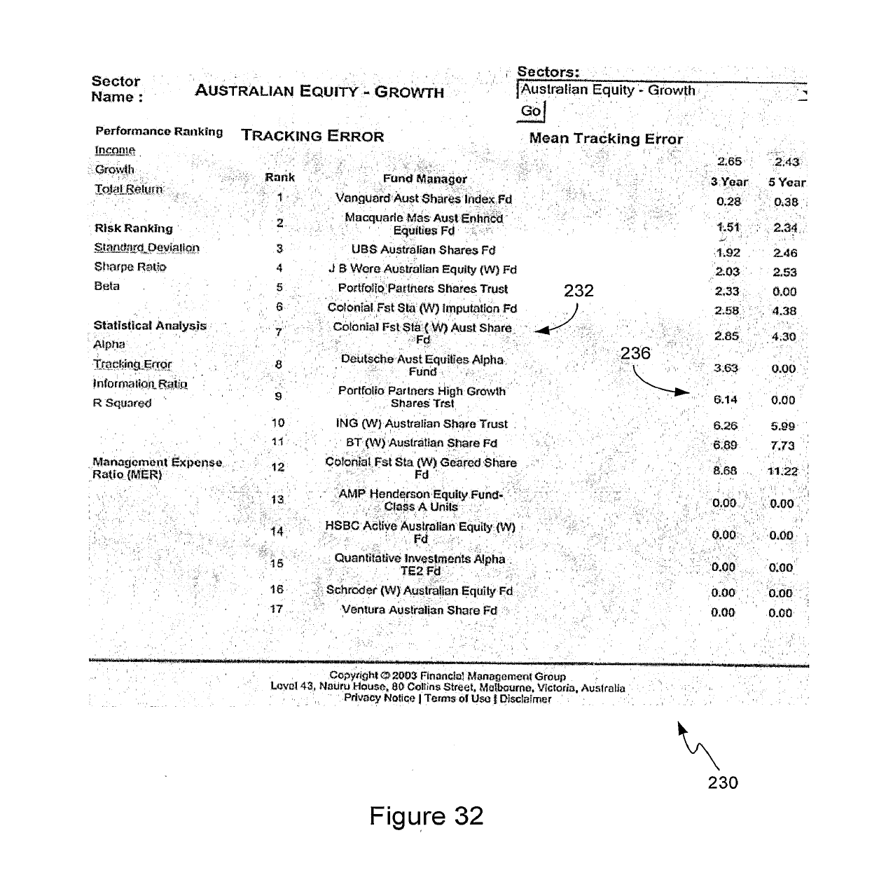

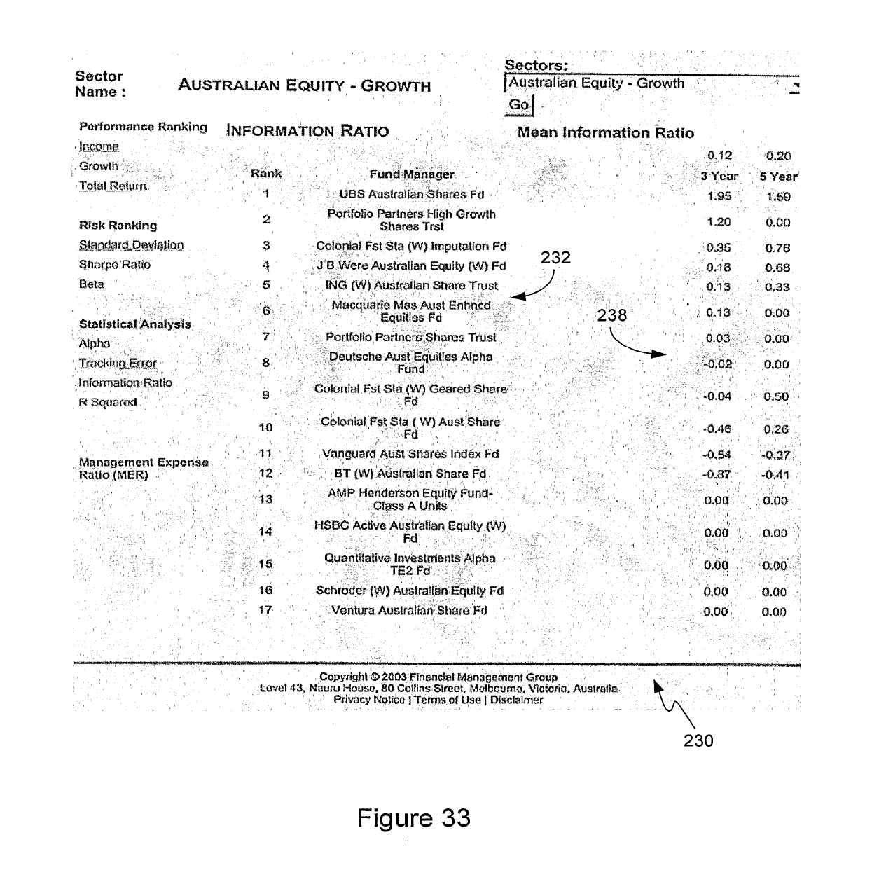

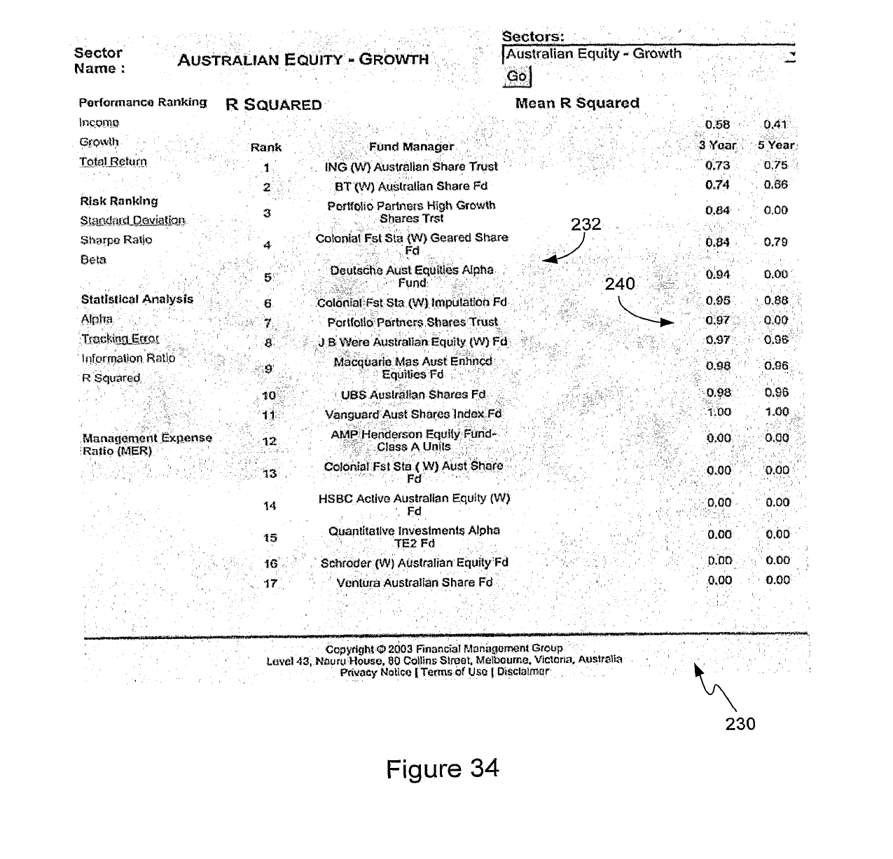

FIGS. 31 to 34 show the fund managers 232 ranked by each of the above indicators respectively. The statistics generated by the indicator ranking interface 212 for the above indicators are based on the fund manager's performance over the past three years and five years only.

The indicator ranking interface 212 provides information to assist the financial planner 151 in selecting fund managers that suit the risk tolerance of the investor 105.

The system 100 allows a financial planner 115 to directly access the portfolio construction interface 164 of a pre-existing investment portfolio of an investor. The financial planner 115 can use the portfolio construction interface 164 to adjust the investment portfolio in accordance with changes in market trends and/or investor's needs.

The following codes are used to implement that the fund manager system 100:

1. Fundmanager.java
This program declares the fund manager class, all of the variables (indicators), all of the Mutator and Accessor methods and some additional methods to be used in the build up of the Fund Manager web application.
2. FundManagerDriver.java
This program extracts all of the necessary data from the database 16 and stores the data in the form of a hash map. The program then writes the hash map into servlet files. The following servelet files are written into and then stored in the objects directory 46:
a. fundmanagers.ser
b. fundManagersSectorWise.ser
   3. DataUploadServlet.java
   This program (Java Class) loads and initiates the servlet class and initializes the servlet. The data is initially read from the .ser files to a map and then a database helper object is created by the web context listener. The DataUploadServlet.java program is configured in the Web.xml file 36.

### 4. Web.xml

This is the XML document (deployment descriptor) in which the DataUploadServlet.java, i.e. th servlet, is described.

### 5. Performance.jsp

This program extracts the data corresponding to Performance indicators of the fund managers from the database 16 and displays the data in a spreadsheet format. The program allows the user to select fund managers.

### 6. Risk.jsp

This program extracts data corresponding to risk and statistical indicators of the fund managers and displays the data in a spreadsheet format. The program allows the user to select fund managers.
7. result.jsp—This program loads the contact attribute from the servlet and uses the methods from Fund.Manager.java and also HTML to display the interface.
8. secondPage.jsp
This program loads the second part of the interface which contains performance, risk and statistical indicators for the user to have a look at the fund managers performance.

### 9. Investment.jsp

This program determines the estimated income calculation of the portfolio once the user inputs the amount of assets that he wants into the portfolio.

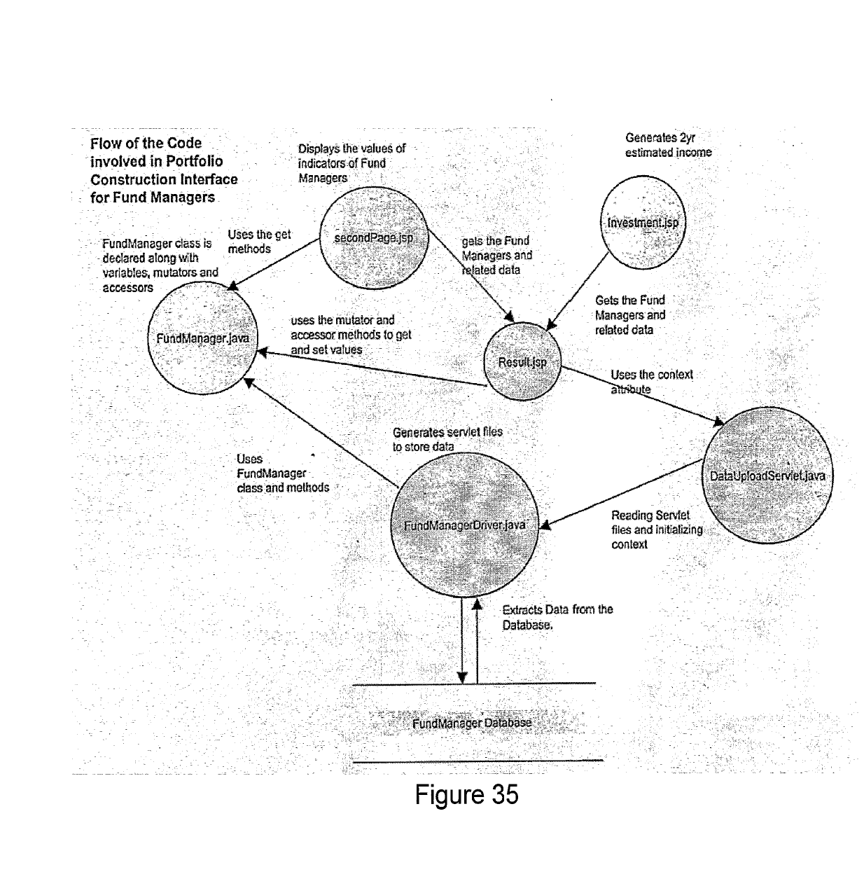

The FundManager directory 40 also includes the database 16. The database 16 includes all of the legacy data of the computer system 12. The flow of the code involved in generating the Portfolio Construction Interface is shown in FIG. 35.

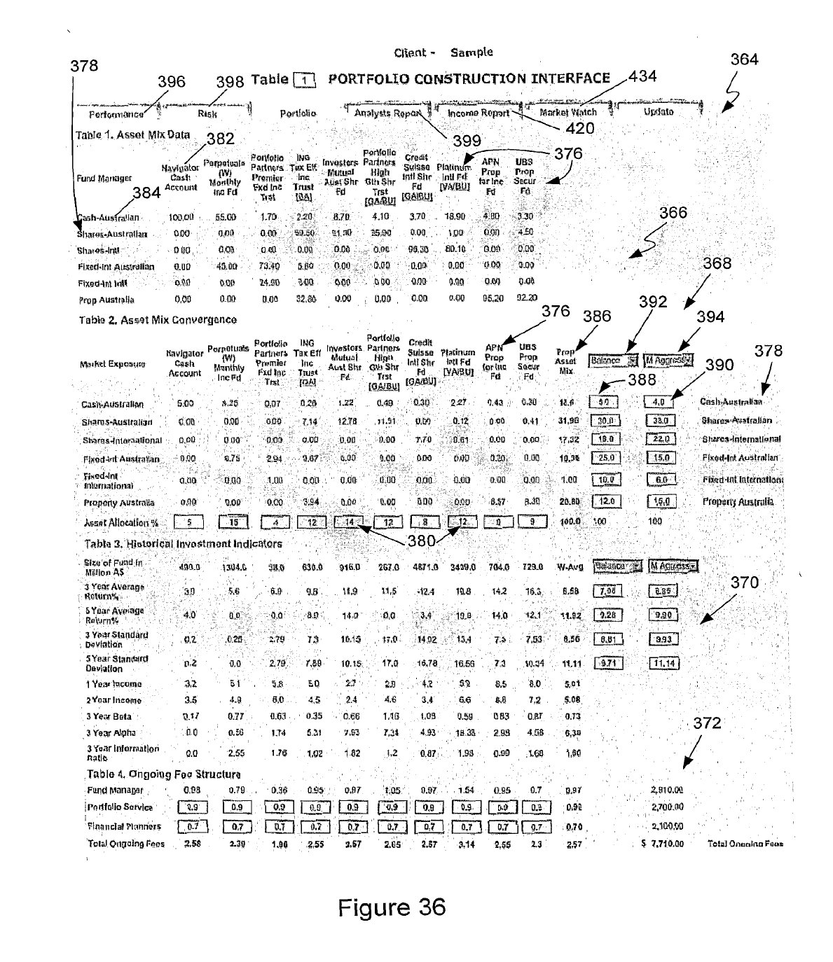

In an alternative embodiment, the fund managers selected using the selection spreadsheet interface 116 populate the following tables of the portfolio construction interface 364 shown in FIG. 36:
1. Asset Mix Data 366.
2. Asset Mix Convergence 368.
3. Historical Investment Indicators 370.
4. Ongoing Fee Structure 372.

The Asset Mix Data table 366 includes a column for each of the fund managers 376 selected by the financial planner 115 and a row for each of the following asset classes:
a. Cash—Australian
b. Shares—Australian
c. Shares—International
d. Fixed Interest—Australian
e. Fixed Interest—International
f. Property—Australian

The asset mix data table 166 shows the distribution of assets over the above asset classes 378 for each selected fund manager.

The asset mix convergence table 368 includes a column for each of the selected fund managers and a row for each of the above asset classes 378. In addition, the asset mix convergence table 368 includes a row of data boxes 380, one for each of the selected fund managers 376. The financial planner 115 can allocate a percentage of the investor's assets to a selected fund managers 376 by entering the desired percentage into the respective fund manager's data box 380. One hundred percent of the investor's assets are allocated to the selected fund managers 376 in the described manner.

For each selected fund manager 376, the asset mix convergence table 368 shows the distribution of assets in each mentioned asset class multiplied by the percentage of the investor's assets allocated to the relevant fund manager 376. For example, the asset mix data table 366 indicates that the Navigator Cash Account fund manager 382 allocates 100% of its assets to the asset class Cash—Australian 384. The asset mix convergence table 368 indicates that the Navigator Cash Account fund manager 382 was allocated 5% of the investor's assets by the financial planner 115. The asset mix convergence table 368 also indicates that 100%) of the 5% of assets allocated to the Navigator Cash Account fund manager 382 was allotted to the Cash—Australian asset class 384.

The asset mix convergence table 168 also includes a column 386 that, for each asset class, shows the sum of the entries across the table 368 for each of the selected fund managers 376. Thus, the rows of the proposed asset mix column 386 show the distribution of assets of the investment portfolio over the above mentioned asset classes 378, where the distribution is weighed by the investor's asset allocation to each of the selected fund managers 376.

In addition, the asset mix convergence table 368 includes two columns 388,390 that each indicate benchmark asset distributions over the asset classes 378 for respective benchmark risk categories. The benchmark risk category of each of these columns 388,390 can be selected from respective drop down lists 392,394 of the asset mix convergence table 368.

The financial planner 115 can display the values for the mentioned classes 378 for the benchmark risk category of the investor 105 using the first drop down window 392, for example. The financial planner 115 can then compare these values with the values in the proposed asset mix column 386. In addition, the financial planner 115 can display the values for the mentioned asset classes 378 for another benchmark risk category using the second drop down window 394.

The financial planner 115 and/or the investor 105 can compare the values of the proposed asset mix column 386 with the values of the asset classes of the investor's benchmark risk category. The financial planner 115 and/or the investor 105 can thereby observe how closely the proposed asset mix of the investment portfolio corresponds to the asset mix of the relevant benchmark risk category. The financial planner 115 can change the selected fund managers 376 to increase, or decrease as the case may be, the degree to which the proposed asset mix corresponds to the benchmark risk category.

The plurality of data boxes 380 allow the financial planner 115 to apportion a percentage of the investor's assets to each of the selected fund managers 376. The financial planner 115 can change the proposed asset mix of the selected fund managers 376 by changing the percentage of assets allocated to each of the selected fund managers 376.

The degree to which the proposed asset mix column 386 corresponds to the values of the asset classes 378 of the benchmark risk category of the investor 105 indicates how closely the proposed investment portfolio corresponds to the benchmark risk category of the investor 105. In observing this, both the financial planner 115 and the investor 105 are aware of the risk associated with the investment portfolio. This risk is presented to the financial planner 115 by the Portfolio Construction Interface 364 and can be changed to suit the specific risk tolerance of the investor.

The historical investment indicator table 370 provides a means by which the financial planner 115 can compare the weighted average return and risk values of the selected fund managers 376 with the benchmark risk categories. The data presented in this table 370 allows the financial planner 115 to identify long-term themes in the market. On consideration of this data, if the financial planner 115 finds that the risk is too high, or some part of the asset allocation is higher than expected, then he or she can adjust the asset allocation values entered into the asset mix convergence table 368. On consideration of this data, if the financial planner 115 finds that the risk is too high, or some part of the asset allocation is higher than expected, then he or she can adjust the asset allocation values entered into the asset mix convergence table 168.

The ongoing fee structure table 374 displays the ongoing fees associated with the investment portfolio. The ongoing fee structure table 374 includes the fees for each of the selected fund managers 376. The ongoing fee structure table 374 also includes data boxes that allow the financial planner 115 to enter a portfolio service charge and a financial planner fee for each of the selected fund managers 376. The ongoing fee structure table 374 displays a summary of fees associated with each selected fund manager 376.

The financial planner 115 can change the selected fund managers 376 by executing either the Performance Spreadsheet function button 396 or the Risk and Allocation Spreadsheet function button 398. On execution of the Performance Spreadsheet function button 396, the system 100 generates the Performance Spreadsheet 118 shown in FIGS. 8 to 14. The financial planner is able to cancel previous fund manager selections and add additional fund managers by clearing and marking checkboxes 143 associated with each of the listed fund managers.

On execution of the Risk and Asset Allocation Spreadsheet function button 398, the system 100 generates the Risk and Allocation Spreadsheet 120 shown in FIGS. 15 to 21. The financial planner is able to cancel previous fund manager selections and add additional fund managers by clearing and marking checkboxes 143 associated with each of the listed fund managers.

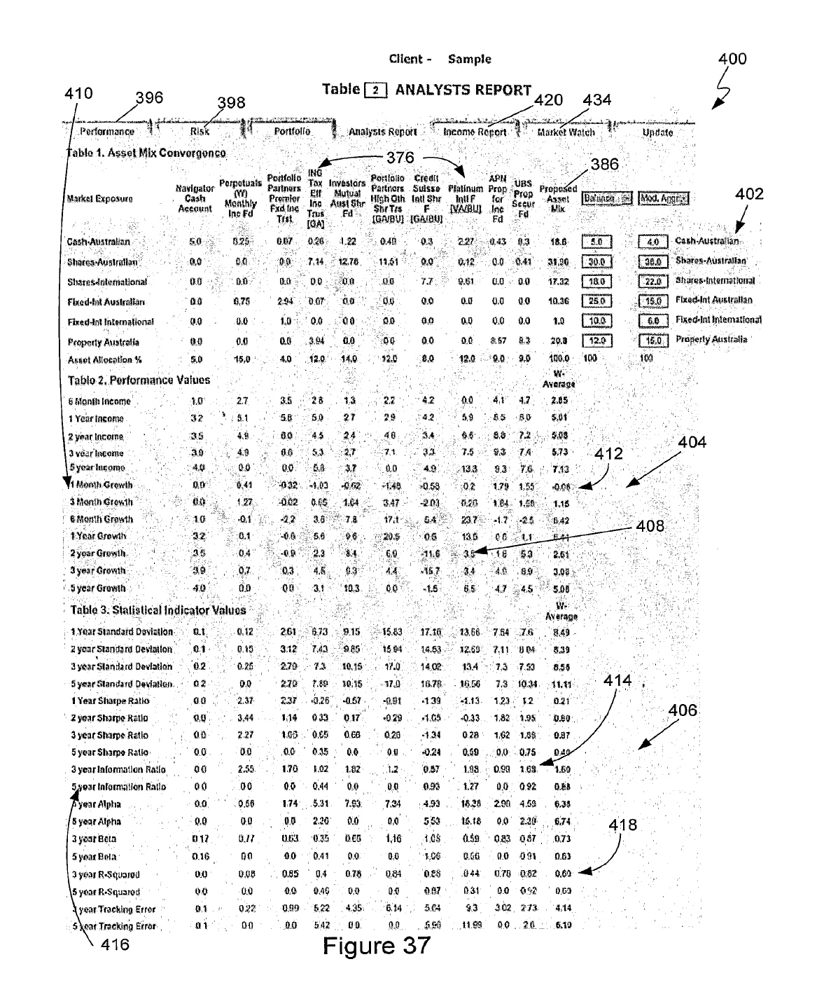

Once the financial planner 115 is satisfied that he or she has selected the right fund managers 376 for the investment portfolio and adequately adjusted the proposed asset mix column to satisfy the investor's risk objectives, then the financial planner 115 executes the Analysis Report function button 399 and the system 100 generates the Analysts Report Interface shown in FIG. 37. The Analysts Report interface 400 includes the following three tables:
1. Asset Mix Convergence table 402
2. Performance Values table 404
3. Statistical Indicator Values table 406

The Asset mix convergence table 406 is a finalised version of the asset mix convergence table 368 shown in FIG. 36. The performance Values table 404 includes data 408 on each of the selected fund managers 376 for different performance indicators 410, as well as data 412 on the proposed asset mix of the investment portfolio for the different performance indicators 410.

The Statistical Indicator Values table 406 includes data 414 on each of the selected fund managers 376 for different statistical indicators 416, as well as data 418 on the proposed asset mix 386 of the investment portfolio for the different performance indicators 416.

The Analysts Report Interface 400 allows the financial planner 115 to review the investment portfolio that he or she has constructed using known performance values and statistical indicator values.

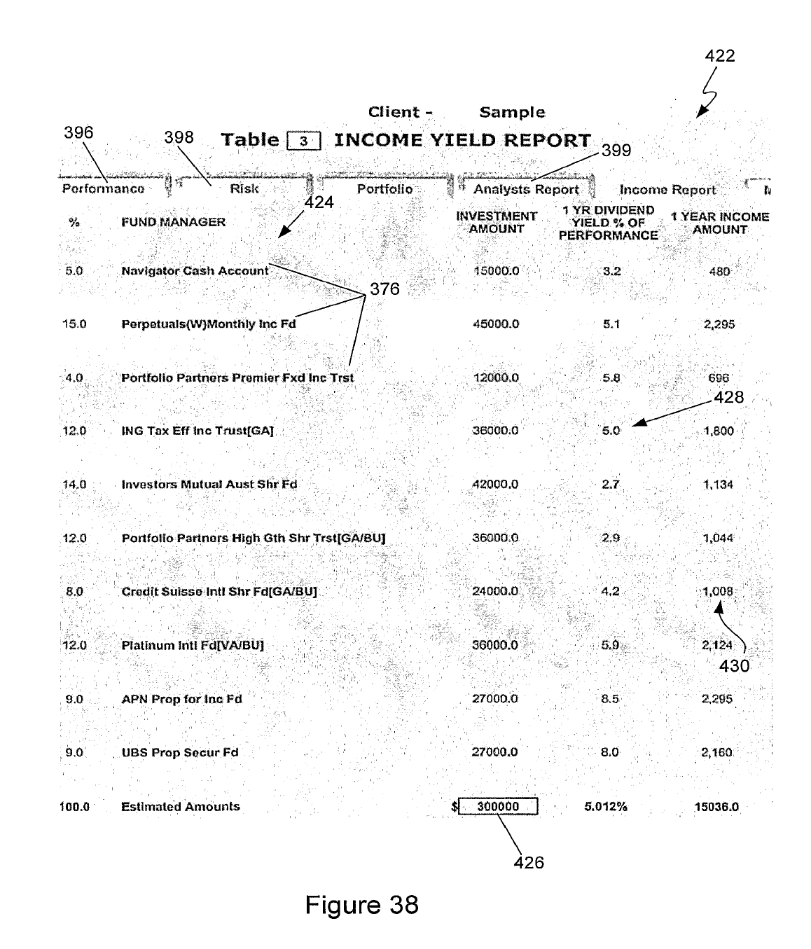

Once the financial planner 115 is satisfied that the investment port folio adequately meets the objectives of the investor 105, then the financial planner 115 executes the Income Yield Report function button 420 and the system 100 generates the Income Yield Report Interface 422 shown in FIG. 38. The Income Yield Report Interface 422 includes a list 424 of the fund managers 376 selected by the fund manager 115. The Income Yield Report Interface 422 includes a text box 426 allows the financial planner 115 to enter the monetary amount of the assets that the investor 105 wishes to invest in the investment portfolio. Once an amount is entered into the text box 426, the Income Yield Interface 422 generates an estimate of the one year dividend yield 428 for each selected fund manager 376 as well as the one year income amount 430 for each selected fund manager 376. The Income Yield Report Interface 422 also generates projected income of the investment portfolio over a period of one year, for example. The Income Yield Report Interface 422 generates this data using the one year performance values of the selected fund managers 376, for example.

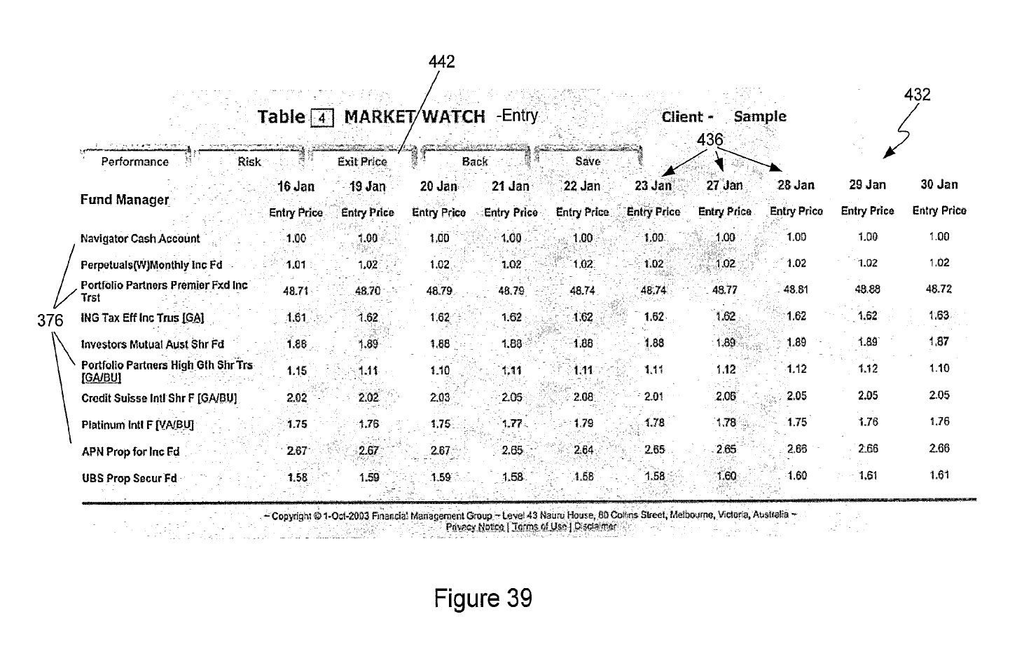

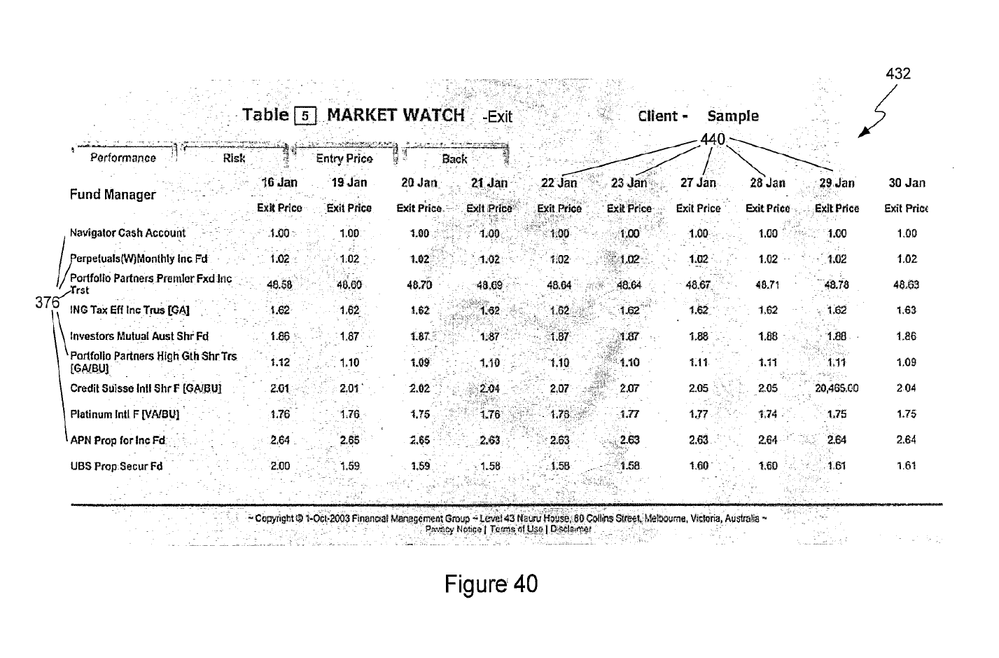

The financial planner 115 can generate the Market Watch Entry Interface 432 shown in FIG. 39 by executing the Market Watch function button 434. The short-term price movement of the selected fund managers 376 are represented by 10 consecutive day entry prices 436. The short-term price movement of the selected fund managers 376 are also represented by 10 consecutive day exit prices 440 shown in FIG. 40. The financial planner can access the 10 consecutive day exit prices by executing the function button 442. The share markets are unpredictable and yet may lead many to conclude that the share markets are efficient and all relevant information is reflected in the asset price. A trend picker picks may identify a warning signal using the market watch interface 432 and reduce their exposure while the market situation that triggered the warning clarifies. Since no such trend is totally reliable, i.e. warning signals depend on economic situations such as inflation rate, 90 day bill rate, 10 year bond rate, monthly balance of payments, budget projections up and coming reporting sessions, global predictions, etc.

The system 100 can generate the above-described Indicator Ranking Interface 212 by executing the to evaluate the performance of the fund managers. The Indicator Ranking Interface 212 extracts data from the database 117 on fund managers for a nominated economic sector and displays the data in the form of one of the following spreadsheets:
1. Performance Ranking.
2. Risk Ranking.
5. Statistical Analysis.

The performance ranking spreadsheet 214, shown in FIGS. 25 to 27, displays fund managers 216 for the Australian Equity-Growth Sector. FIGS. 25 to 27 list the fund managers 216 in accordance with their relative performance based on the following indicators:
a. Income,
b. Growth.
c. Total Return.

FIGS. 25 to 27 show data 218 for each fund manager 216 for each of the above indicators respectively. Data on each fund manager's performance over the past six months, one year, three years, five years and seven years is shown.

The risk ranking spreadsheet 220, shown in FIGS. 28 to 30, includes statistics on the following indicators for each of the fund managers 222:
a. Standard deviation 224.
b. Sharpe Ratio 226.
c. Beta 228

FIGS. 28 to 30 show the fund managers 220 ranked by each of the above indicators respectively. The statistics generated by the Indicator Ranking Interface 212 for the Standard Deviation 224 and Sharpe Ratio 226 indicators are based on the fund managers performance over the past one year, two years, three year and five years. The statistics generated by the Indicator Ranking Interface 212 for the Beta 228 indicators is based on the fund managers performance over the past three year and five years.

The statistical analysis spreadsheet 230 that includes statistics on the following indicators for each of the fund managers 232:

g. Alpha 234.

h. Tracking Error 236.

i. Information Ratio 238.

j. R Squared 240.

FIGS. 31 to 34 show the fund managers 232 ranked by each of the above indicators respectively. The statistics generated by the indicator ranking interface 212 for the above indicators are based on the fund manager's performance over the past three years and five years only.

The indicator ranking interface 212 provides information to assist the financial planner 151 in selecting fund managers that suit the risk tolerance of the investor 105.

The system 100 allows a financial planner 115 to directly access the portfolio construction interface 164 of a pre-existing investment portfolio of an investor. The financial planner 115 can use the portfolio construction interface 164 to adjust the investment portfolio in accordance with changes in market trends and/or investor's needs.

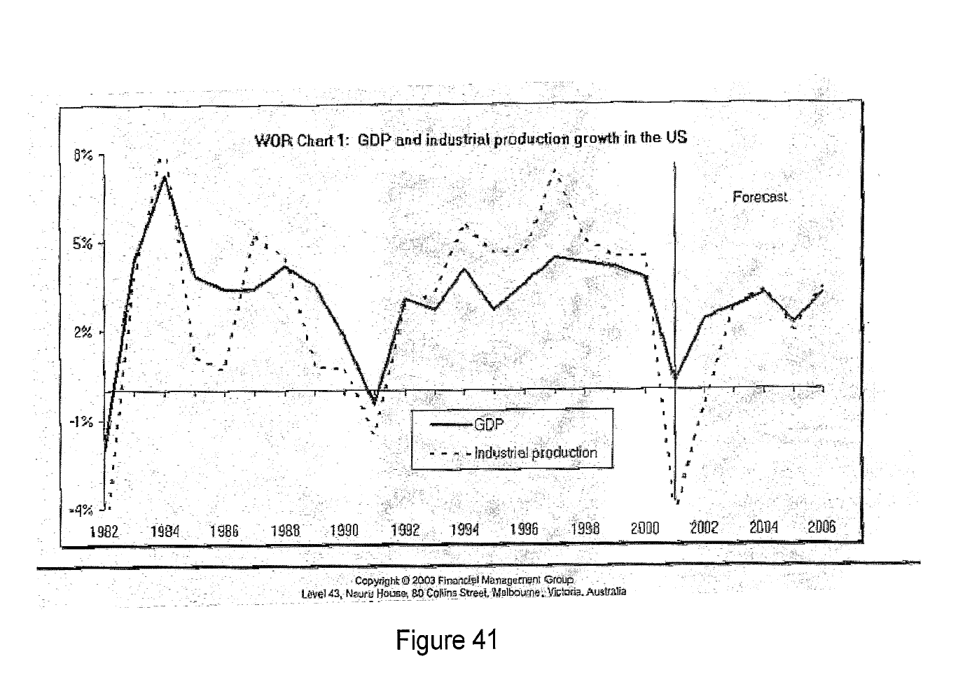

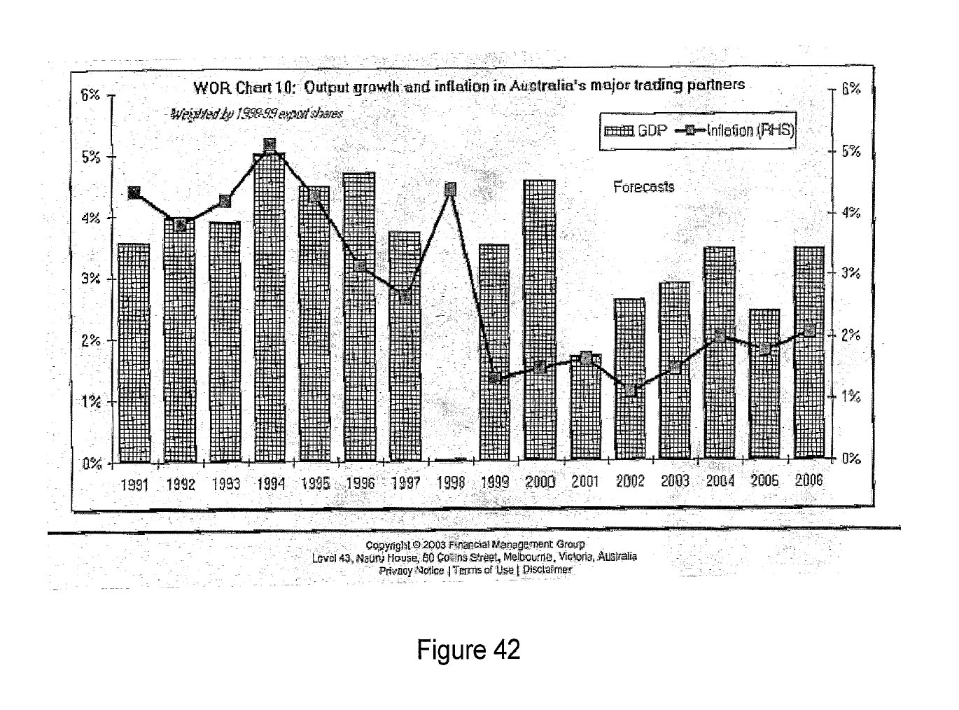

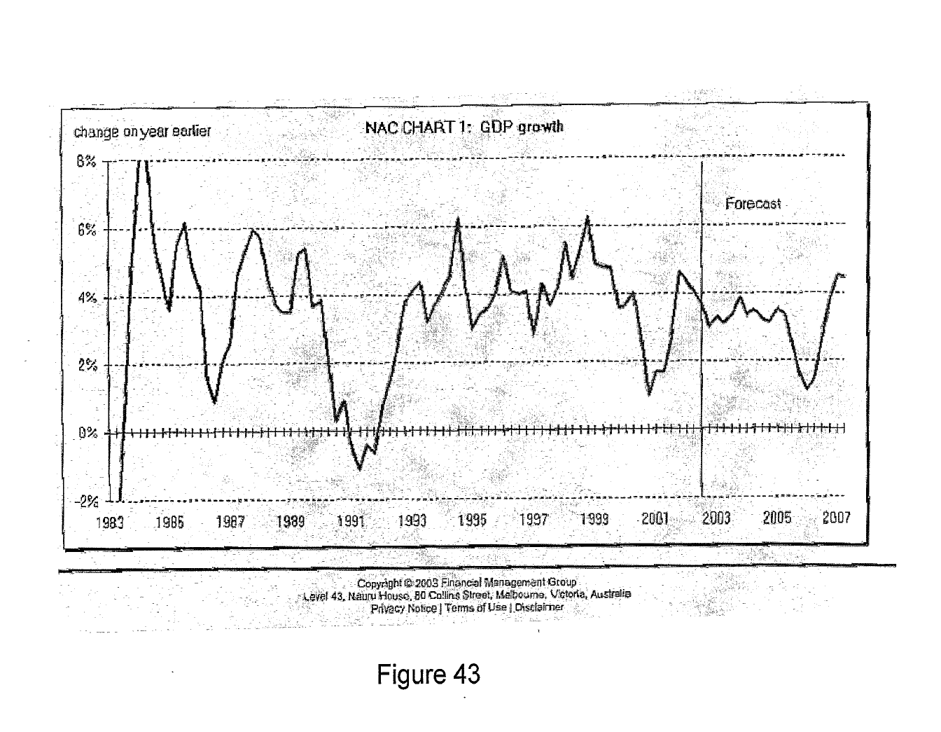

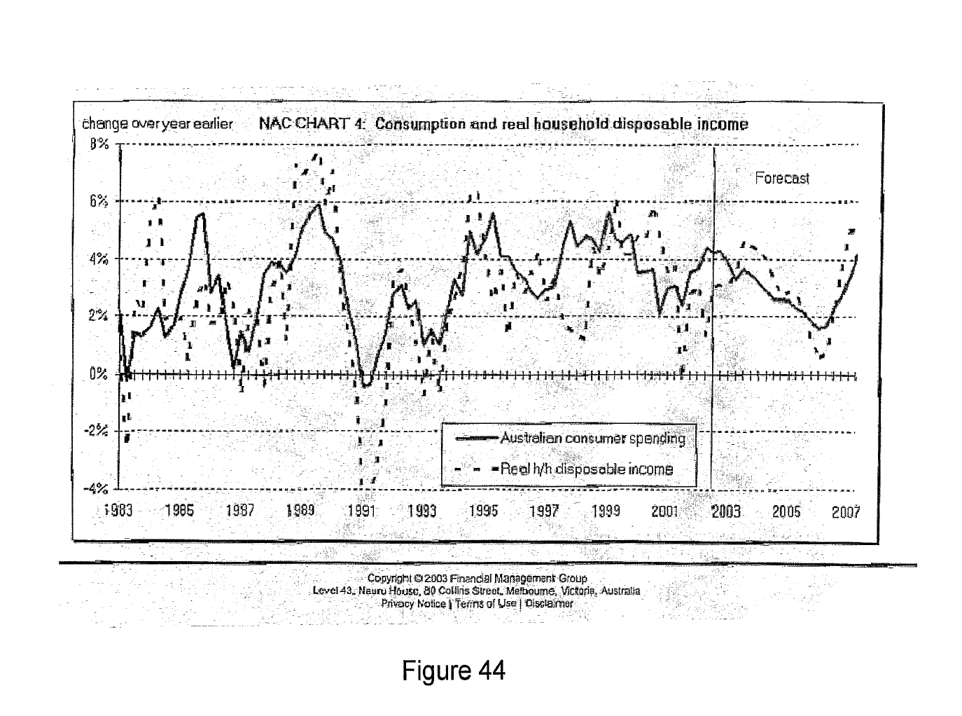

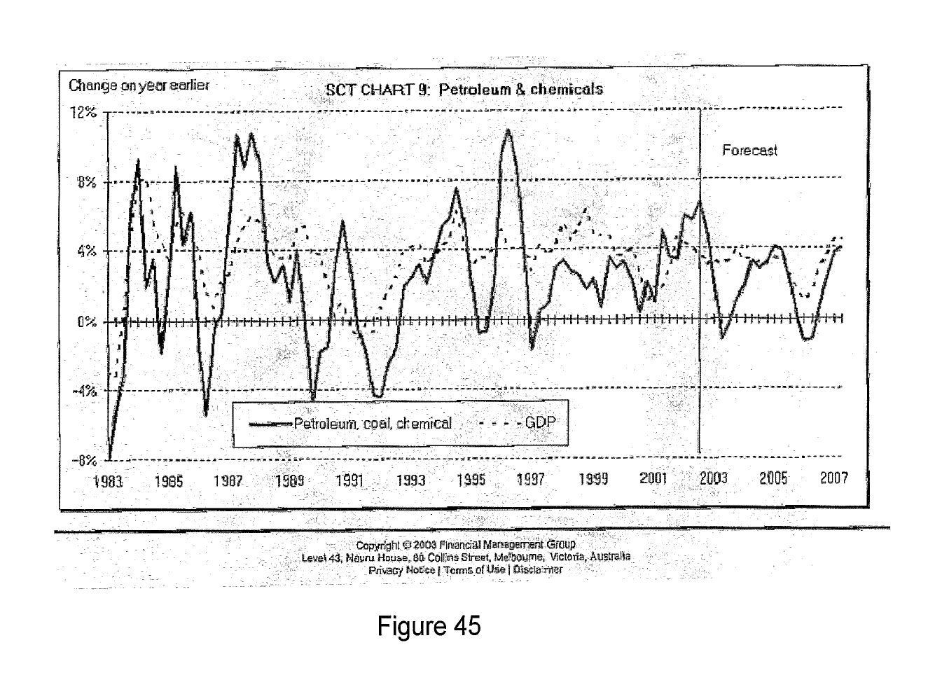

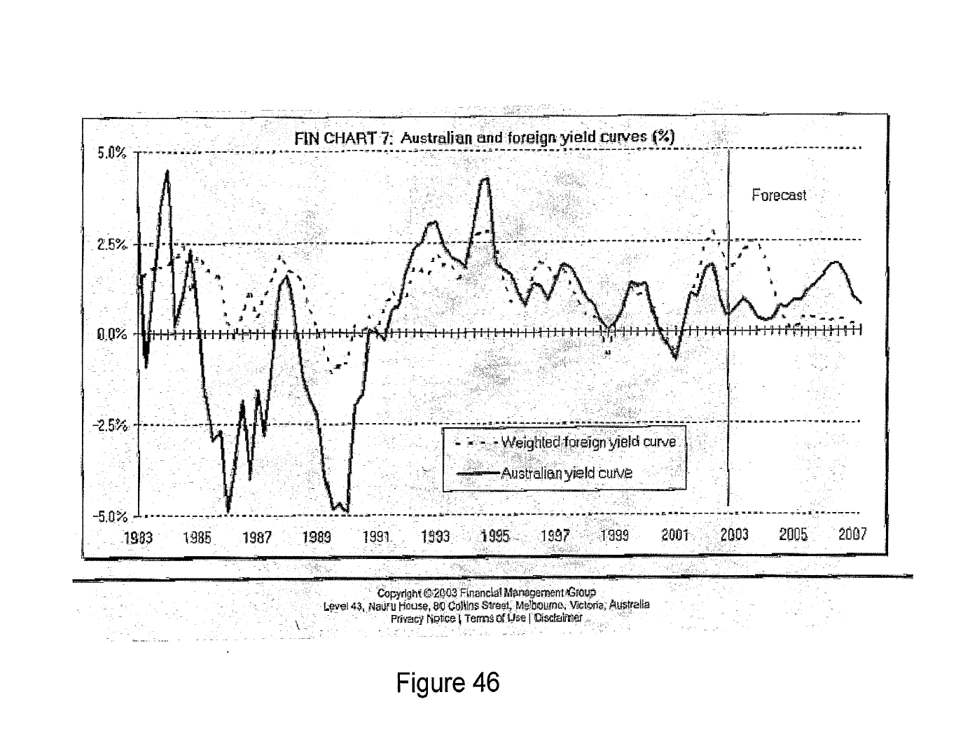

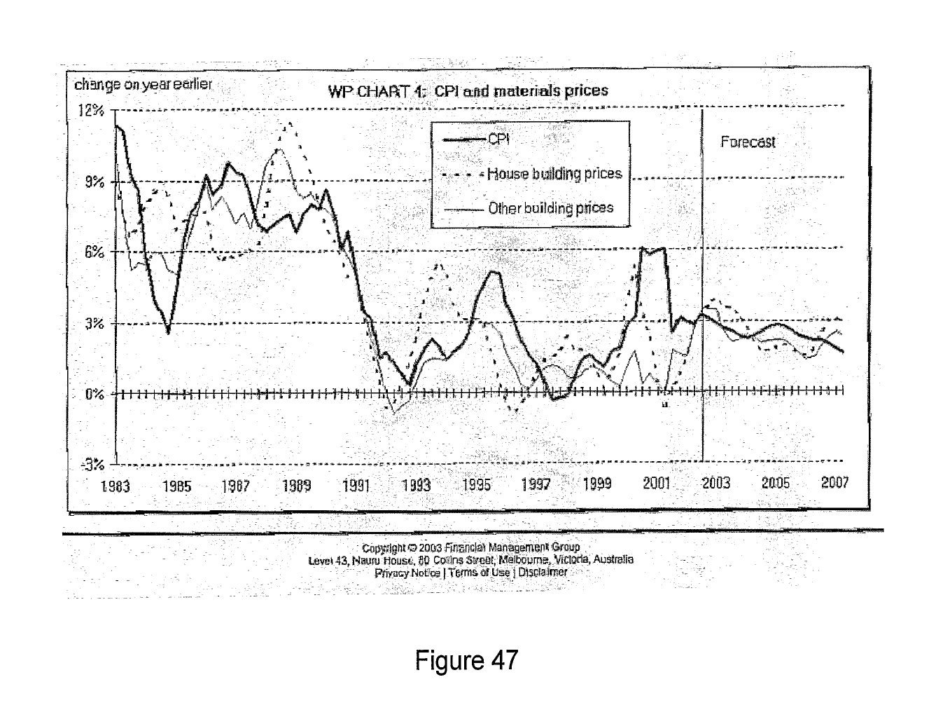

In one embodiment of the invention, the system 100 includes a Macro Trend Forecasting Interface (not shown). The Macro Trend Forecasting Interface includes graphical representations showing data on each of the following economic indicators:
1. World Outlook—GDP and Industrial production growth in the US (see FIG. 41), Output growth and inflation in Australia's major trading partners (see FIG. 42).
2. Australian Outlook—GDP Growth (see FIG. 43), Consumption and Real Household disposable Income (see FIG. 44).
3. Key Growth Sectors (GICS)—Petroleum and Chemicals (see FIG. 45).
4. Financial markets—Australian and foreign yield curves (see FIG. 46).
5. Domestic Wages and Prices—CPI and materials prices (see FIG. 47).

The financial planner 115 is able to use this information to identify longer-term themes based on demographic trends plus technological, political and social developments. As well as this thematic analysis, quantitative value/momentum models are used to identify tactical sector opportunities. Both inputs are used in combination to identify sectors to over weight or under weight an investor's investment portfolio.

Profitable investment strategies require a selection of tools to determine entry and exit positions and to anticipate market behaviour. Different tools are generally best applicable to certain markets. Profitable investment strategies may involve long-term; medium-term or short-term. The system 100 provides a financial planner 115 with both top down and bottom up analysis tolls to make investment decisions on behalf of his or her clients.

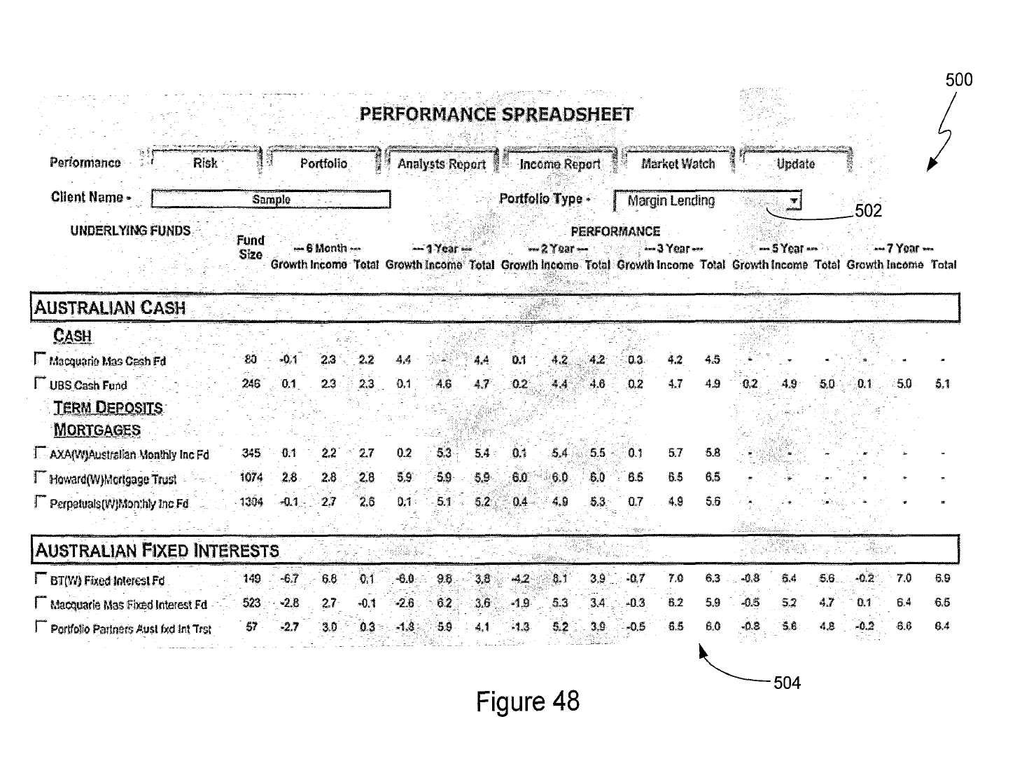

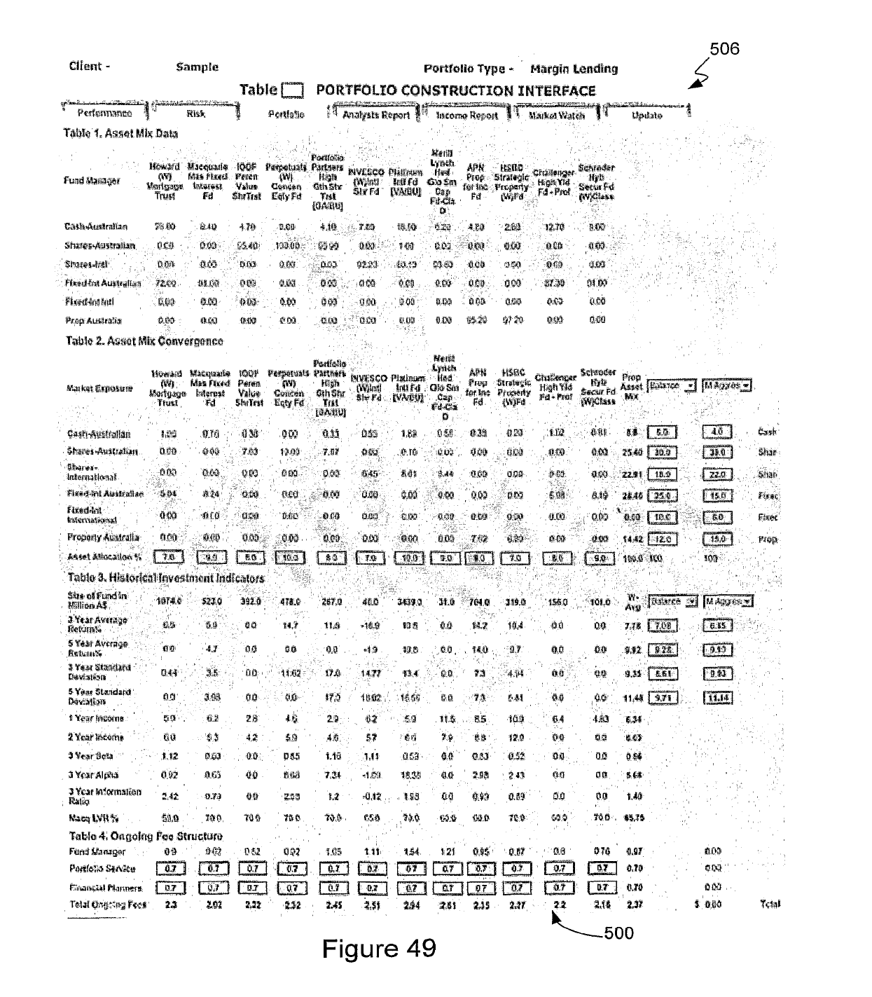

The system 100 is can be used for margin lending investment portfolios. An example of a margin lending portfolio 500 for managed funds is shown in FIGS. 48 and 49. The margin lending portfolio 500 is selected from other investment portfolio types available using the “Profile Type” dropdown window 502 shown in FIG. 48. FIG. 48 shows an example of a risk and asset allocation selection spread sheet 504 of the selection spread sheet interface 116. The risk and asset allocation selection spread sheet 504 functions in an analogous manner to that of the risk and asset allocation selection spread sheet 120 shown in FIG. 15.

FIG. 49 shows an example of a portfolio construction interface for margin lending 506. The portfolio construction interface for margin lending 506 functions in an analogous manner to that of the portfolio construction interface 364 shown in FIG. 36.

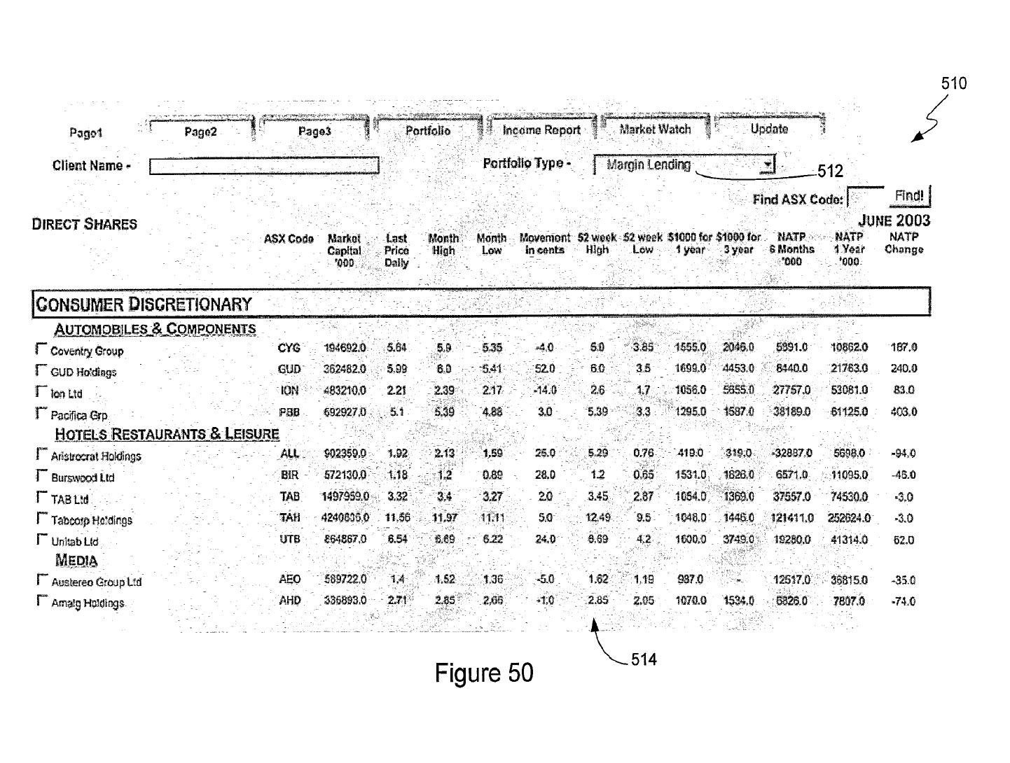

An example of a margin lending portfolio 510 for direct shares is shown in FIGS. 50 to 52. The margin lending portfolio for direct shares 510 is selected from other investment portfolio types available using the “Profile Type” dropdown window 512 shown in FIG. 48. FIG. 48 shows an example of a risk and asset allocation selection spread sheet 514 of the selection spread sheet interface 116. The risk and asset allocation selection spread sheet 514 functions in an analogous manner to that of the risk and asset allocation selection spread sheet 120 shown in FIG. 15.

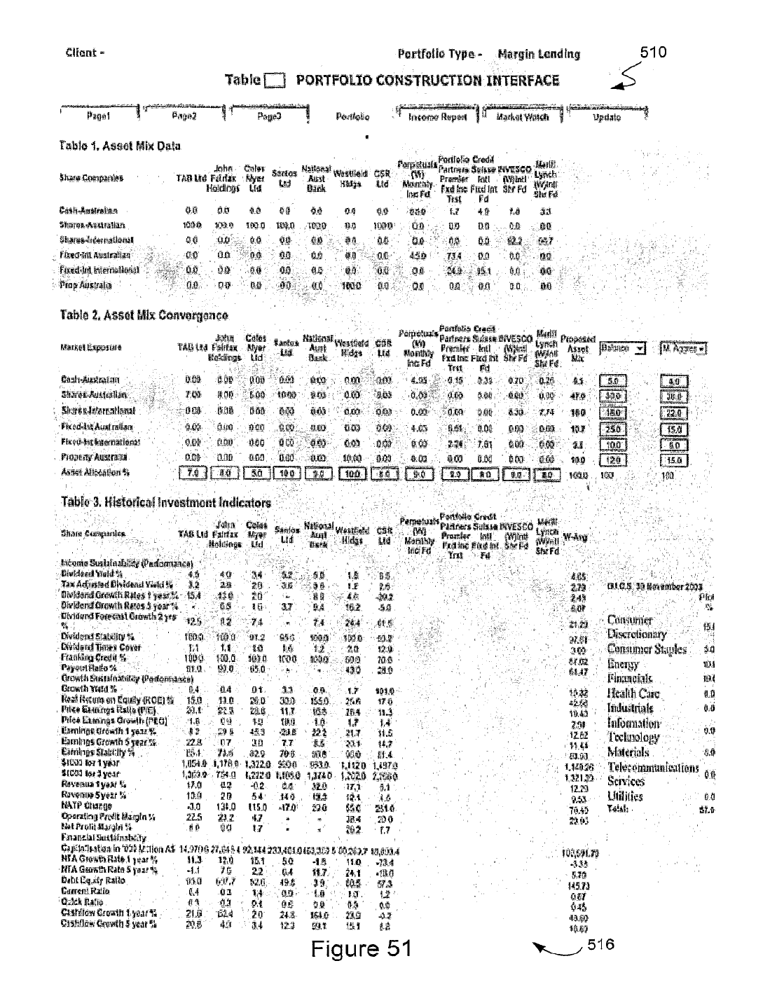

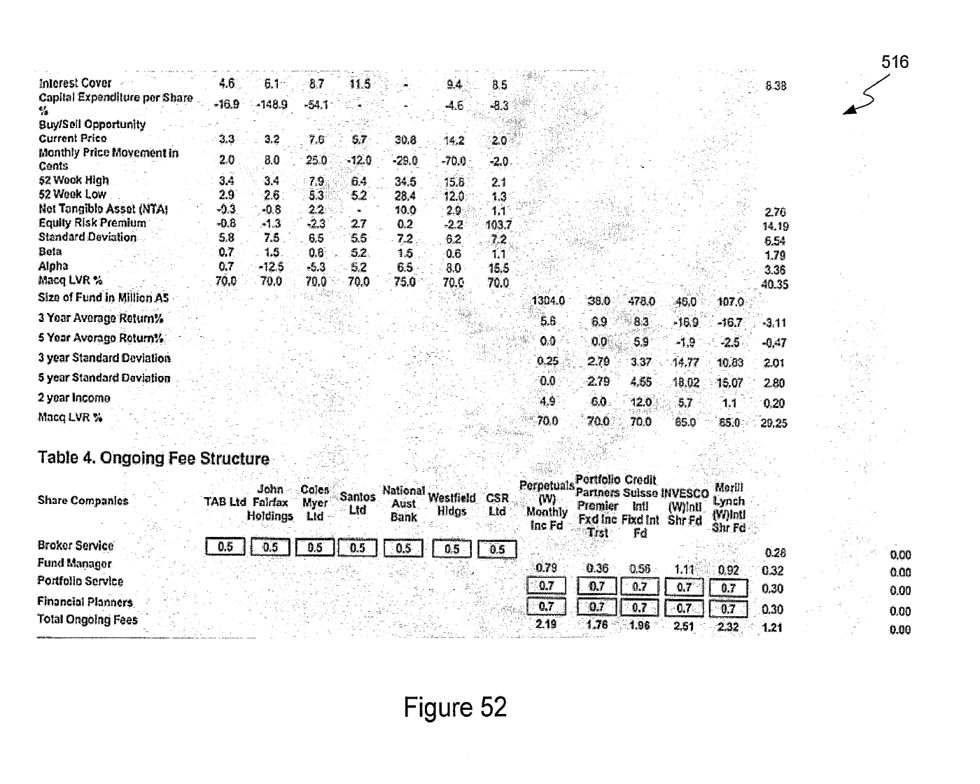

FIGS. 51 and 52 show an example of a portfolio construction interface for margin lending 516. The portfolio construction interface for margin lending for direct shares 516 functions in an analogous manner to that of the portfolio construction interface 364 shown in FIG. 36.

Another preferred embodiment of the computer system is hereafter described. It will be apparent to those skilled in the relevant art that the computer system could be implemented in a number of different ways. However, the most practical implementation of the components of the computer system is a software implementation. The computer system is partitioned into the following areas:
1. Client Risk Profiling
   a. Risk tolerance Questionnaire;
   b. Investor Score;
   c. Risk Meter; and
   d. Style Investor Type.
2. Micro Portfolio Selection
   a. Managed Funds
      i. Sector Funds Sheet; and
      ii. Fund Manager Ranking.
   b. Direct Shares
      i. Sector Spreadsheet; and
      ii. Fundamental Ranking.
3. Macro Portfolio Selection
   a. Leading Trend Indicators
      i. World Outlook;
      ii. Australian Outlook;
      iii. Key Growth Sectors;
      iv. Financial Markets; and
      v. Global Domestic Prices.
4. Portfolio Construction;
   a. Asset Allocation;
   b. Client Profiling;
   c. Fee Structure;
   d. Income Report;
   e. Client Scenario;
   f. Analysis Report; and
   g. Market Wrap.

A discussion on the above aspects of the computer system are set out below.

1. Client Risk Profiling

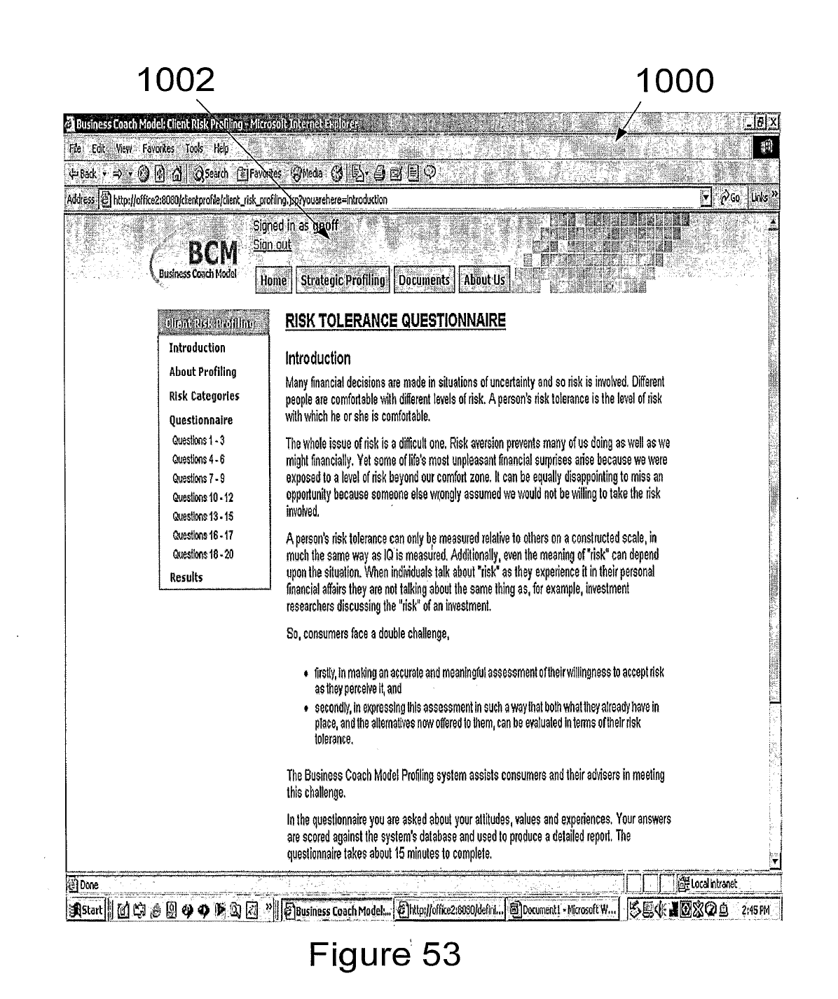

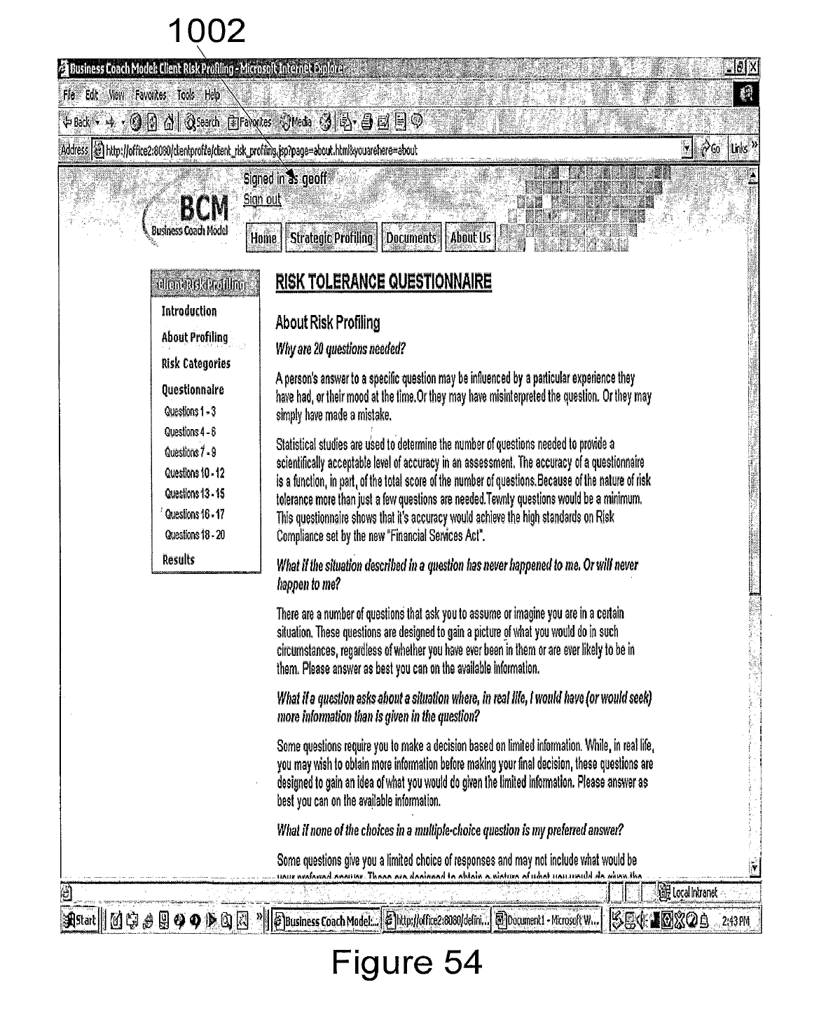

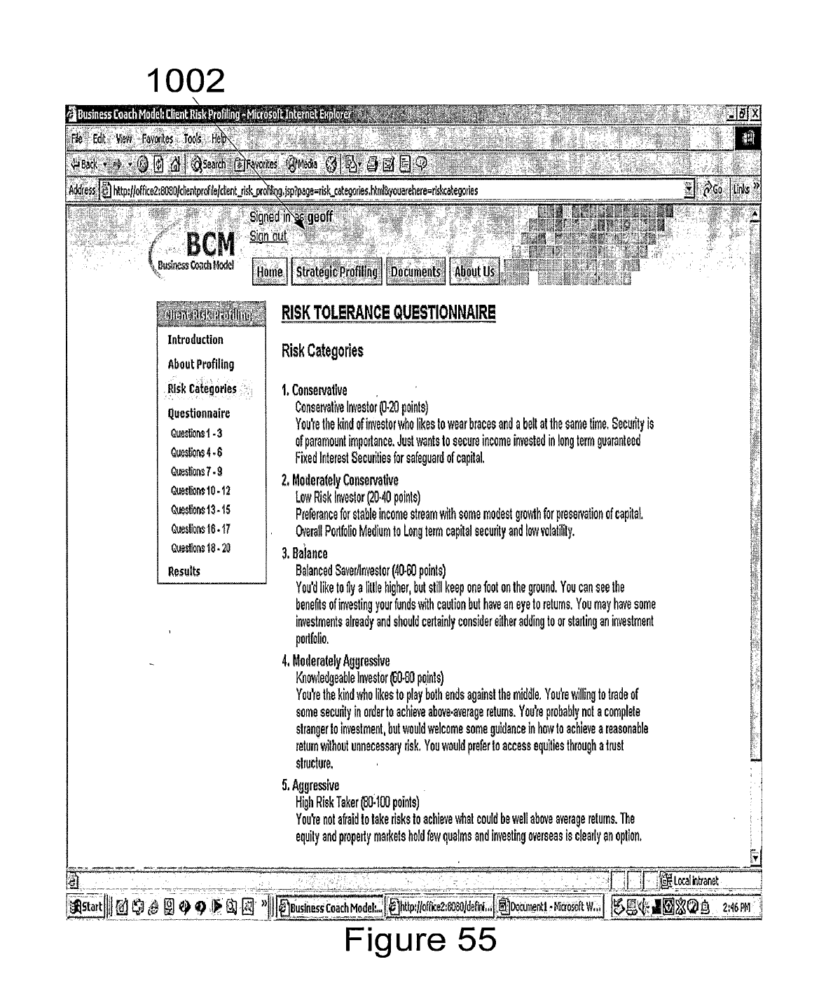

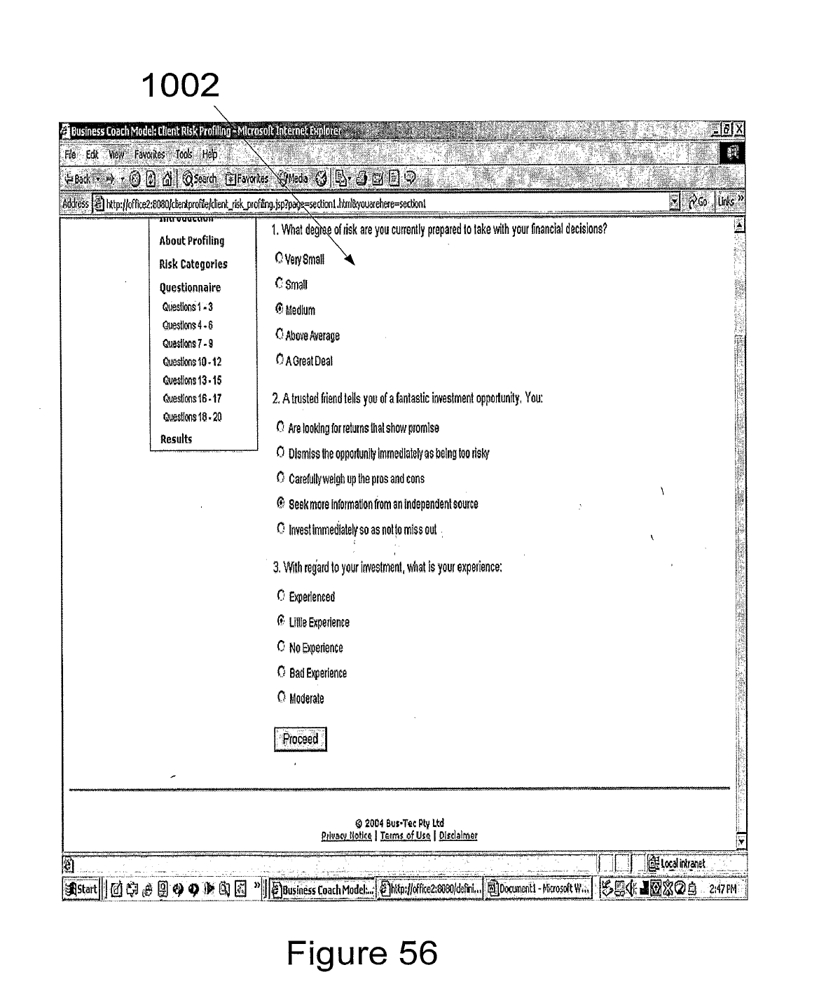

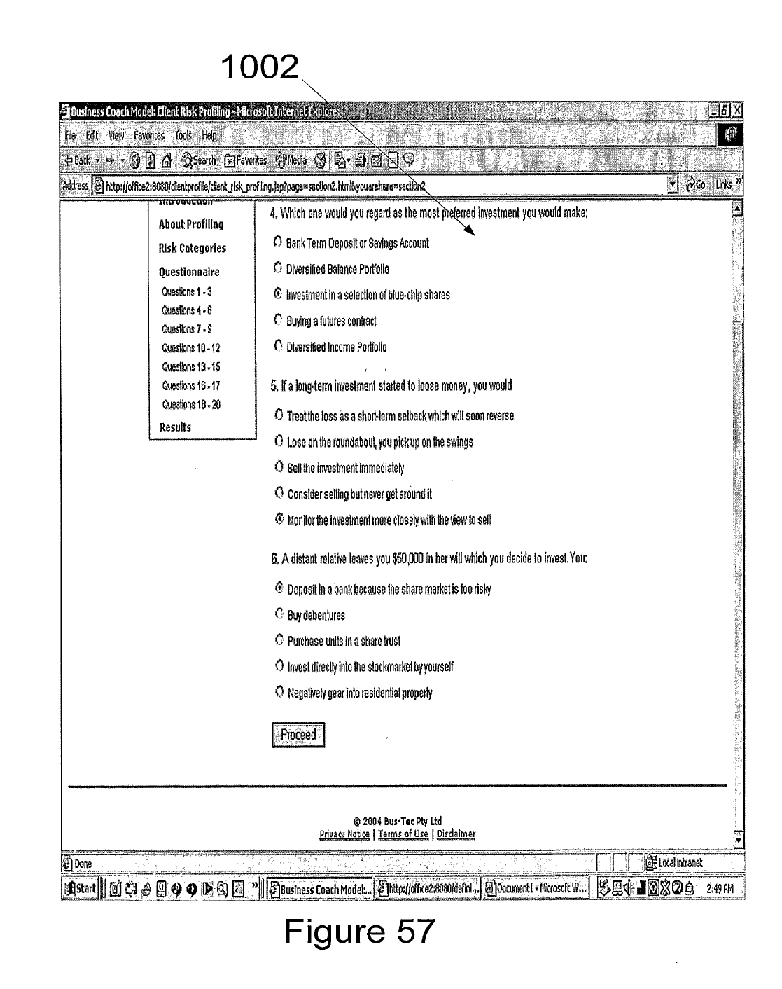

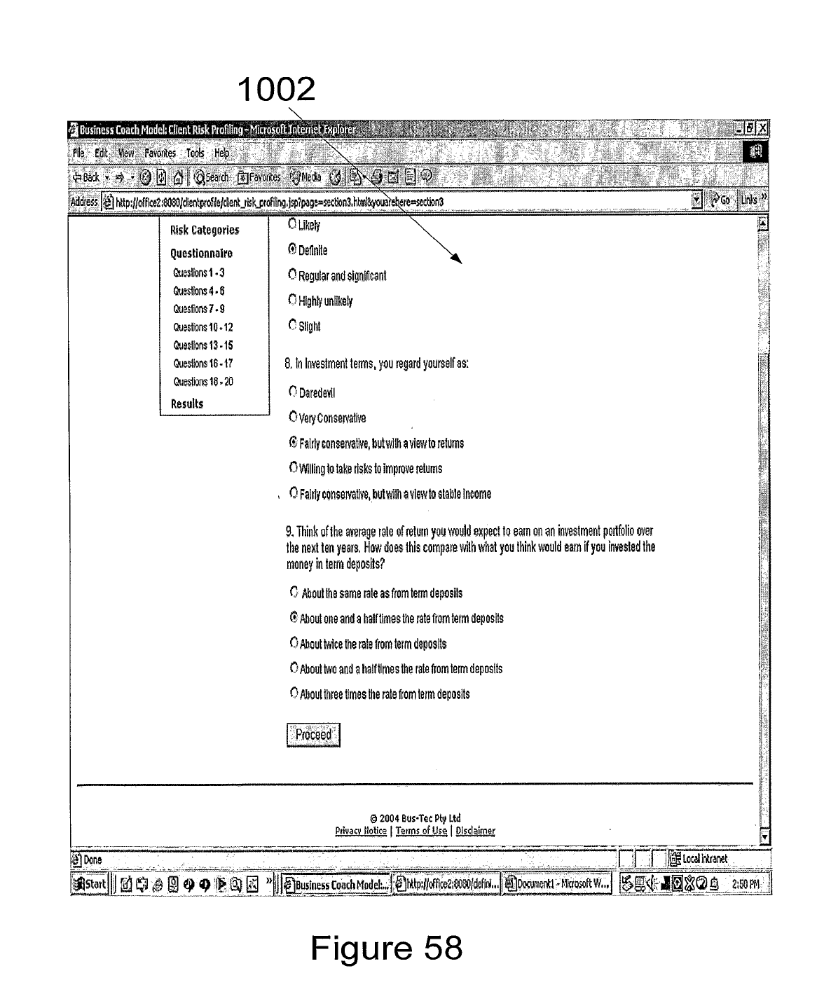

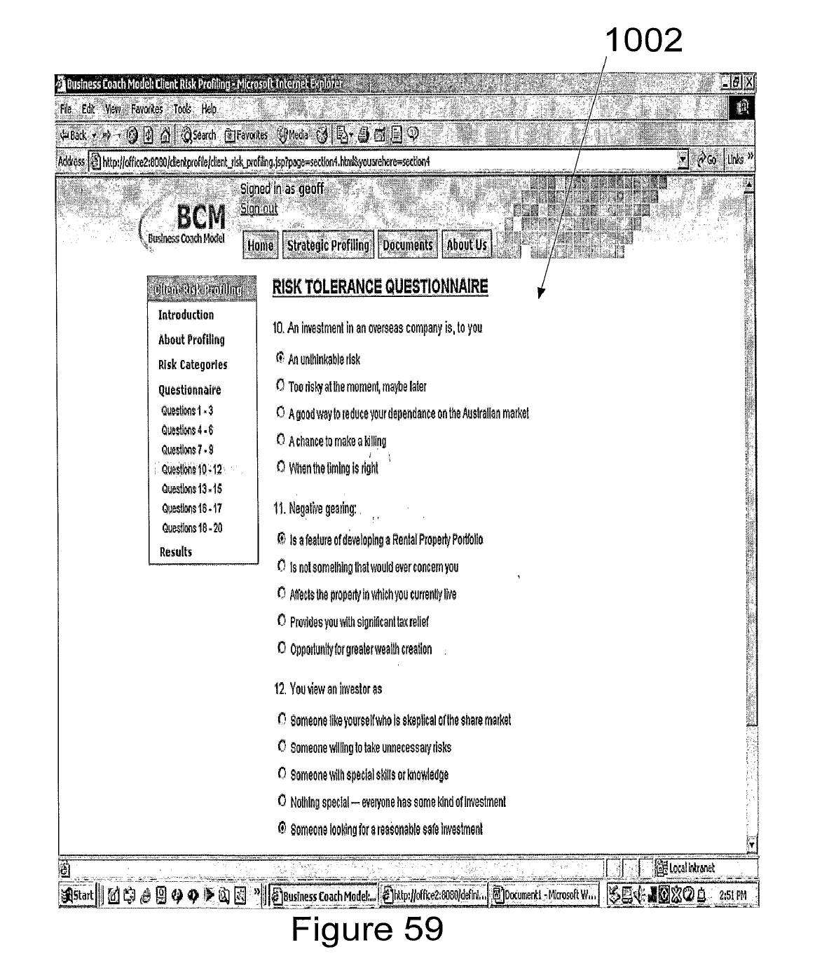

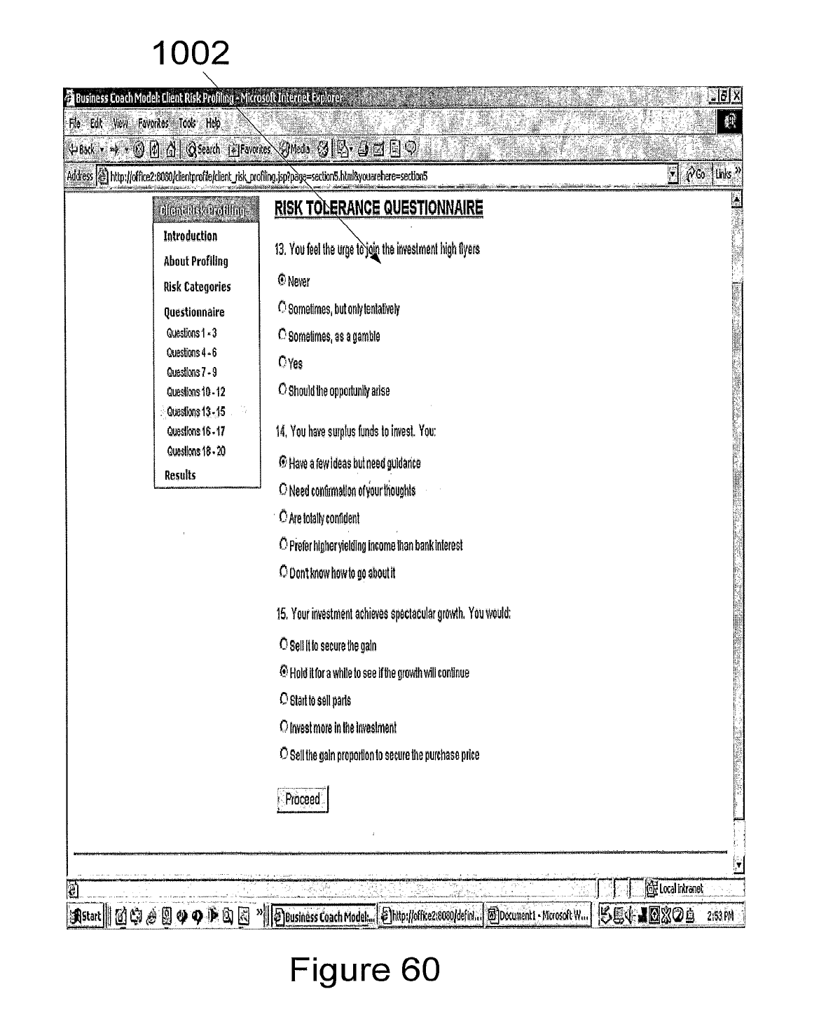

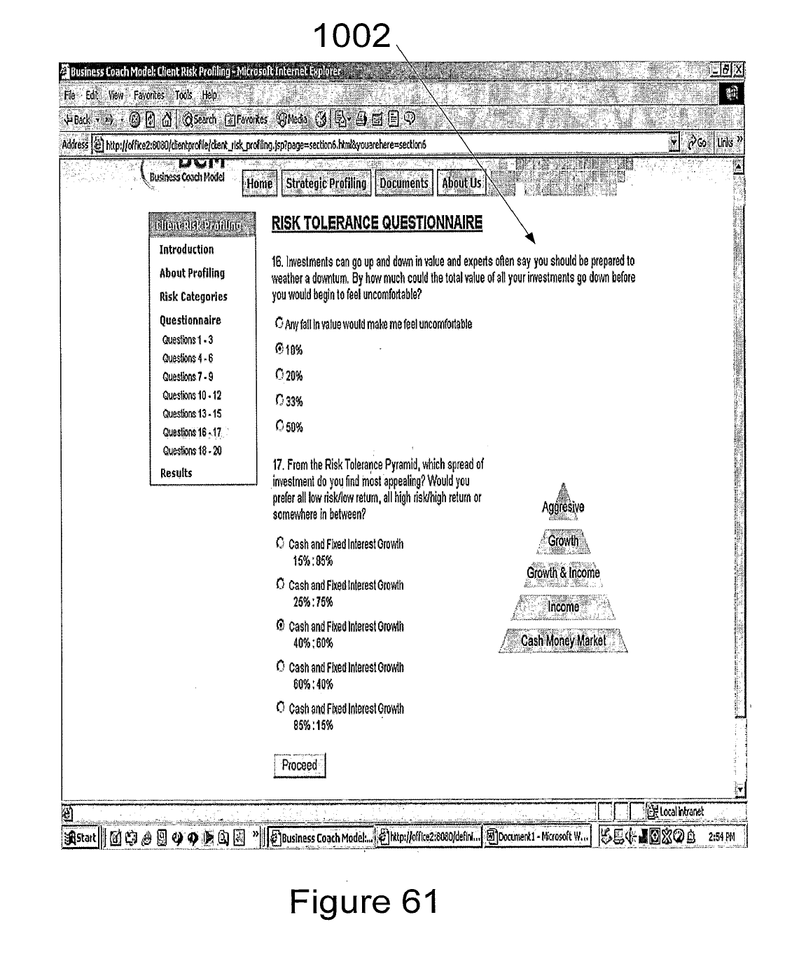

The computer system 1000 shown in FIG. 53 generates the questionnaire 1002 shown in FIGS. 53 to 62 for an investor. The questionnaire 1002 includes, amongst other things, a discussion on risk tolerance and information about the double challenge of:
1. making an accurate and meaningful assessment of their willingness to accept risk as they perceive it; and
2. Expressing this assessment in such a way that what they already have in place, and the alternatives now offered to them, can be evaluated in terms of their risk tolerance.

The questionnaire 1002 also includes information about risk profiling in general and a description of the five risk categories. Risk Profiles and Investor Profiles are used by Financial Planners in the process of selecting Asset Allocation where the Financial Planners triple challenge is:
1. To determine an asset allocation that will achieve the client's financial goals;
2. To determine whether the asset allocation is consistent with the client's risk tolerance; and
3. If there is no asset allocation, which meets these first two challenges, to have the process of resolving the mismatch.

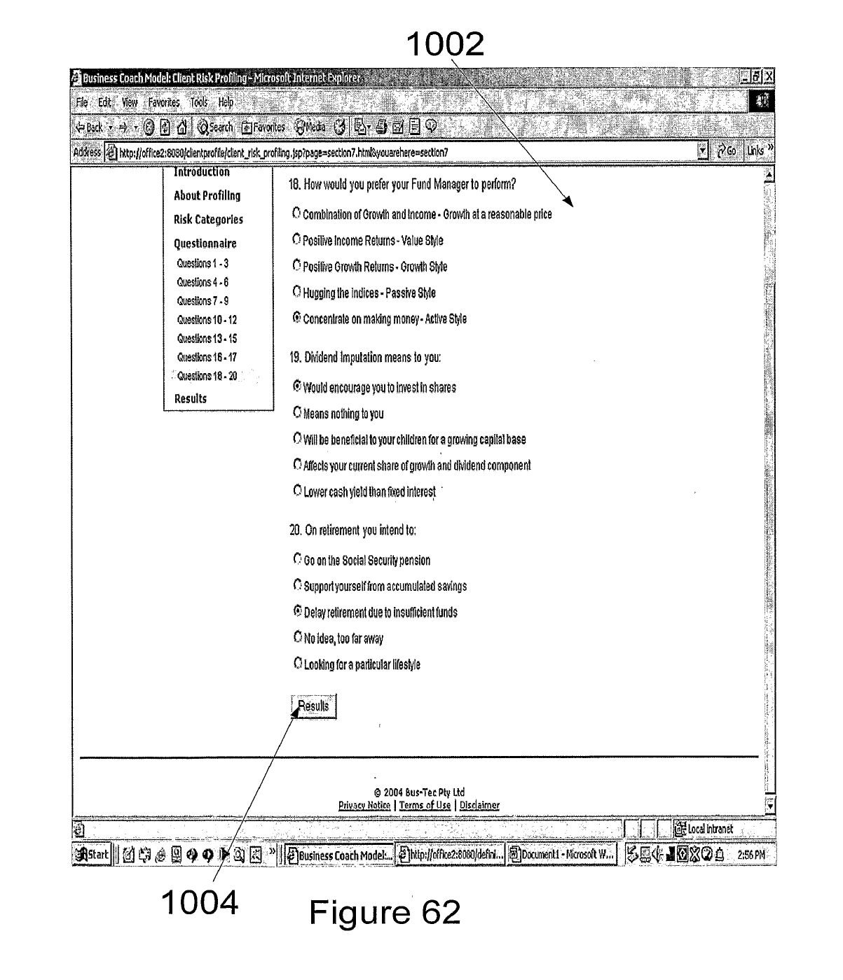

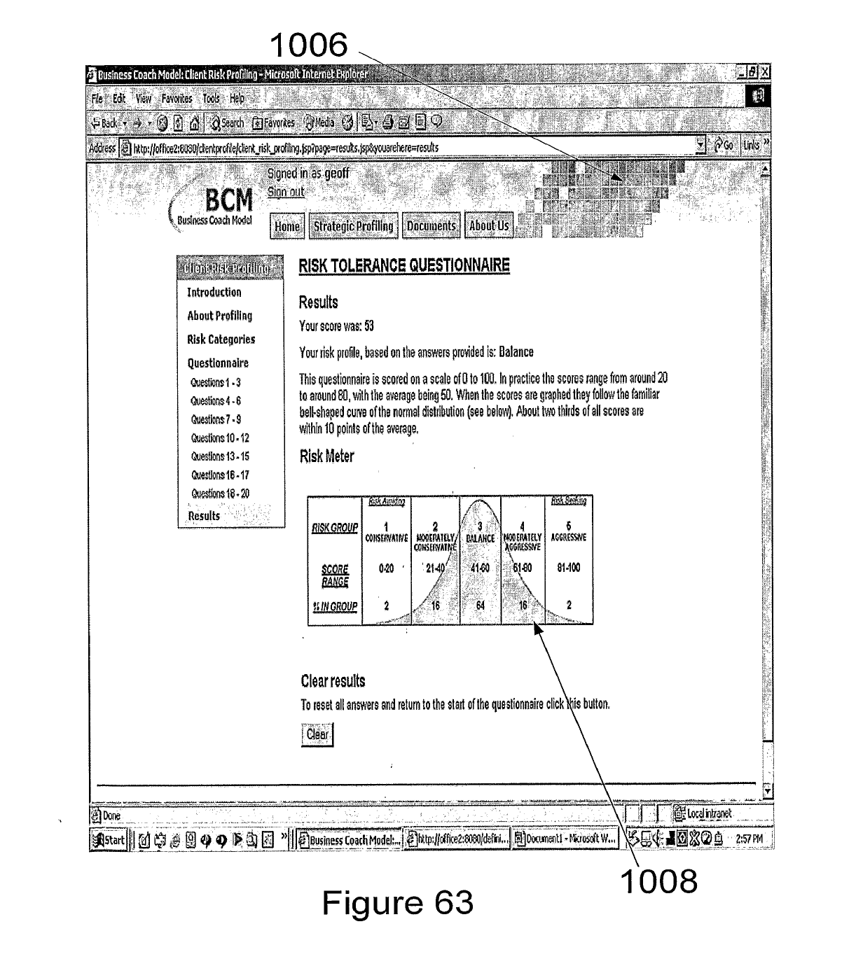

On completion of the last question, the investor can execute the “Results” function button 1004, as shown in FIG. 62, to generate the Results display 1006 shown in FIG. 63. The computer system 1000 generates the client's score from his or her answers to the questions put forward in the questionnaire and displays the score on the Results page 106. The Results page 1006 includes a description of the risk profile associated with the displayed score; and a risk meter 1008 showing a Bell curve of the distribution of risk tolerances of investors' over the different risk groups.

2. Micro Portfolio Selection

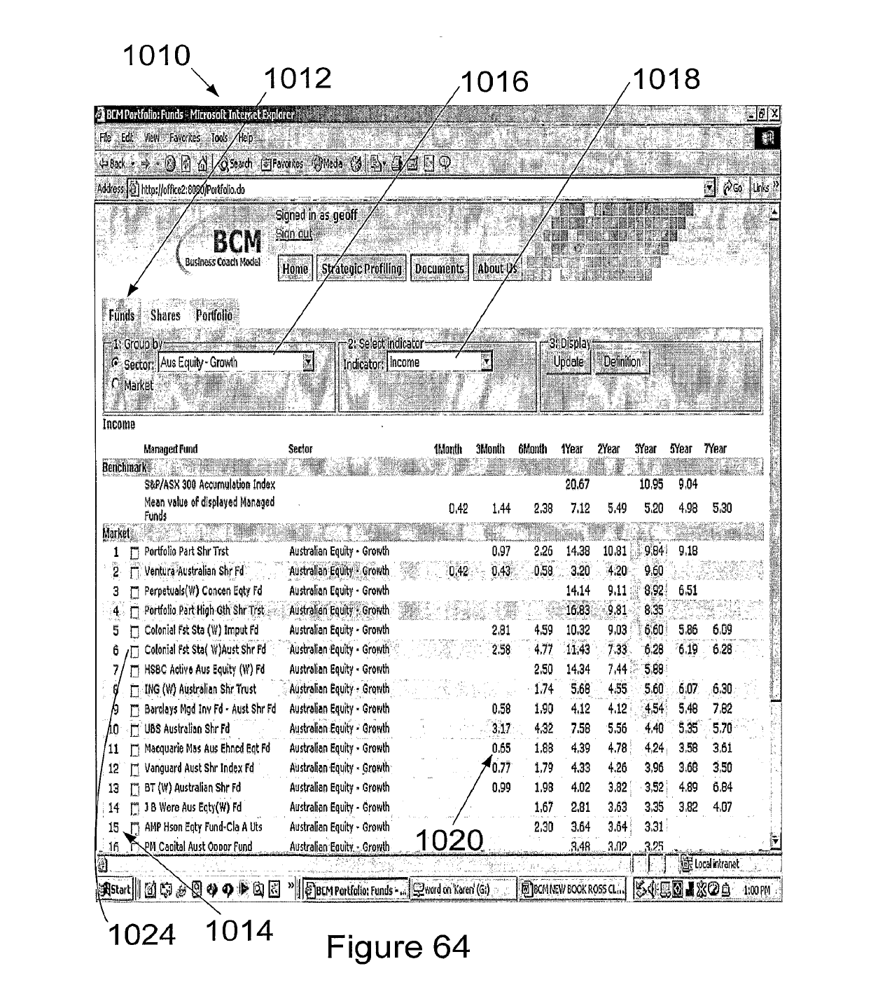

On completion of Client Risk Profiling, the computer system 1000 generates the Portfolio display 1010 shown in FIG. 64. The Portfolio display 1010 is used to select between the following displays, each being accessible by use of a mouse to click on a corresponding tab 1012:
a. Funds;
b. Shares; and
c. Portfolio Construction Interface.

In the portfolio display 1010 shown in FIG. 64, the “Funds” tab 1012 has been selected and the display 1010 includes a list 1014 of Funds Managers grouped by Aus Equity. The portfolio display 1010 includes a “Group By” pull down menu 1016 that controls the grouping of the displayed fund managers. A user can change the grouping by selecting a different group from the pull down window 1016.

The portfolio display 1010 also includes a “Select Indicator” pull down menu 1018 ranks the fund managers 1014 displayed in accordance with the indicator selected. The portfolio display 1010 shown in FIG. 64, for example, ranks the fund managers 1014 in accordance with the “Income”.

The portfolio display 1010 also displays data 1020 associated with the selected indicator for each one of the fund managers over a predetermined number of years. The range of statistics is designed to take the Financial Planners a step beyond the general trend of the asset class and allow them to gain a more detailed understanding of the inherent risk and return characteristics of each class over both short and longer-term time frames. The portfolio display 1010 shown in FIG. 64, for example, displays income data 1020 for each fund manager 1014 for 1 month, 3 months, 6 months, 1 year, 2 years, 3 years, 5 years and 7 years.

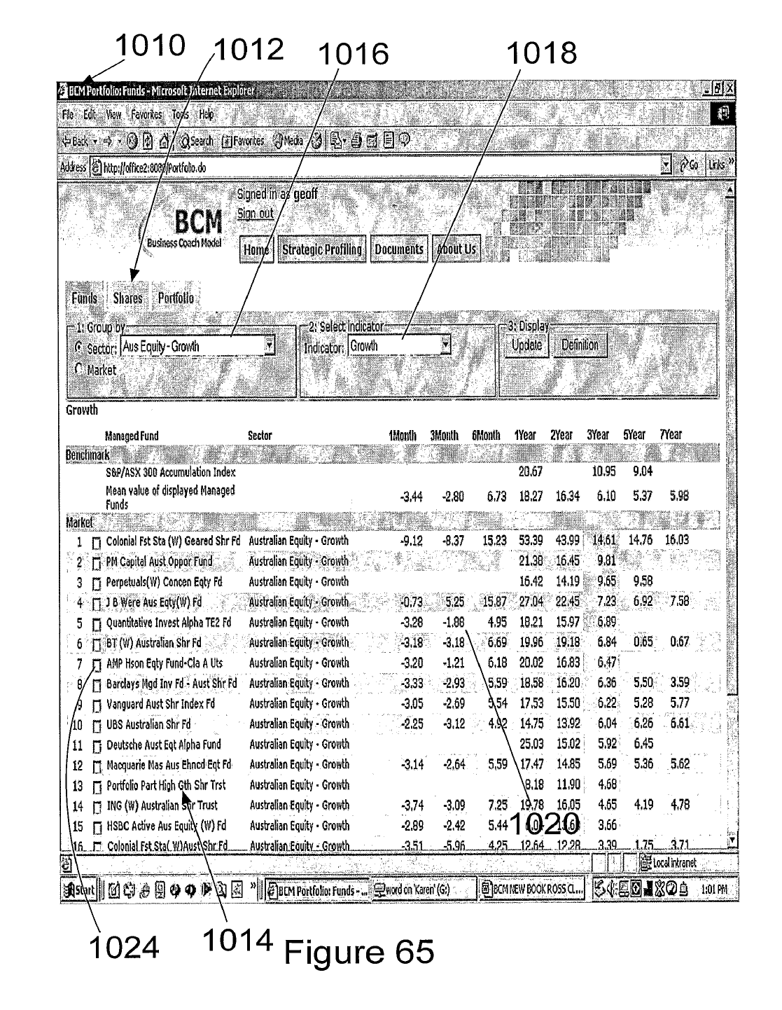

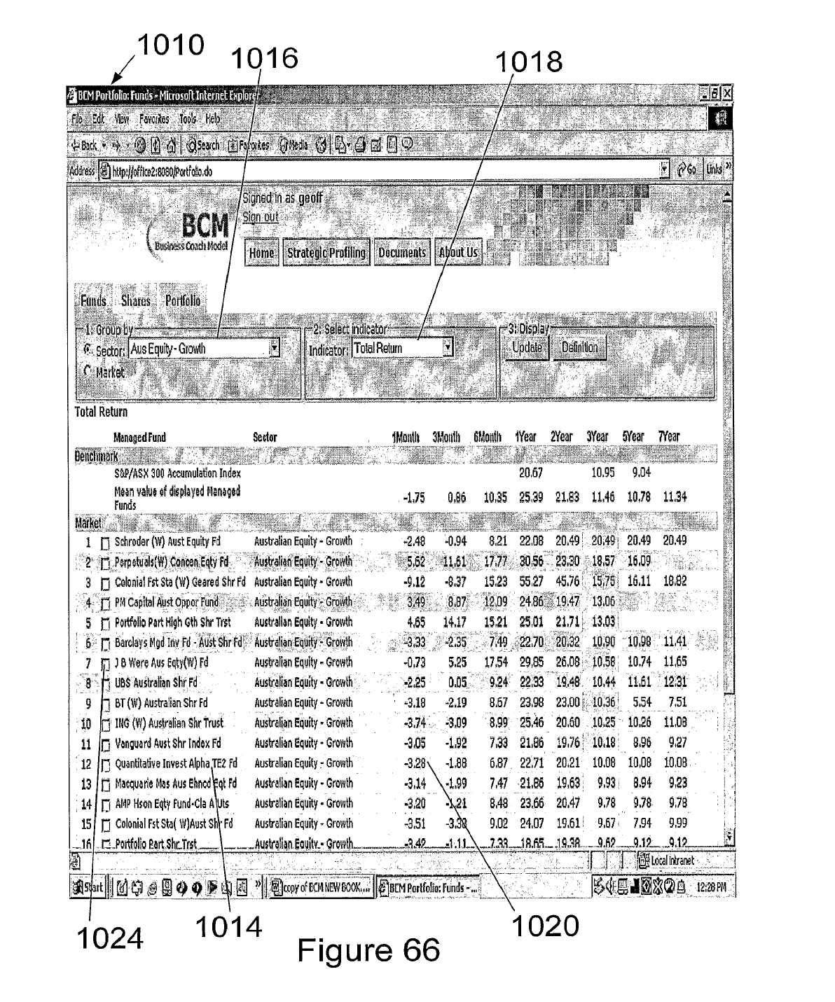

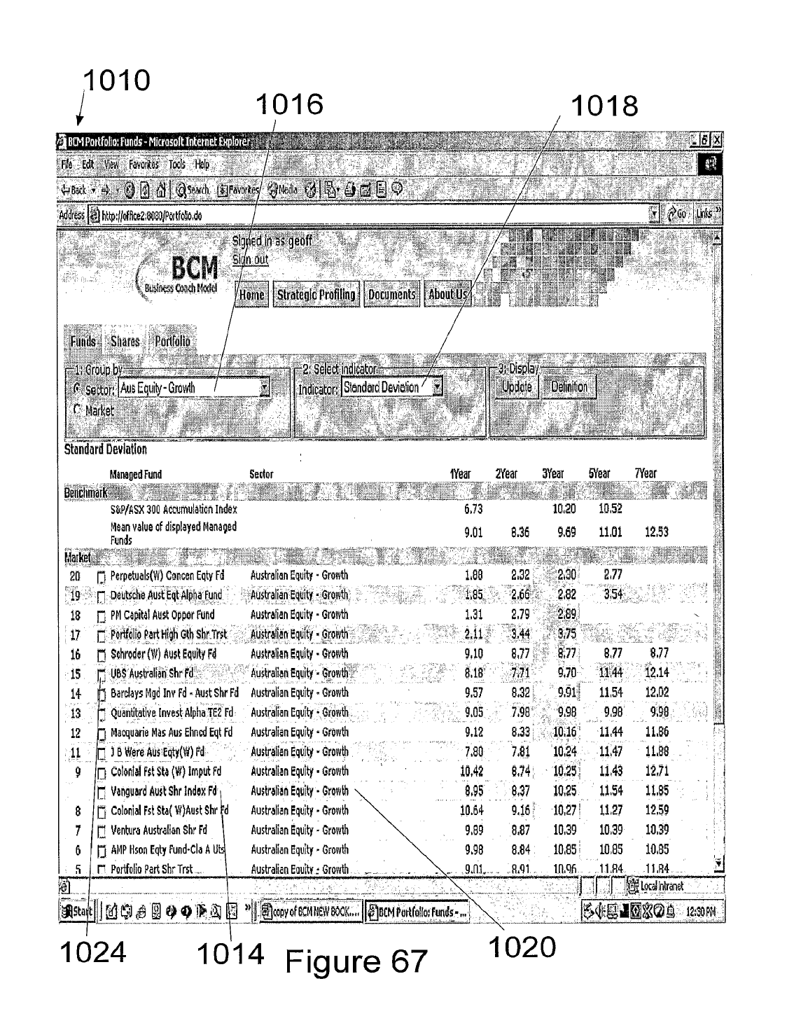

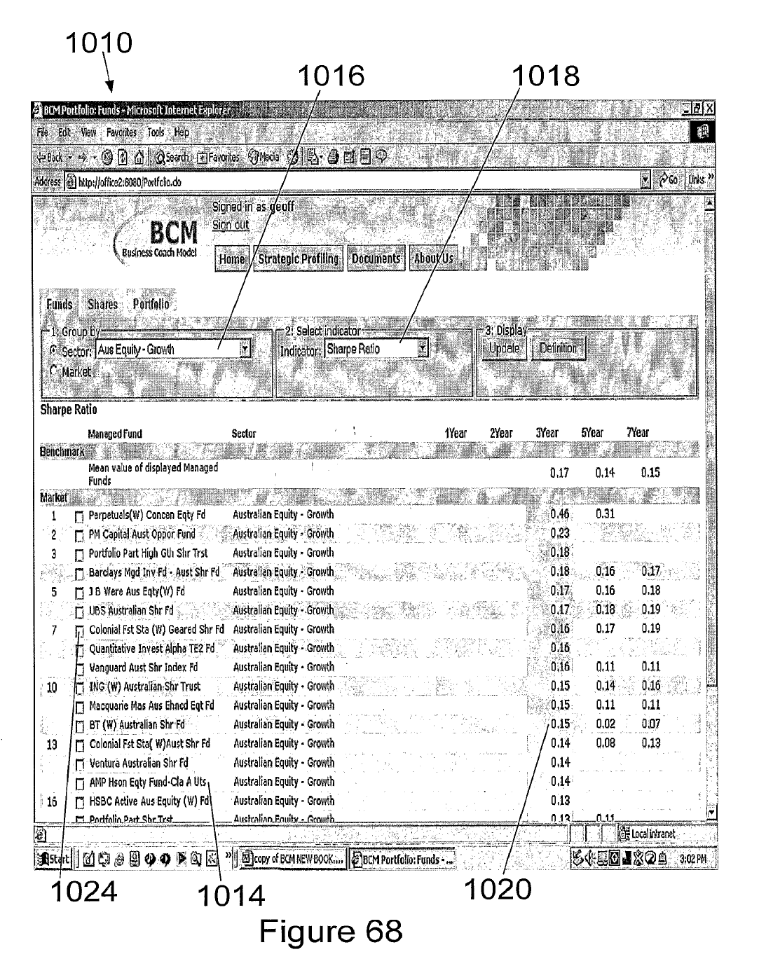

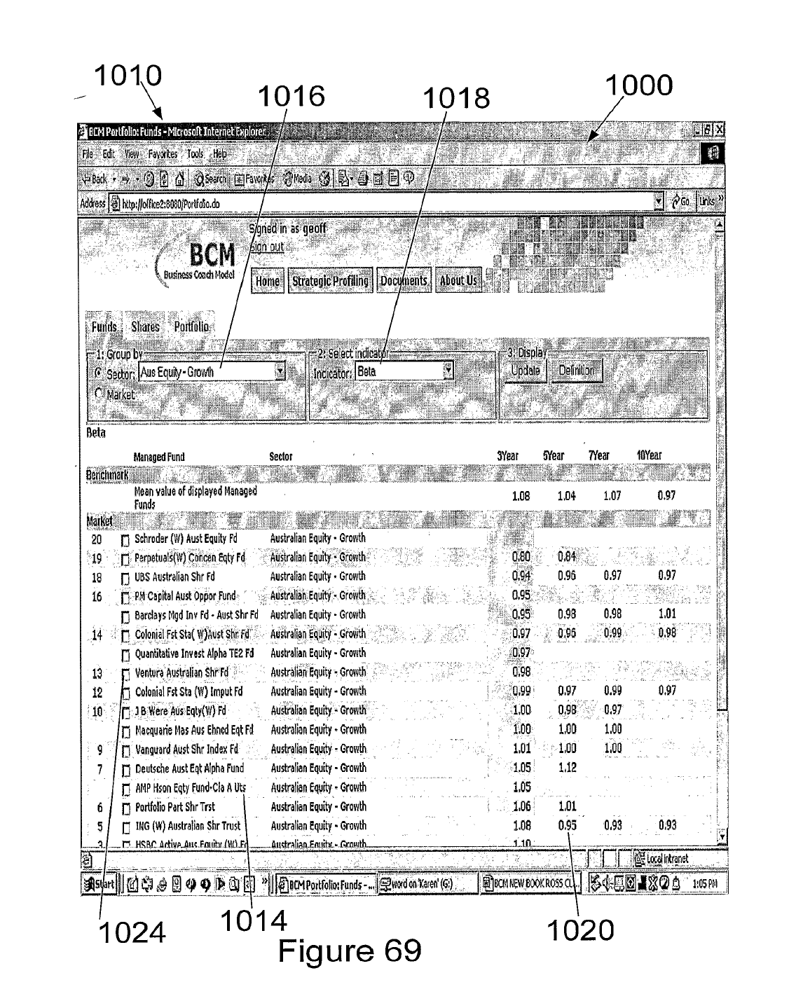

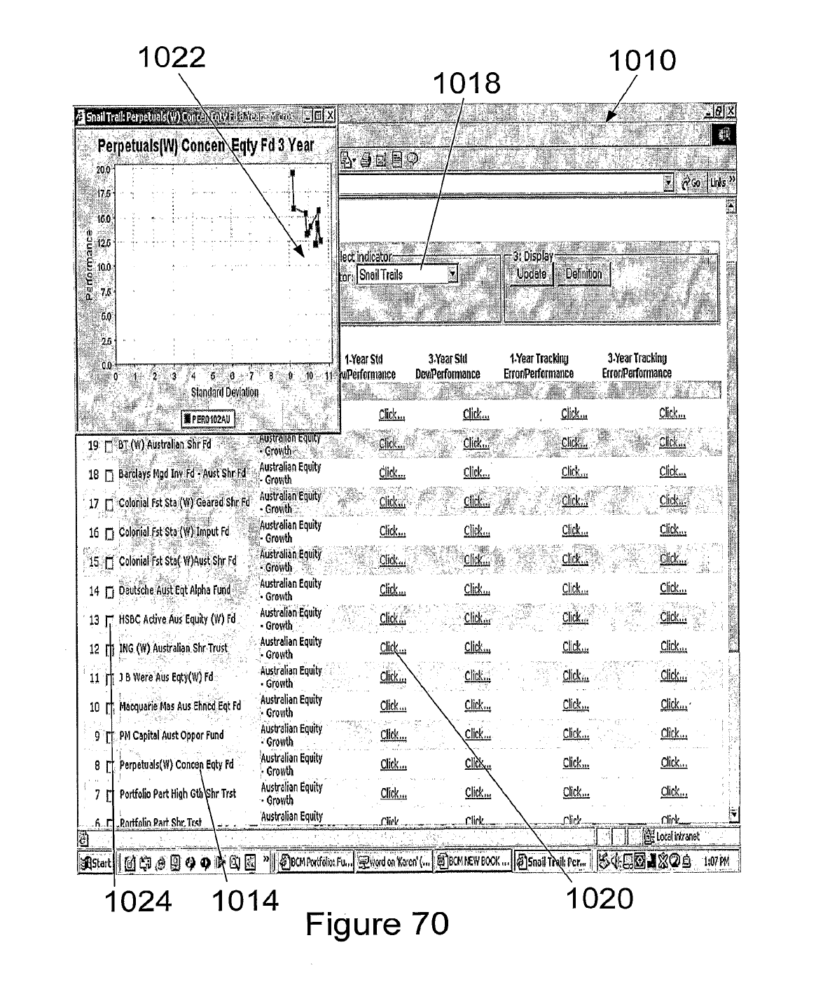

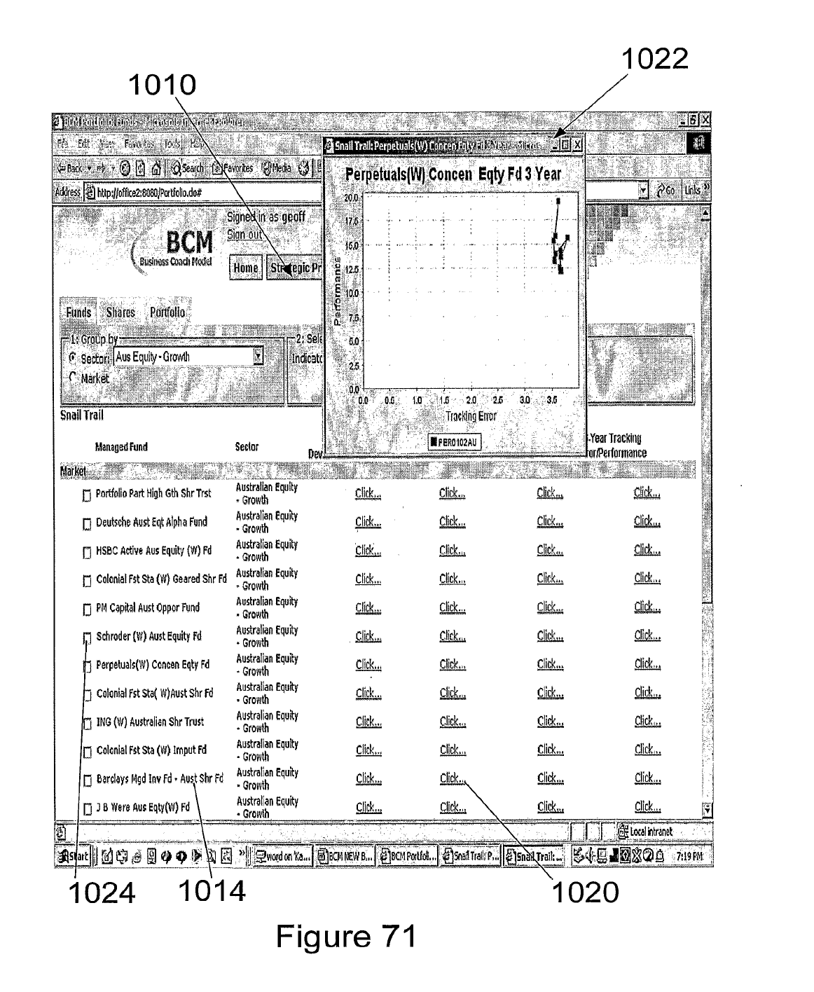

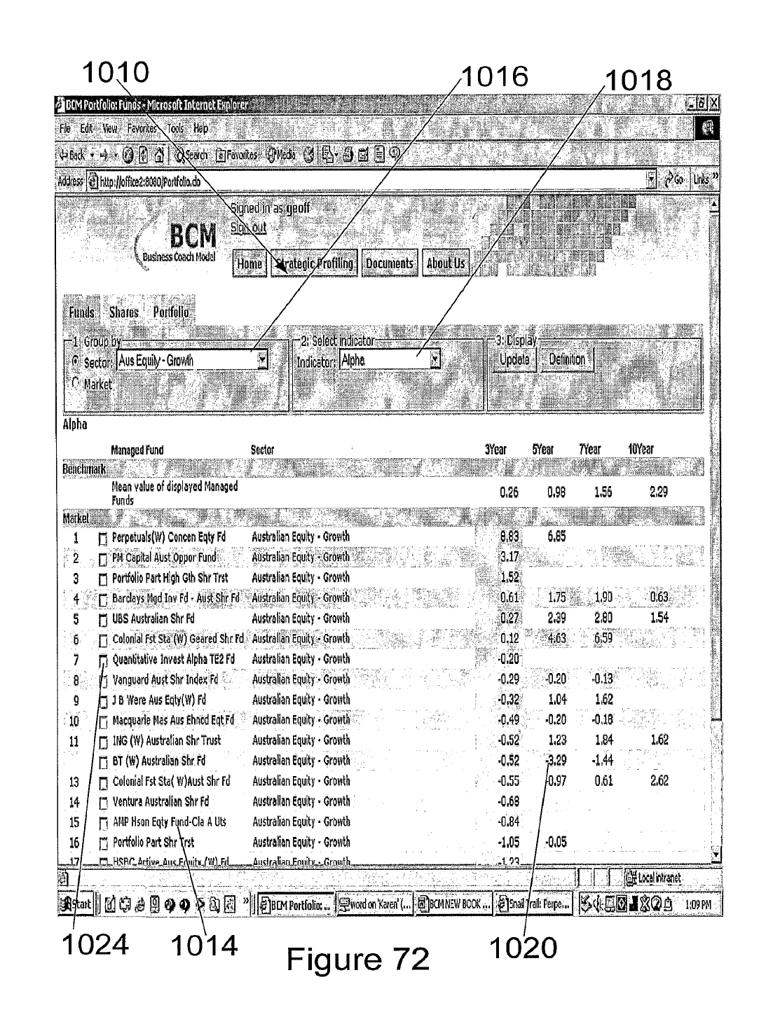

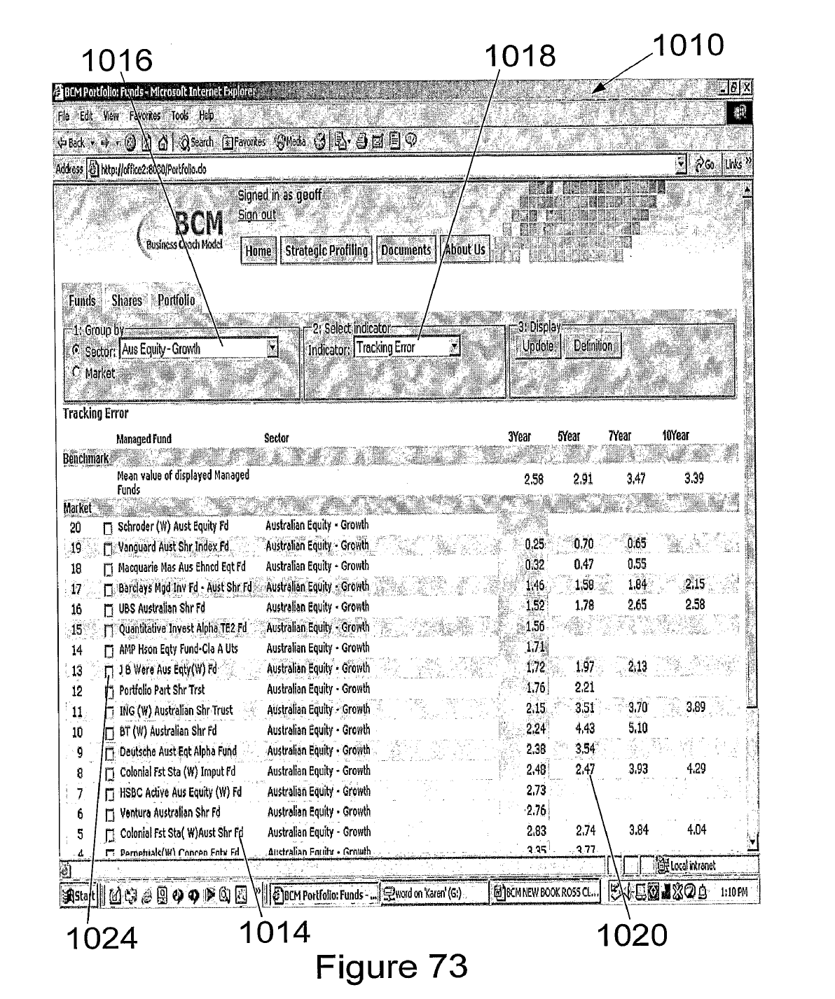

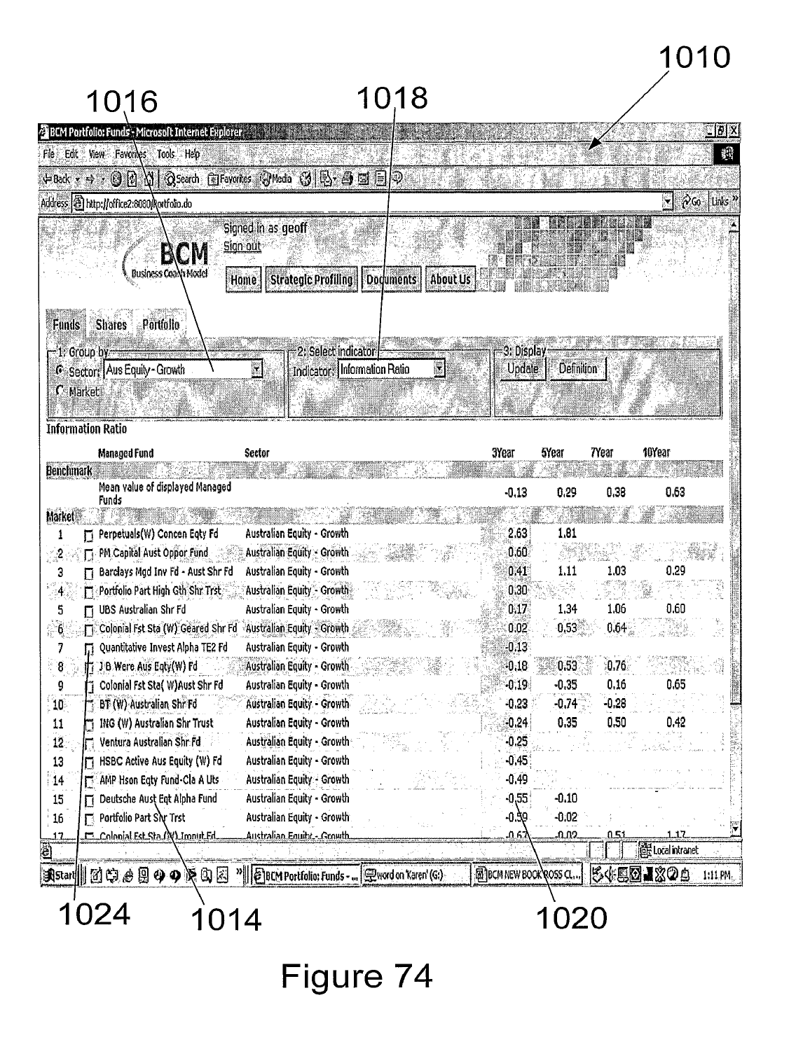

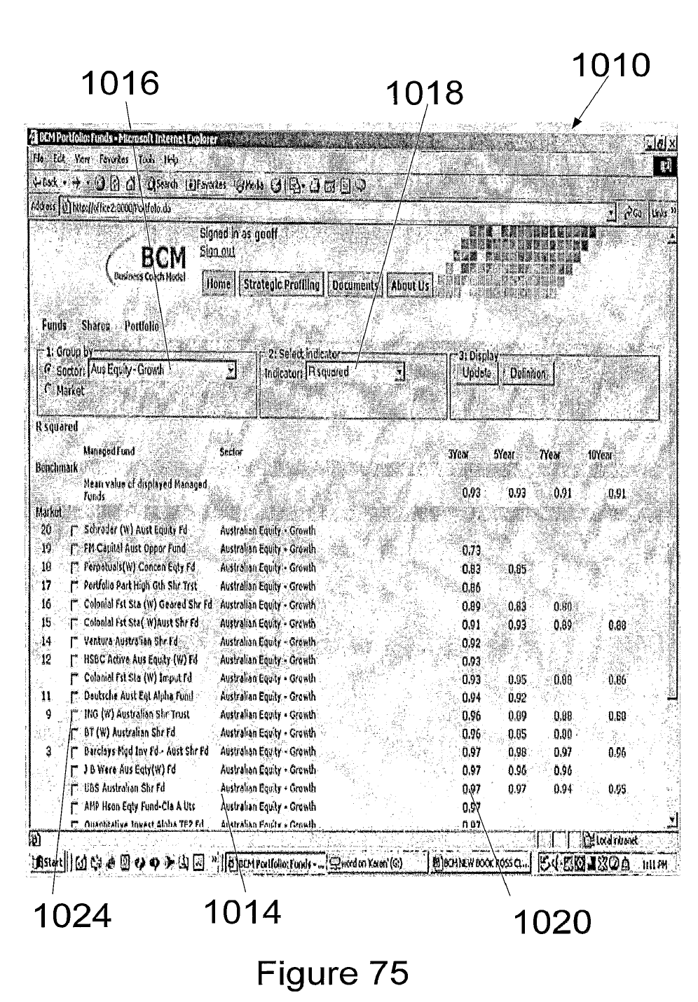

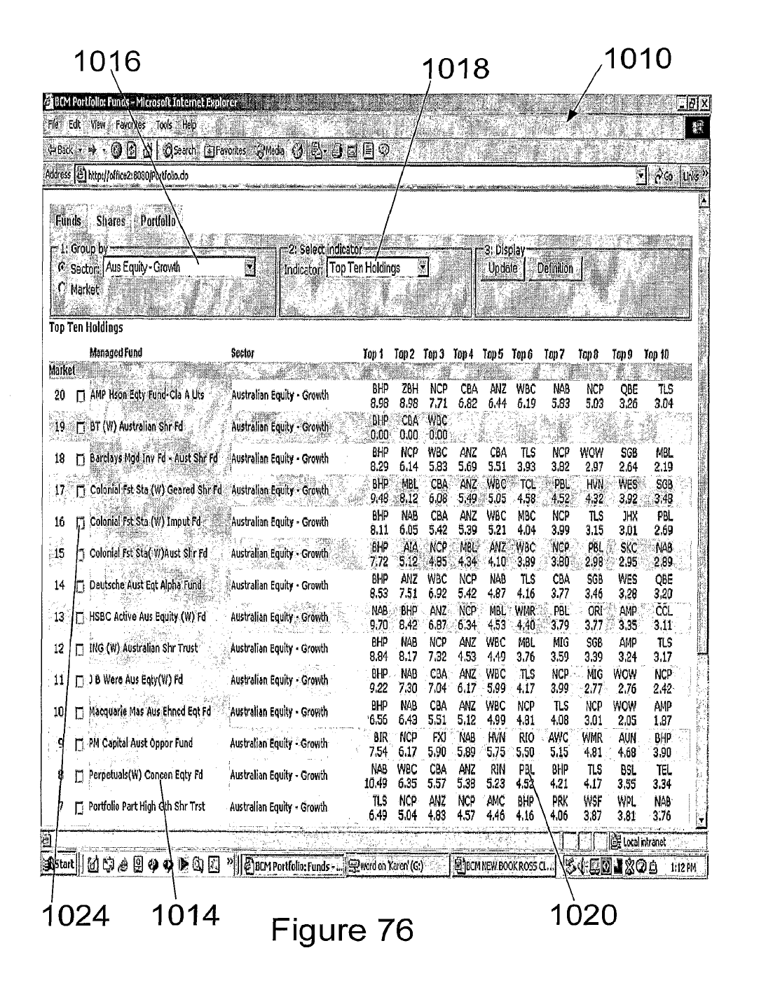

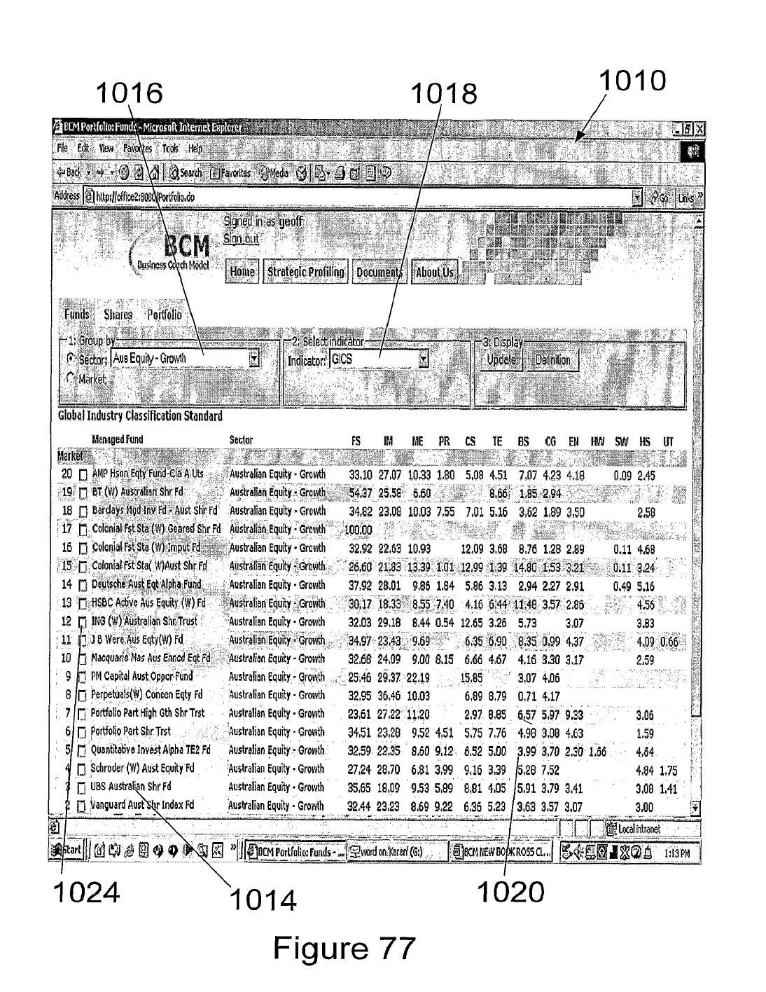

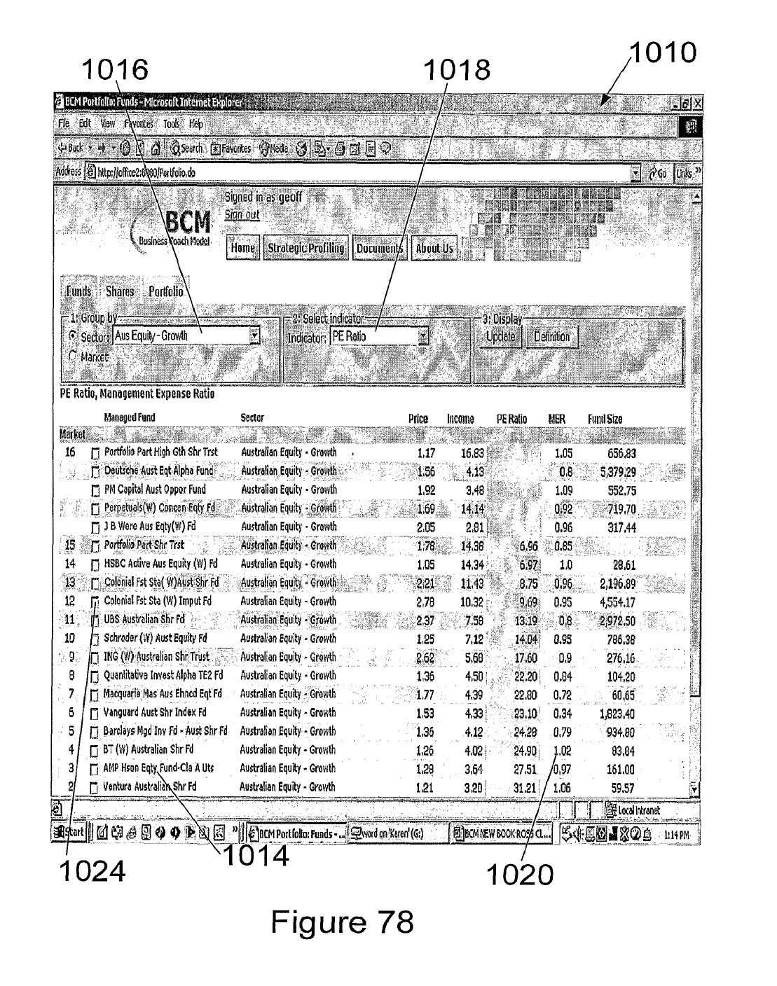

The portfolio display 1010 displays data 1020 for the following indicators for the fund managers 1014:
1. Growth data 1020 for each fund manager 1014 for 1 month, 3 months, 6 months, 1 year, 2 years, 3 years, 5 years and 7 years, as shown in FIG. 65.
2. Total Return data 1020 for each fund manager 1014 for 1 month, 3 months, 6 months, 1 year, 2 years, 3 years, 5 years and 7 years, as shown in FIG. 66.
3. Standard Deviation data 1020 for each fund manager 1014 for 1 year, 2 years, 3 years, 5 years and 7 years, as shown in FIG. 67.
4. Sharpe Ratio data 1020 for each fund manager 1014 for 1 year, 2 years, 3 years, 5 years and 7 years, as shown in FIG. 68.
5. Beta data 1020 for each fund manager 1014 for 3 years, 5 years, 7 years and 10 years, as shown in FIG. 69.
6. Snail Trail data 1020 for each fund manager 1014 for:
   a. 1 year standard deviation V performance; and 3 year standard deviation V performance, as shown in FIG. 70.
   b. 1 year tracking error V performance; and 3 year tracking error V performance, as shown in FIG. 71.
7. Alpha data 1020 for each fund manager 1014 for 3 years, 5 years, 7 years and 10 years, as shown in FIG. 72.
8. Tracking Error data 1020 for each fund manager 1014 for 3 years, 5 years, 7 years and 10 years, as shown in FIG. 73.
9. Information Ratio data 1020 for each fund manager 1014 for 3 years, 5 years, 7 years and 10 years, as shown in FIG. 74.
10. R Squared data 1020 for each fund manager 1014 for 3 years, 5 years, 7 years and 10 years, as shown in FIG. 75.
11. Top Ten Holdings data 1020 for each fund manager 1014, as shown in FIG. 76.
12. Global Industry Classification Standard data 1020 for each fund manager 1014, as shown in FIG. 77.
13. PE Ratio data 1020 for each fund manager 1014, as shown in FIG. 78.

The snail trail data 1020 is presented to the user in the form of a snail chart 1022 generated by the computer system 1000, as shown in FIG. 70 and FIG. 71. A graphical depiction of a fund's risk and return performance over time, relative to industry averages. Risk, measure in terms of the standard deviation of returns, is measured on the horizontal axis, and returns on the vertical axis. The point where the two lines intersect in the middle of the graph represents the average risk and return for all funds surveyed within the sample over the same period. Against this matrix, the historical performance of a particular fund over consecutive time periods is plotted and then joined by a line to create the snail trail. The preferable sector for a fund to be in is the top left-hand quadrant, which represents consistent above average returns and below average risk relative to the sample of managers or funds surveyed.

The user can select a fund manager by checking the selection box 1024 corresponding to the desired fund manager. Unless we are adopting a “passive index” approach, all investments and tracking methods involve trying to find outstanding Fund Managers/Shares. In the investment world, there are two basic approaches to finding the best shares. In the professional analysts-speak, these are known by the jargon terms “bottom-up” and “top-down”.

The “Bottom-Up” Approach

Is known simply as “stock picking”. Analysts who employ this method, look at the entire universe of shares and try to find the best ones by applying various tests. There is a wide range of possible tests that may be used, based on accounting data, market price data and subjective judgements like quality of management.

The “Top-Down” Approach

The strongest shares is the search for or managed funds on the logical grouping they belong to. Assuming that analysts tend to look anywhere in the world, they will compare all the available national markets and select the best ones. Then they take only the best markets compared to all industry sectors within them and select the best ones. Finally, they take only the best sector, compare all shares or managed funds within them and select the best ones. Again, there is a wide range of possible criteria that may be used to access which are the best.

Relative Strength Index

Technical analysts use both top-down and bottom-up approaches except they focus only on market data, primary price for the criteria used to make the judgements. One of the most powerful of the possible technical analysis tool is also one of the simplest—“relative strength”. Relative strength is simply one thing compared to another to see which is increasing the price faster. To do this, the comparisons must have a common base so if we divide the prices over the time of the listed shares or fund managers by a common base such as the market price index, we will be able to identify which shares a fund managers price are rising the fastest.

Analysts have found that the strongest shares, fund managers or sectors tend to remain the strongest in their field for some time. If we can find the strongest portfolio synergy and stay with them while they are performing better than the market overall, we should have a superior outcome. This has an advantage over the fundamental analysts who might identify what is thought to be the great share based on its prospects and management but the market hasn't recognised yet. The technical analyst is therefore looking to add the timing dimension.

Relative strength analysis can be done a few different ways. It can be done by hand using the Share tables section and a calculator. The computer literate reader could use a spreadsheet. Technical analysts would use their charting software but these methods will vary slightly depending upon the features built into each charting software. We could simply chart the relative strength of every industry sector and usually inspect the charts to find which has risen fastest in recent times.

However, we can hone in on them faster if we shift them mathematically. I want to find the sectors that have gone up the most in the last three months. To do this, we take the price now and divide it by the price three months ago. This will indicate which sectors are rising in price and by what percentage. We then select the ones with the strongest percentage. If a three months relative strength sector produces too many sectors on the rise, then narrow the field down, either 44 or 22 trading days, sample, instead of 66 days or three months, sample, so as to make a valid comparison.

Therefore, having found a relative strong sector or stock over a specific period, the next step will be to do our research and to see whether it will fit into the portfolio.

The computer system 1000 supports stand-alone modules for all risk, all performance, all asset class and all investment sector with the most comprehensive range of deep quantitative research tools and relative strength economic indicators, systematically used for determining top quartile performing fund managers in global and domestic markets which presently gives us daily update access to historical data and performances on over 200 Managed Funds diversified over 22 business sectors and ASX 500 Listed Securities diversified over 24 business sectors. Therefore, these sophisticated strategically developed analytical tools enables a financial planner, for example, to analysis the needs and resource of clients' financial goals and then combine these with the skills and expertise of the organisation to marry these factors into an integrated plan.

An investor can be confident in the knowledge that the investment products recommend to them are extensively researched, thus reducing the risk element associated with investing in Direct Shares. The Group's services are underpinned by both a comprehensive external research house and in-house research facilities which assess investment opportunities, track and monitor investment products and assess trends on a global basis, updated regularly through its sophisticated software system and research database. These functions are outsourced by, for example, Morningstar—Quantitative And Qualitative Research; Aspect Huntley-Quantitative And Qualitative Research, and Access Economics—Leading Indices.

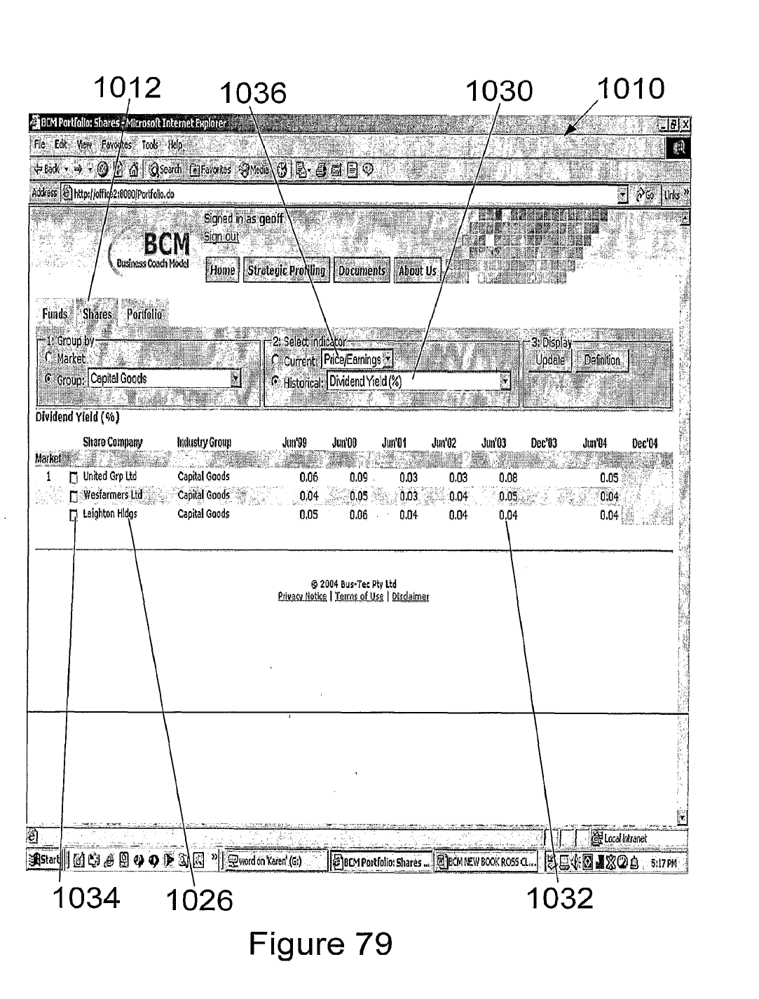

In the portfolio display 1010 shown in FIG. 79, the “Shares” tab 1012 has been selected and the display 1010 includes a list of Share Companies 1026 grouped by capital goods. The portfolio display 1010 includes a “Group By” pull down menu 1028 that controls the grouping of the displayed Share Companies. A user can change the grouping by selecting a different group from the pull down window 1028.

The portfolio display 1010 also includes a “Select Indicator—historical” pull down menu 1030 that ranks the Share Companies 1026 displayed in accordance with the indicator selected. The portfolio display 1010 shown in FIG. 79, for example, ranks the Share Companies 1026 in accordance with the “Dividend Yield”.

The portfolio display 1010 also displays data 1032 associated with the selected indicator for each one of the Share Companies 1026 over predetermined periods of time. The range of statistics is designed to take the Financial Planners a step beyond the general trend of the asset class and allow them to gain a more detailed understanding of the inherent risk and return characteristics of each class over both short and longer-term time frames. The portfolio display 1010 shown in FIG. 79, for example, displays dividend yield data 1032 for each Share company 1030 for June 1999; June 2000; June 2001; June 2002; June 2003; December 2003; June 2004; and December 2004.

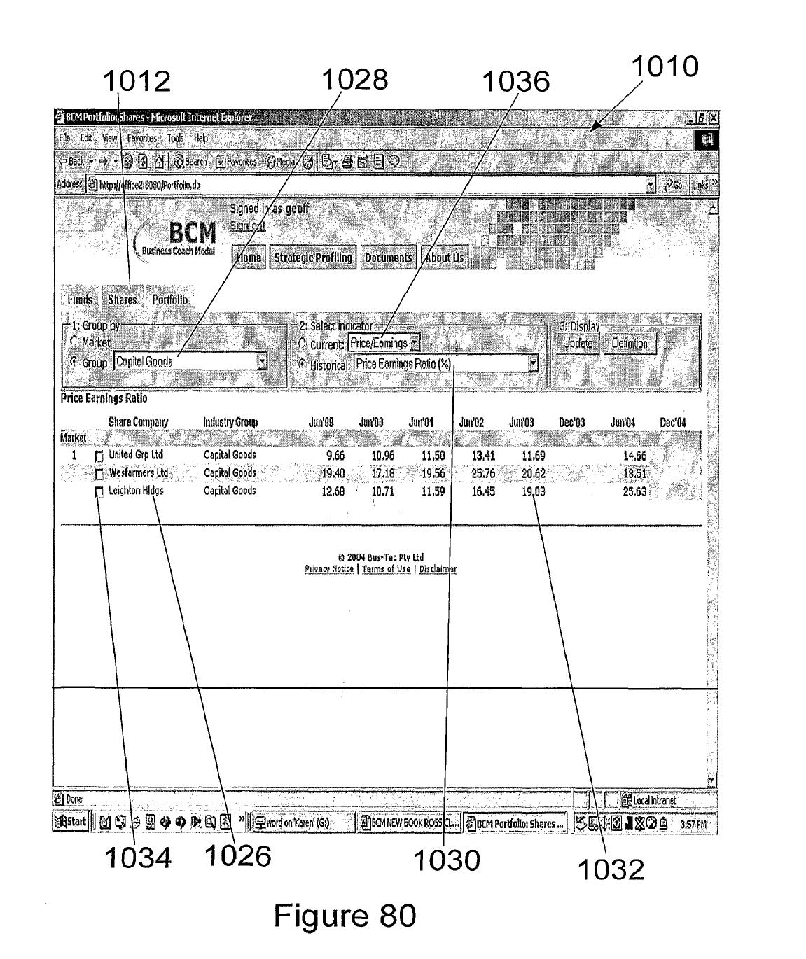

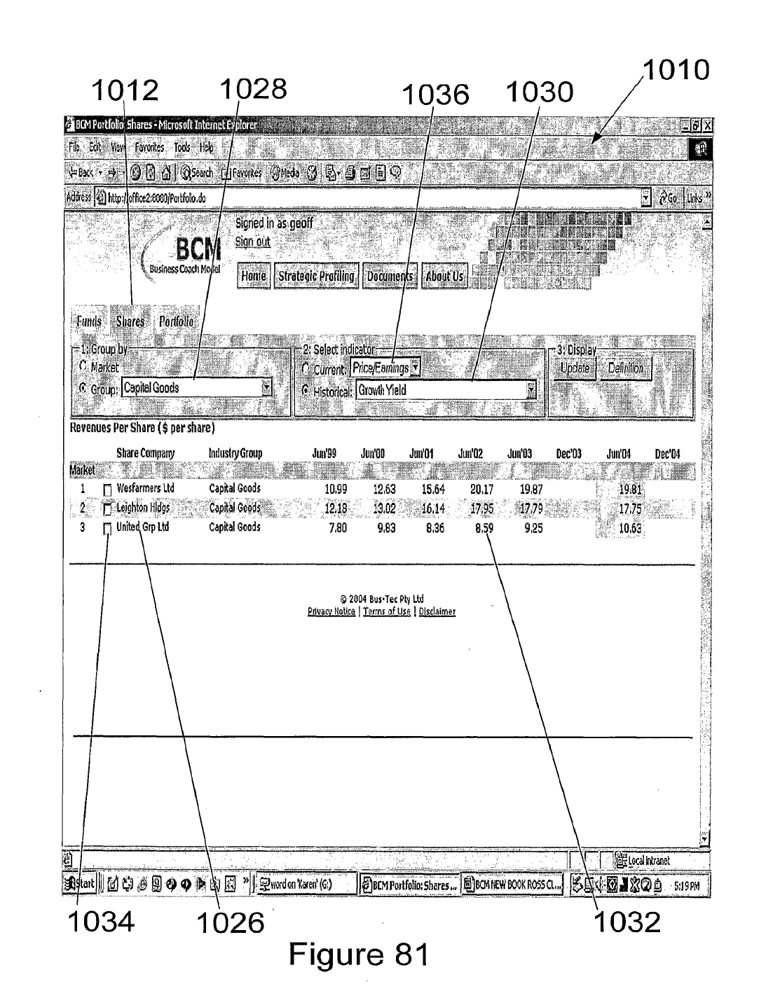

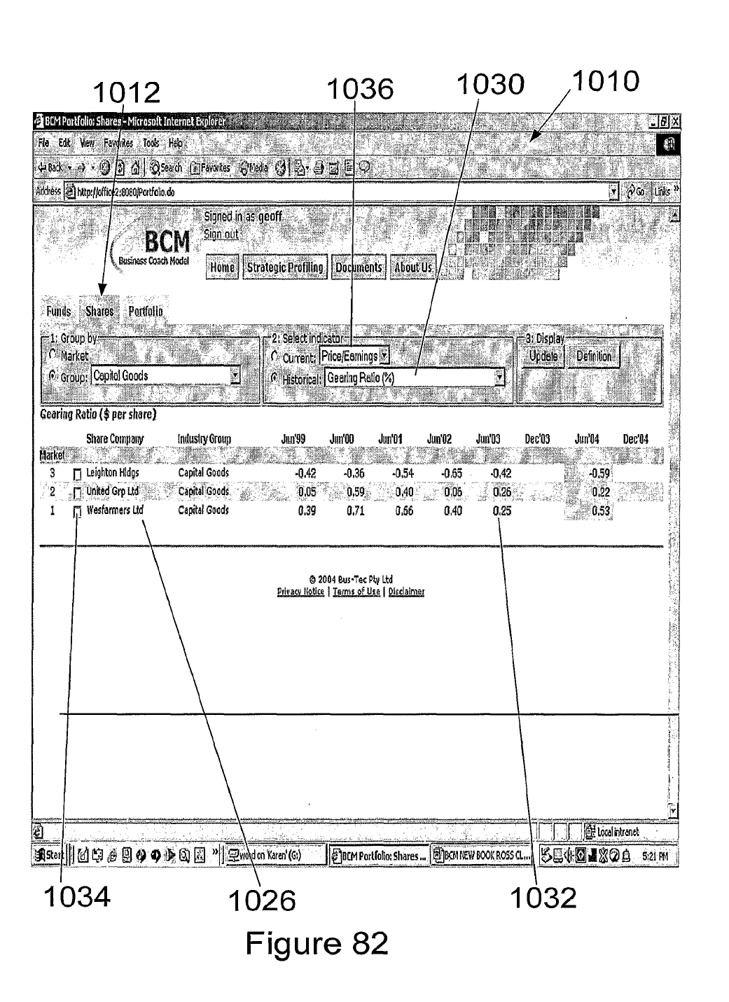

The portfolio display 1010 displays data 1032 for the following indicators for the Share Companies 1026:
1. Price Earnings Ratio data 1030 for each share company 1026 for June 1999; June 2000; June 2001; June 2002; June 2003; December 2003; June 2004; and December 2004, as shown in FIG. 80.
2. Growth Yield data 1030 for each share company 1026 for June 1999; June 2000; June 2001; June 2002; June 2003; December 2003; June 2004; and December 2004, as shown in FIG. 81.
3. Gearing Ratio data 1030 for each share company 1026 for June 1999; June 2000; June 2001; June 2002; June 2003; December 2003; June 2004; and December 2004, as shown in FIG. 82.

The user can select a Share Company by checking the selection box 1034 corresponding to the desired Share Company.

The portfolio display 1010 also includes a “Select Indicator—current” pull down menu 1036 that ranks the Share Companies 1026 displayed in accordance with the indicator selected. For example, the portfolio display 1010 can rank the Share Companies 1026 in accordance with the “Price/Earnings”.

3. Macro Portfolio Selection

Consensus forecast numbers are usually an average of all economists' forecasts which gives a top down created expectation in general on how the market views the global and domestic prospects. Financial Planners and investors need to keep their fingers on the pulse of the economy because it indicates how various types of investments will perform. By tracking economic data such as index of leading indicators, investors will be able to determine the likely path of future economic growth and therefore better understand the economic backdrop for the various markets.

The leading economic indicators are designed to predict turning points in the economy such as recession and recoveries. Despite a few misses, such as during the OPEC oil crisis in the 1970's and the Asian financial crisis of 1997, the leading index has been generally successful in predicting economic turning points, months in advance. The Stock market likes to see healthy economic growth because that translates into higher corporate profits. Rising profits in return leads to higher share prices. Typically, Property also enjoys healthy economic growth. Real estate buyers are more likely to purchase houses and investment properties during times of expansion when jobs are more secure and incomes are growing. The Bond market, on the other hand, prefers less rapid growth and is extremely sensitive to whether the economy is growing too quickly—and causing potential inflationary pressure. Continued acceleration in the leading index against a backdrop of overheating economy is not good for the Bond market.

The computer system 1000 uses on global and domestic macroeconomics as an insight into Fund Managers/Shares industry analysis. The aim of this analysis is to identify longer-term themes based on demographic trends plus technological, political and social developments. As well as this thematic analysis, quantitative value/momentum models are used to identify tactical sector opportunities. Both inputs are used in combination to identify sectors to over—or underweight in the portfolio.

To achieve real-value added profitability of a client's portfolio, some Financial Analysts prefer fundamental analysis of economic data while others have more profit success at technical analysis systems, focusing on trends. Profitable strategies require a selection of tools to determine entry and exit positions and anticipate market behaviour. It may also be obvious that different tools may be applicable for different markets for greater or lesser extent. These profitable strategies may involve a long-term, medium-term or a short-term.

Technical analysis uses both ‘top-down’ and ‘bottom-up’ approach except they focus on market data, primary price for criteria used to make judgements. One of the most powerful of the possible technical analysis tools is also one of the simplest “relative strength”.

Our source of Leading Indices is Access Economics Leading Indices, which are designed to anticipate and identify turning points in the World and Australian economy. The Leading Index is contained in Access Economics composite reports produced quarterly. As well as examining Australia's leading indicators, the report also studies movements coincident and lagging indicators of economic activity in the country, along with comparative data from overseas.

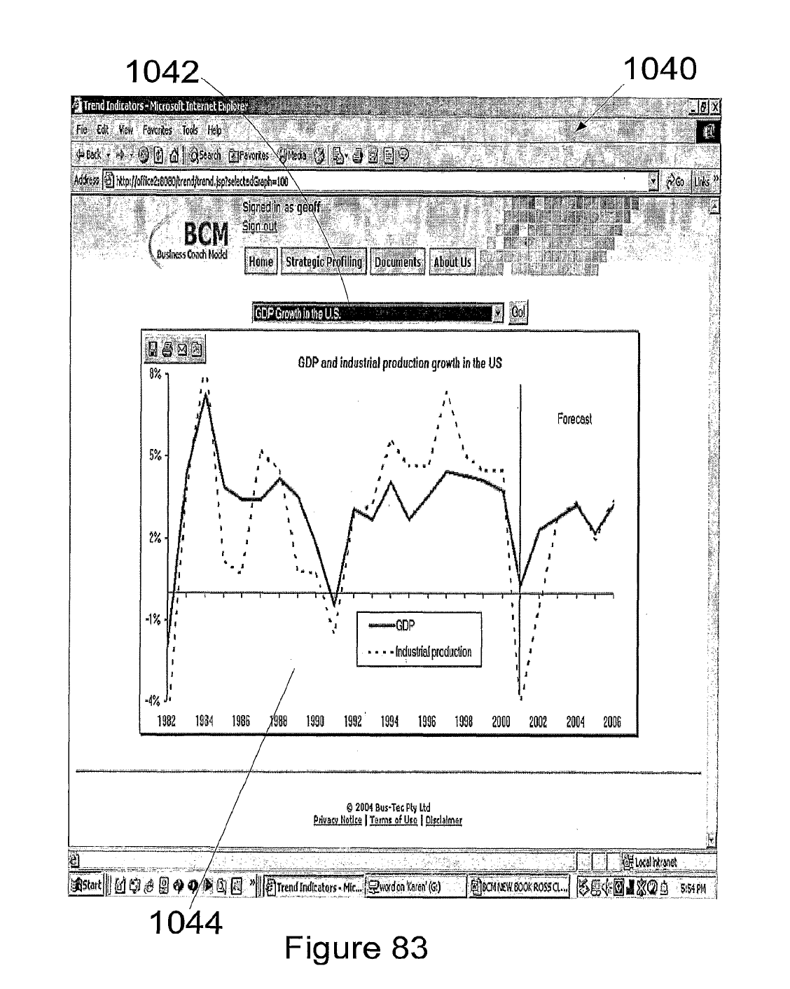

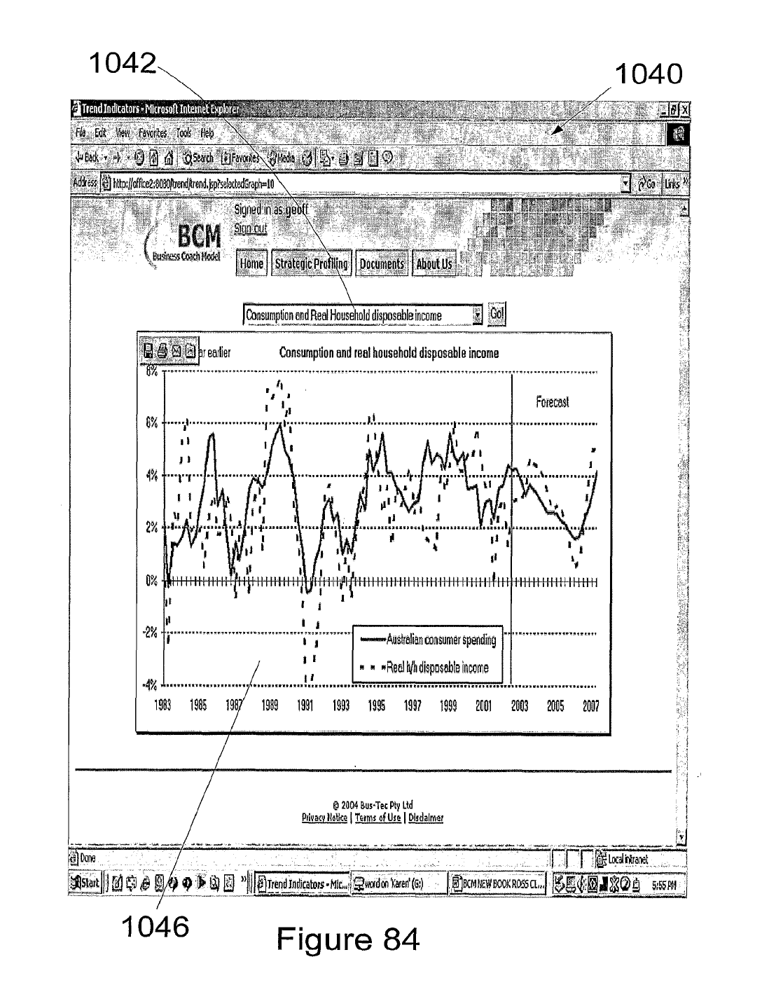

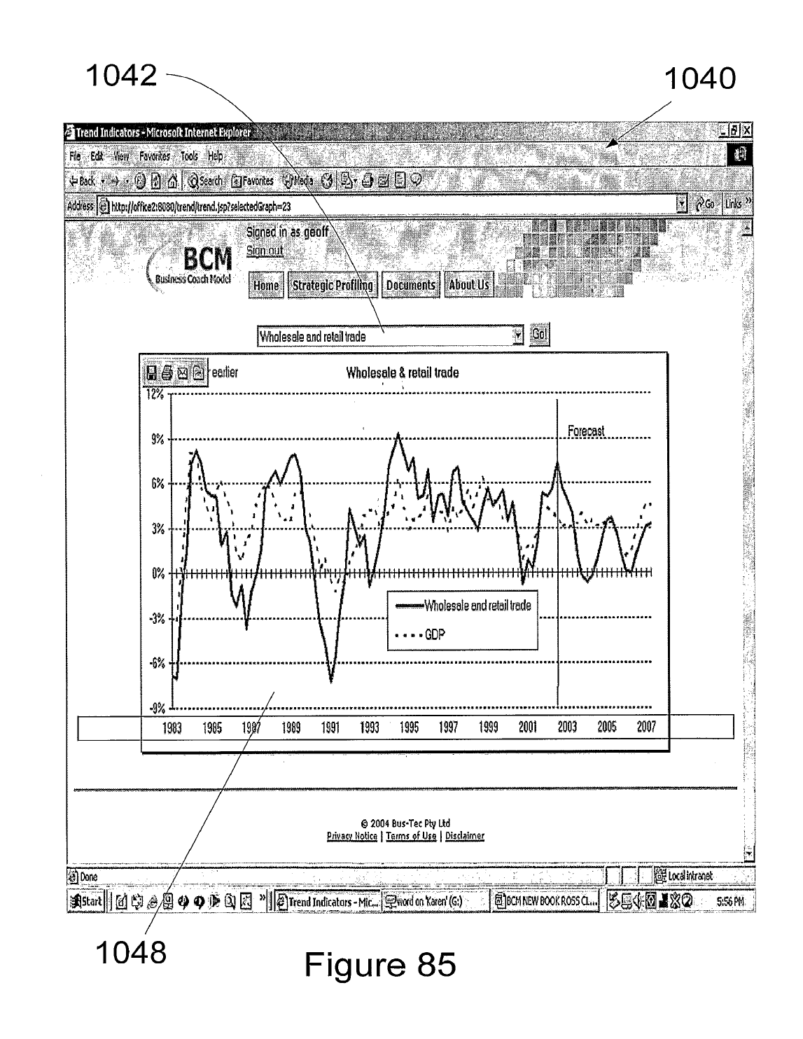

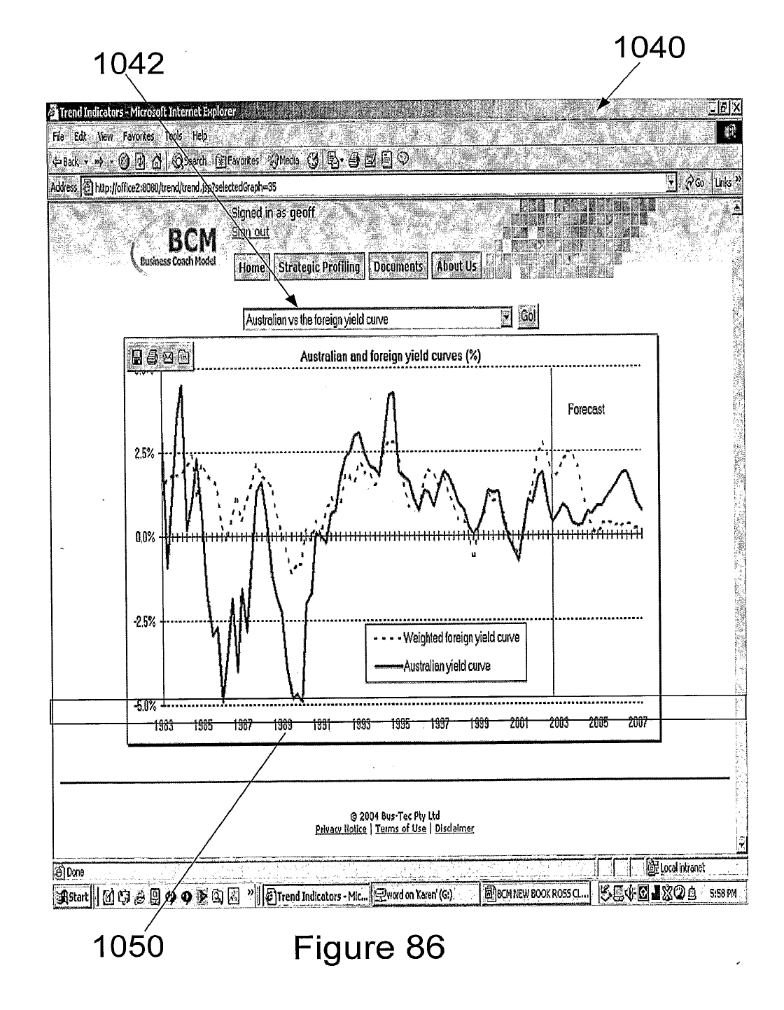

The system 1000 generates the macro display page 1040 shown in FIG. 83 that displays graphical representations of a number of macro indicators. The macro display page 1040 includes a drop down window 1042 that enables a user to select between the following graphs:
1. GDP Growth in the US 1044, as shown in FIG. 83;
2. Consumption and Real Household Disposable Income 1046, as shown in FIG. 84;
3. Wholesale and Retail Trade 1048, as shown in FIG. 85; and
4. Australia Versus Foreign Yield Curve 1050, as shown in FIG. 86.

The US Market is a significant trendsetter most watched stock market statistic in the world is the Dow Jones index. Any good trend picker would be alarmed with a high global exposure to the US market with a GDP for the next two years of two and a half percent.

This trending downwards of household disposable income would be an alarming sign to consumer durables business sector of the Australian Stock Market.

The ten broad sectors under the GICS, consumer durables and consumer discretionary (the things that you buy but you can live without) would be a sector to stay away from in the short term if you are trying to pick winners.

The stock market likes to see healthy economic growth because it is translated into higher corporate profits and judging by the disparity in favour of domestic rates over the short term foreign interest rates as it is attracting a lot of hot money and providing it is used for long term infrastructure investments it will be a benefit.

4. Portfolio Construction

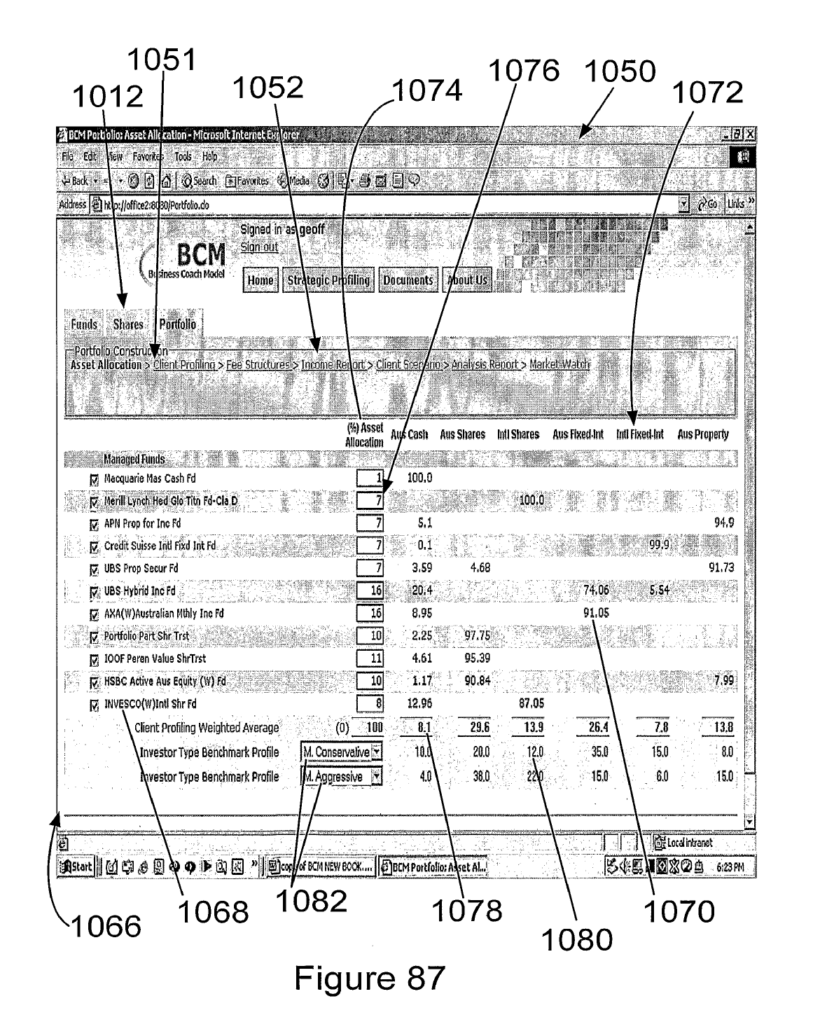

The computer system 1000 generates the portfolio construction interface 1050 shown in FIG. 87 of the portfolio display 1010 when the “Profile” tab 1012 is selected. The portfolio construction interface 1050 generates the following displays when corresponding links 1501 are executed:
a. Asset Allocation 1052;
b. Client Profiling 1054;
c. Fee Structure 1056;
d. Income Report 1058;
e. Client Scenario 1060;
f. Analysis Report 1062; and
g. Market Wrap 1064.

Asset Allocation

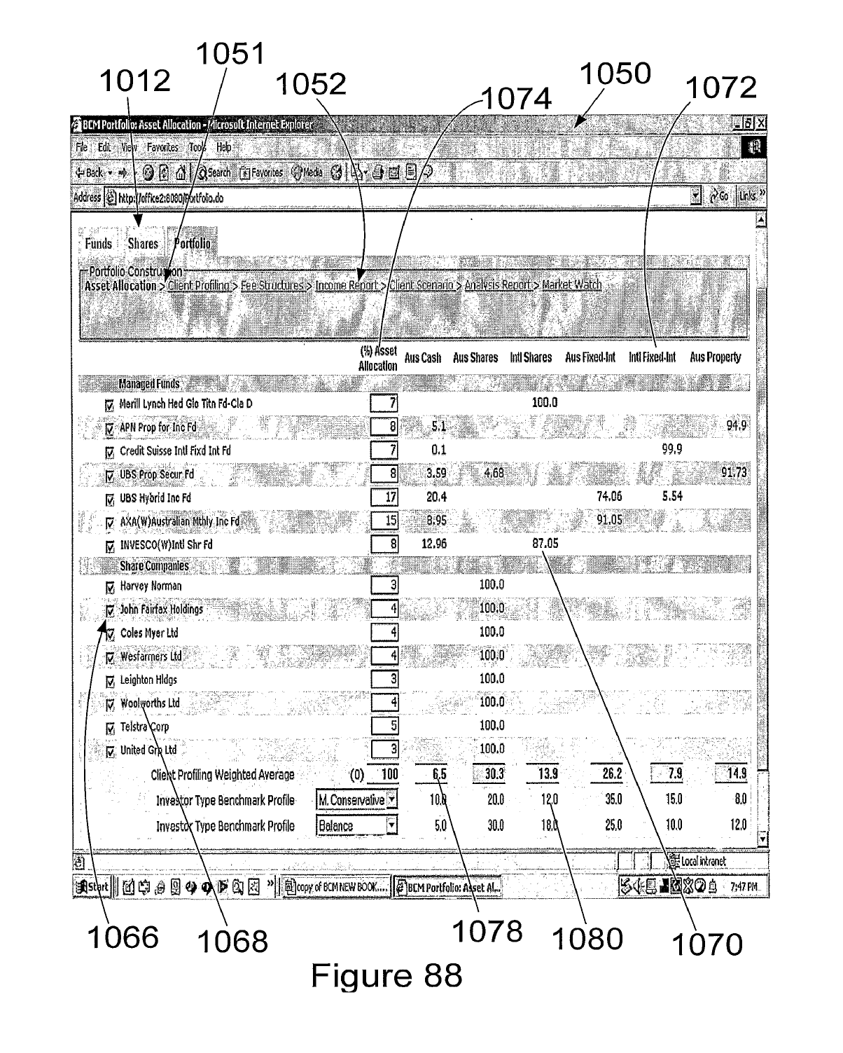

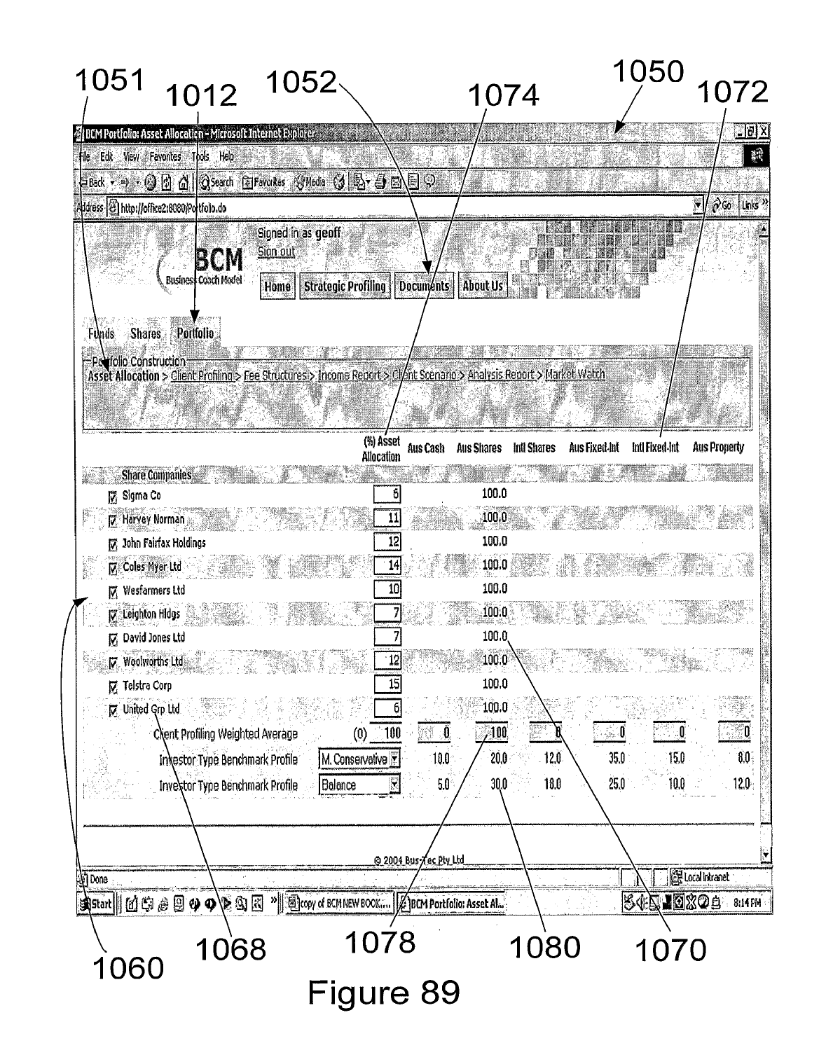

The Asset Allocation display 1052 shown in FIG. 87 includes a table 1066 listing of the investments 1068 selected by the financial planner. Further examples of the asset allocation display 1052 are shown in FIGS. 88 and 89. The table 1066 shows the distribution of assets 1070 over the following asset classes 1072 for each selected investment 1068:
1. Australian Cash;
2. Australian Shares;
3. International Shares;
4. Australian Fixed Interest;
5. International Fixed Interest; and
6. Australian Property.

For example, the table shows that Macquarie Mas Cash Fund has 100% of its assets in Australian Cash; APN Prop for Inc Fund has 5.1% of its assets in Australian Cash and 94.9%o of its assets in Australian Property.

The table 1066 includes a percentage asset allocation column 1074 including a data box 1076 corresponding to each one of the selected investments 1068. The financial planner can there by allocate a percentage of the investor's assets to each one of the selected investments 1068.

The table 1066 shows the sum of the distribution of assets 1070 in each asset class 1072 for the selected investments 1068, where the distribution 1078 of assets for each asset class for an investment is weight by the percentage of assets allocated to that investment by the financial planner. For example, Merill Lynch Hed Glo Titn Fed-Cla D has 100% of its assets in International Shares and has been allocates 7% of the investor's assets. INVESCO(w) Intl Shr Fd has 87.05% of its assets in International Shares and has been allocated 8% of the investor's assets. As such, the weighted sum of the investor's profile in International Shares is 13.9%.

The table 1066 also shows the distribution of assets 1080 in each asset class 1072 for a benchmark risk category selected from the drop down window 1082. The financial planner can select the investor's benchmark risk category from the drop down window 1082 and compare the distribution of assets 1080 of the benchmark with the weighted distribution 1078 of the investor. The financial planner and/or the investor can thereby see how closely the selected investments and the asset allocation correspond to the benchmark risk category of the investor.

Riskiness of a portfolio depends on how the investments within the portfolio move in relation to one another and that by combining investments with different volatility characteristics, you can decrease the volatility of the whole portfolio.

Part of construction of any portfolio is to ensure that you don't take unnecessary risks and that you don't fall in love with your fund selection. This is one of the fundamental reasons why we stress having a discipline selection process that is repeatable and dispassionate. Through asset allocation, this allows us to adjust the fund weights in our portfolio when the fund has been reweighted according to a client's risk return, tolerance or where better investment opportunities have been identified.

The following challenges face Financial Planners when Asset Allocations:
i. To determine an asset allocation that will achieve the client's goals;
ii. To determine whether the asset allocation is consistent with the client's risk tolerance;
iii. If there is no asset allocation that can satisfy the above criteria, then resolve with a suitable compromise.

One method of meeting the above goals is to use a top-down approach to portfolio construction whereby investments are selected by superior sector strength. This approach is then followed by a bottom-up approach whereby investments are selected by their consistency in performance over the last three to five years. Finally, an appropriate asset allocation for the selected investments is determined.

Client Profiling 1054

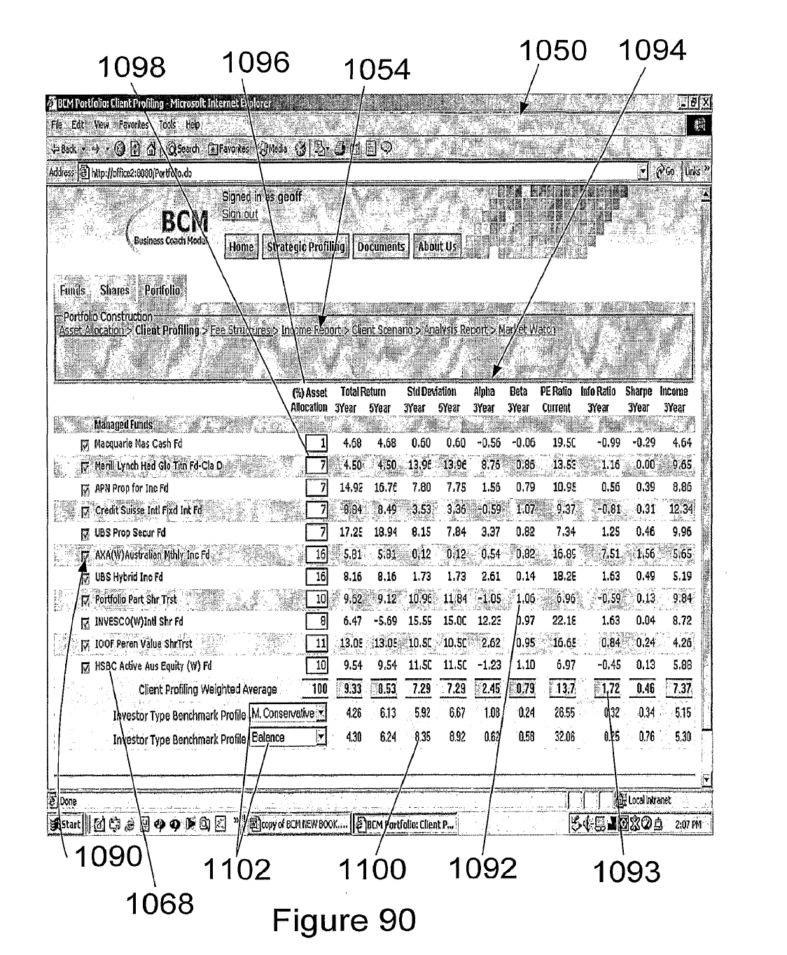

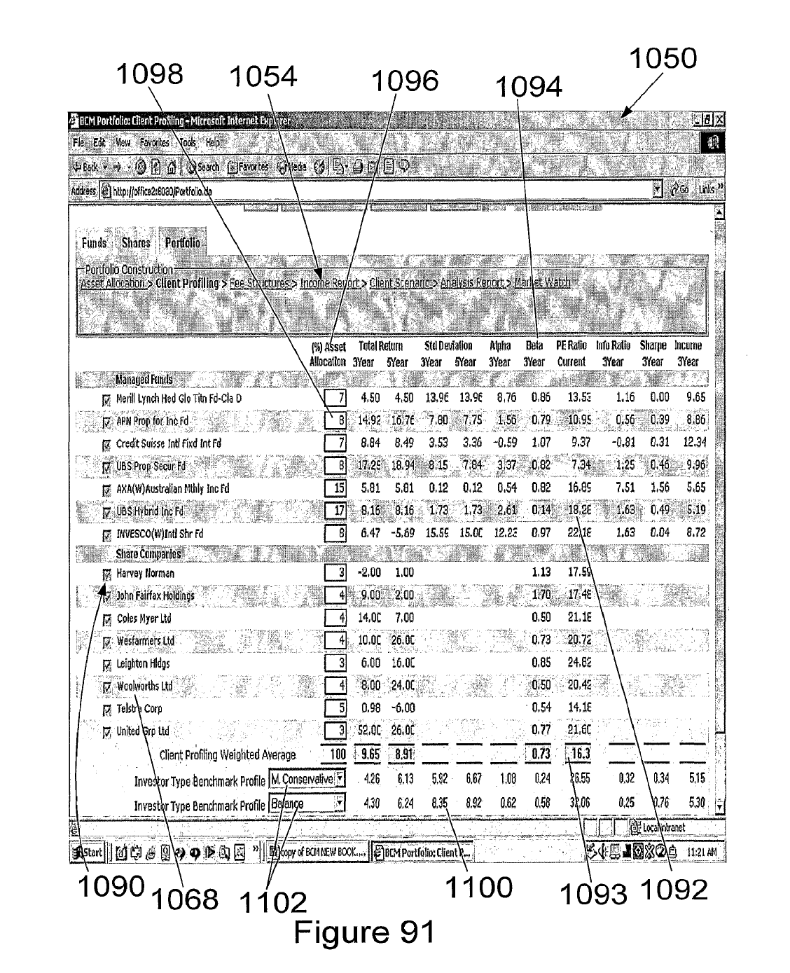

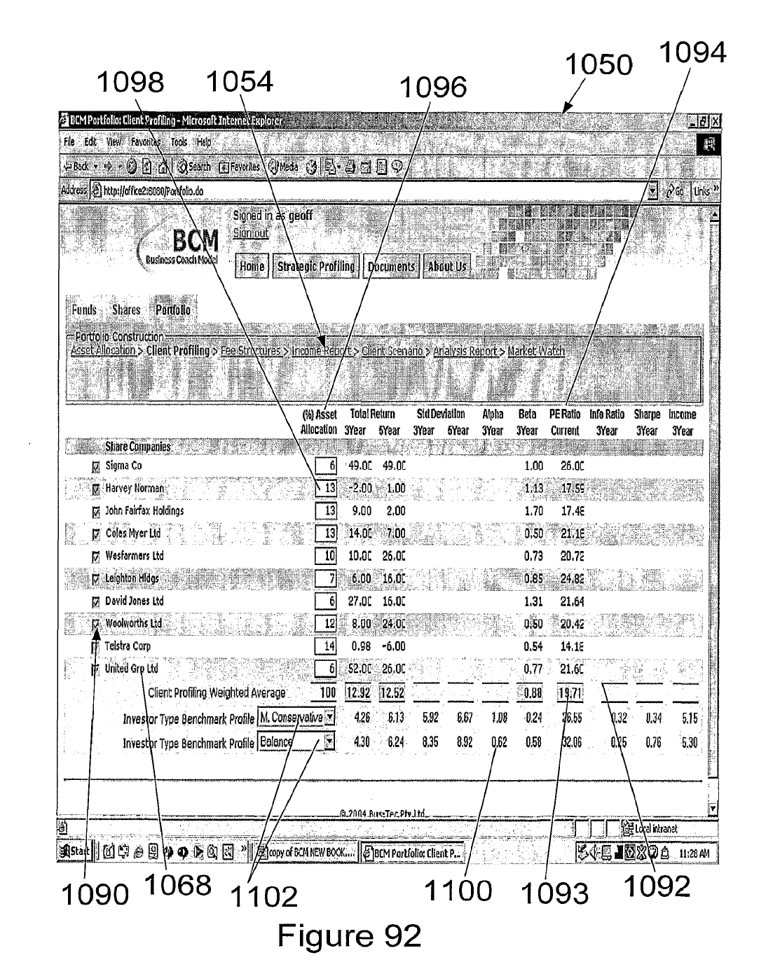

The Client Profiling display 1054 shown in FIG. 90 includes a table 1090 listing the investments 1068 selected by the financial planner. Further examples of the client profiling display 1054 are shown in FIGS. 91 and 92. The table 1090 shows the data 1092 pertaining to each one of the investments 1068 for the following sector indicators 1094:
i. Total Return;
ii. Standard Deviation;
iii. Alpha;
iv. Beta;
v. PE Ratio;
vi. Info Ratio;
vii. Sharpe; and
viii. Income.

For example, the table 1090 shows that Macquarie Mas Cash Fund has a 4.68%> total return over three years; a standard deviation of 0.60 over three years; an alpha of −0.56 over three years etc.

The table 1090 includes a percentage asset allocation column 1096 including a data box 1098 corresponding to each one of the selected investments 1068. The financial planner can there by allocate a percentage of the investor's assets to each one of the selected investments 1068.

The table 1090 shows the sum 1093 of the data 1092 for each sector indicator 1094 for the selected investments 1068, where the data 1092 for each sector indicator 1094 for an investment is weight by the percentage of assets allocated to that investment by the financial planner. For example, Merill Lynch Hed Glo Titn Fed-Cla D has 4.50%> 3 year total return and has been allocated 1% of the investor's assets.

The table 1066 also shows data 1100 for each sector indicator 1094 for a benchmark risk category selected from the drop down window 1102. The financial planner can select the investor's benchmark risk category from the drop down window 1102 and compare the data associated with the sector indicators 1094 of the benchmark with the weighted data 1092 of the investor. The financial planner and/or the investor can thereby see how closely the selected investments and the asset allocation correspond to the benchmark risk category of the investor.

This table 1090 uses rolling returns benchmarking ranging in length from 3 years to 5 years to indicate the range of growth/volatility returns including Alpha, Beta, Current P/E Ratio, Info/Ratio, Sharpe, R Squared and Income. (See detailed under Portfolio Construction dedicated discipline Screen Shot and printout—Analysis Report) and likewise we do the same thing for Direct Shares, both combined on the same platform in the portfolio or individual portfolio.

As a best practice standard, the difference between the actual portfolio and the two appropriate benchmark optimizer, set in a tramlines like format, so as to provide Financial Planners with a Client Risk Tolerance compliance discipline, rather than a behavioral attitude of their own.

c. Fee Structure 1056

Financial Planners are set for a squeeze in the future in profit margin and it is no telling anyone in the business anything they don't already know, that in order to make the cuts least felt, they will have to be on the client's side.

For the last decade or more, the financial service industry has come to expect and consistently deliver double-digit investment returns. However, as global economies weaken and financial markets begin to plateau, the multi million dollar question is “are double digit returns sustainable?” and “if not, what will this mean for fees”. Will planners be able to continue to charge high fees for lesser returns? The consumers will increasingly realise that there are a lot of people in the value chain that are opportunistic. When we break down the various entities of the financial service industry, the structure involves three main components:
i. Product Manufacturers or Fund Managers;
ii. The Administrators or Master Trusts or Wrap Accounts Platforms; and
iii. The Distributors or Financial Advice Givers and Discounters

The thing Financial Planners are going to have to deal with is the supply-side competition—the competition by the funds for getting Financial Planners which is driving up costs—is going to fall apart soon. The costs are just so high now in some areas, particularly in the fancy fee for service but who don't declare ongoing trails. It's just an explosive issue that the consumers are only just starting to understand how much is being taken away from them.

The commission-versus-fee argument—what is important is that the client is getting what is perceived MER's value going forward, they won't support otherwise there are lots of competitive forces outside the financial planning industry and if they think their only competition within the industry, they are very one-dimensional. Choice will test the value chain and whoever is able to blend technology and relationship will win because the consumer is buying the Financial Planners relationship; they are not buying the Dealer Group or Platform Providers of Master Trusts or Wrap accounts.

New pressure will be placed on the industry for transparency, seamlessness, personalization and accountability to justify fees to the more discerning consumers and the industry can only provide sub double digit returns; then the consumer will begin to question and require justification of each layer of fees incurred.

If we start seeing single digit returns, then the demand for good outperforming managers who can provide 2% to 3%> above the average will be great. Investors will be happy to pay high fees for returns at that level. There are reasons to be optimistic in 2005 but it would be difficult to argue strong double-digit returns. Investors will ask themselves if they are getting value for money. Is their Master Trust or Wrap Account adding value and providing value opportunities such as selection of the right Fund Managers to charge fees of 2.0 percent on returns of 15 percent complicated, but in a world where total fees are continuing to charge 3.0 percent while delivering in the era single-digit returns of 8 percent, it gets more.

We can represent individually or combine all three (3) thing such as Managed Funds, Combine Managed Funds and Direct Shares, represented on the same platform in the portfolio.

The system 1000, in its awareness for a more cost efficient Fee Structures dilemma that some consumers are experiencing, includes a combination of both Managed Funds and Direct Shares. As such, the fee structure of normal managed funds by comparison was reduced by 50-70%. Therefore given a $400000 portfolio this represents a huge saving of $6000 pa.

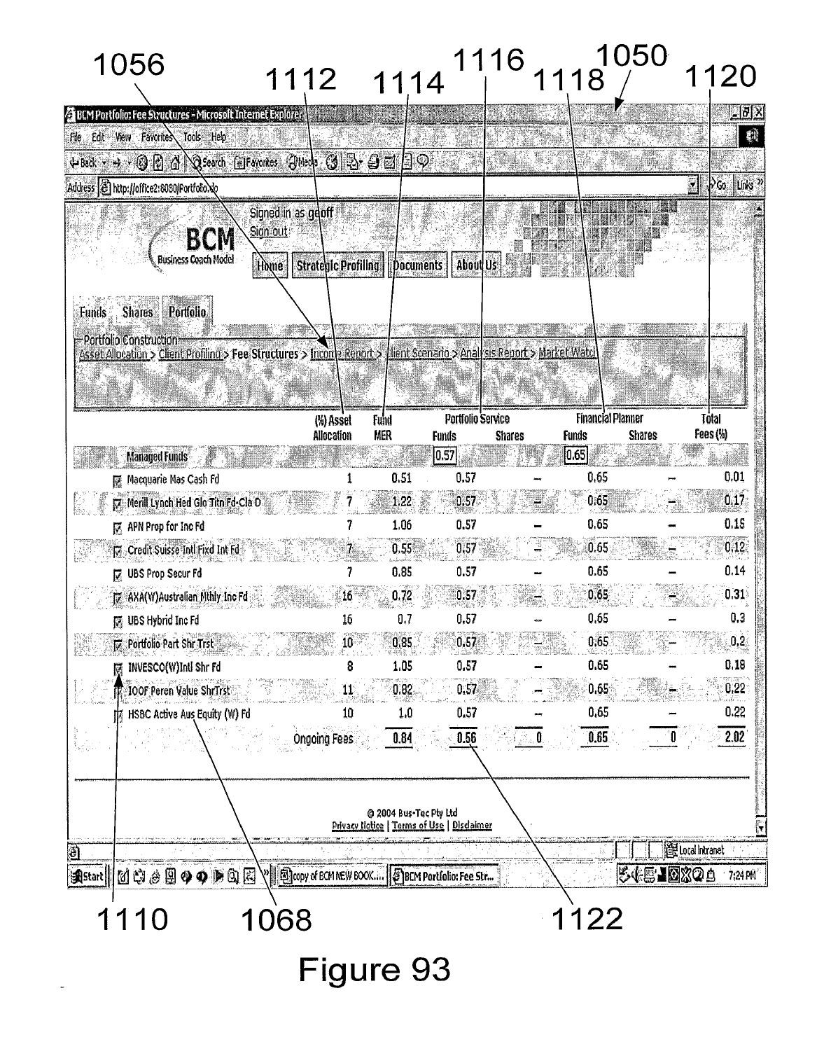

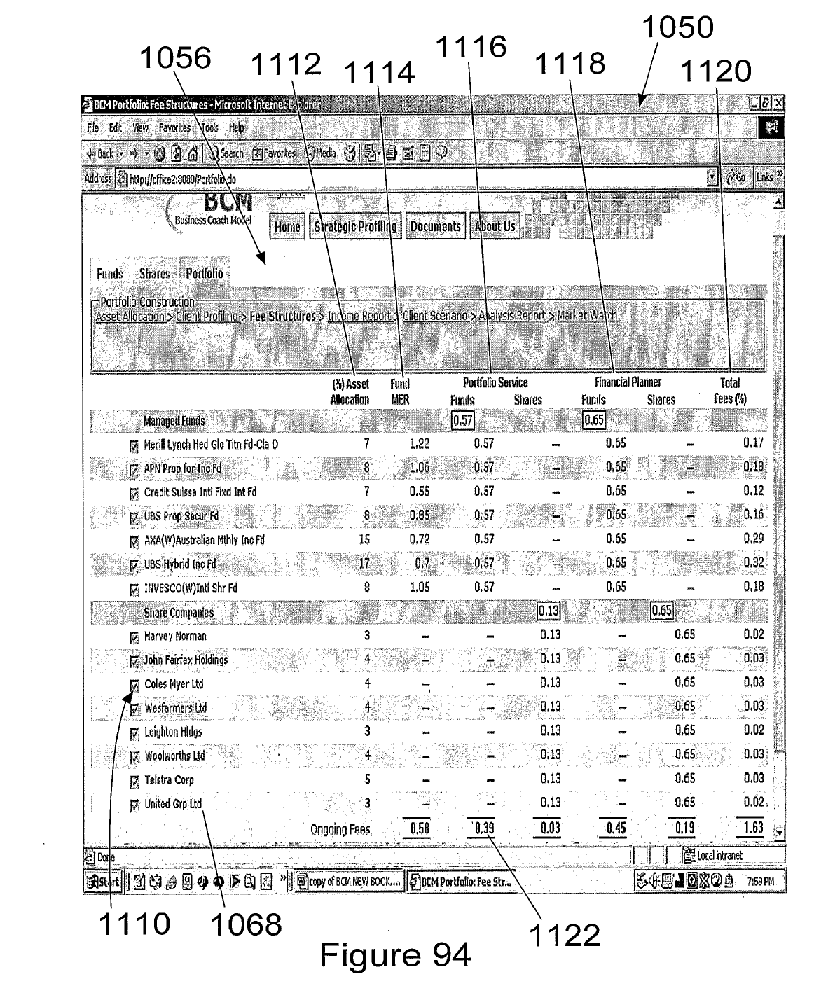

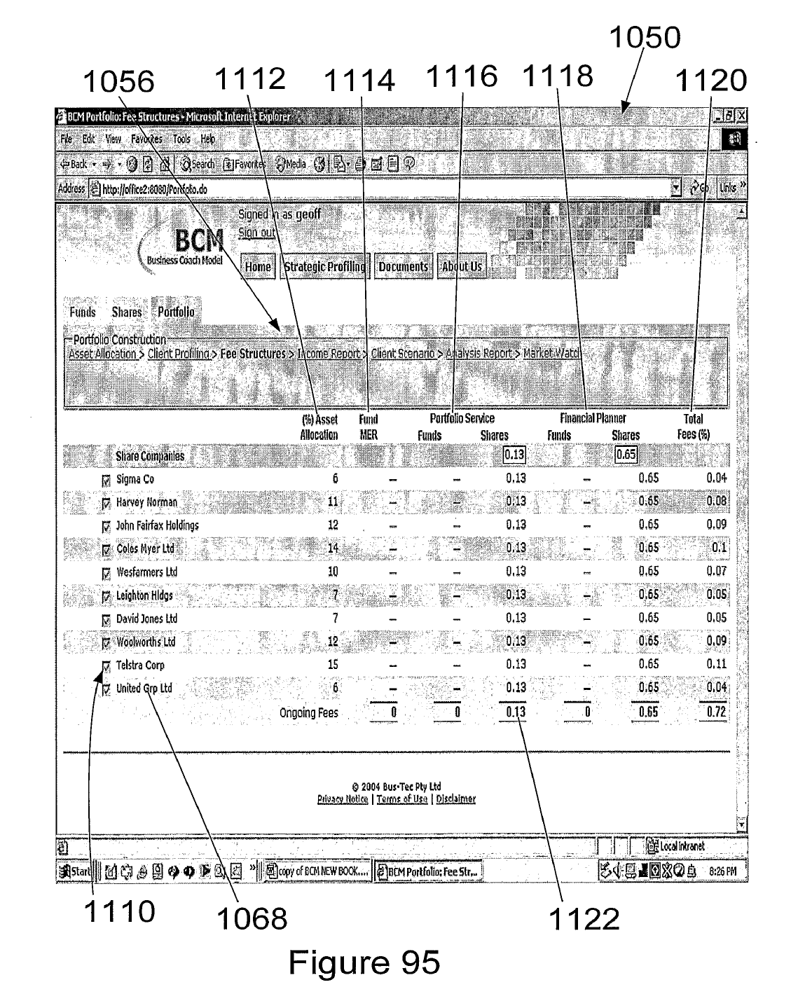

The fee structure display 1056 shown in FIG. 93 includes a table 1110 listing the investments 1068 selected by the financial planner. Further examples of the fee structure display 1056 are shown in FIGS. 94 and 95. For each one of the investments 1068, the table 1110 shows:
i. The asset allocation 1112;
ii. The Fund MER 1114;
iii. Portfolio Service 1116;
iv. Financial Planner 1118; and
v. Total Fees 1120.

The table 1110 also includes the ongoing fees 1122 for each one of the above items.

d. Income Report 1058

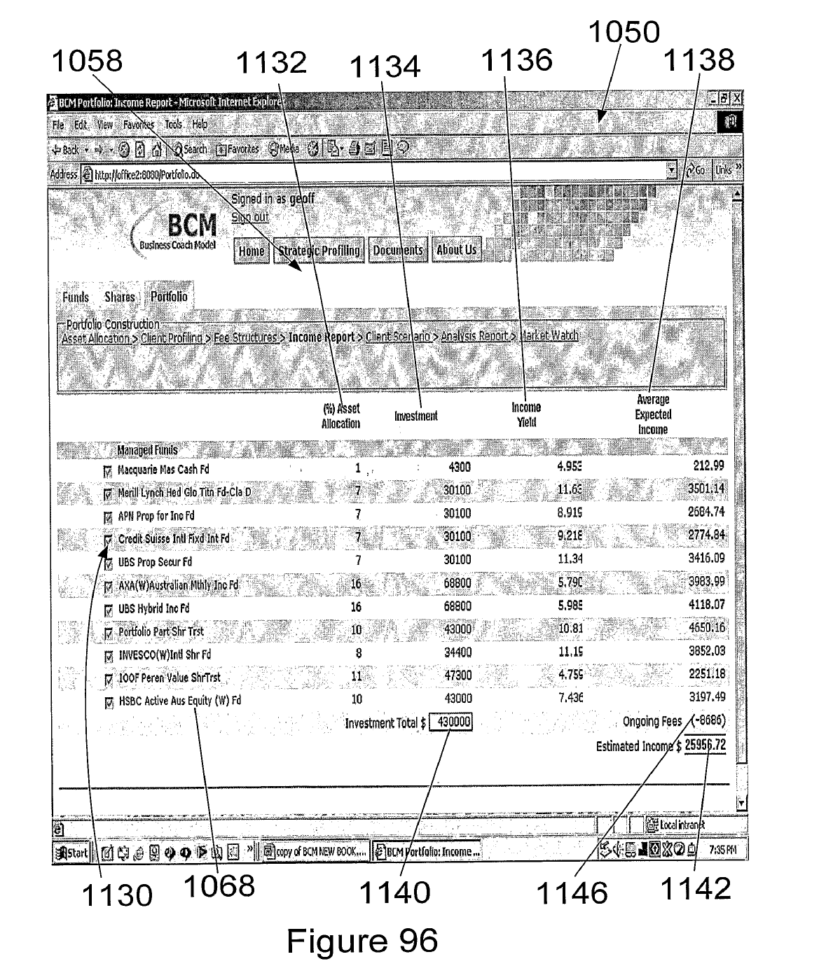

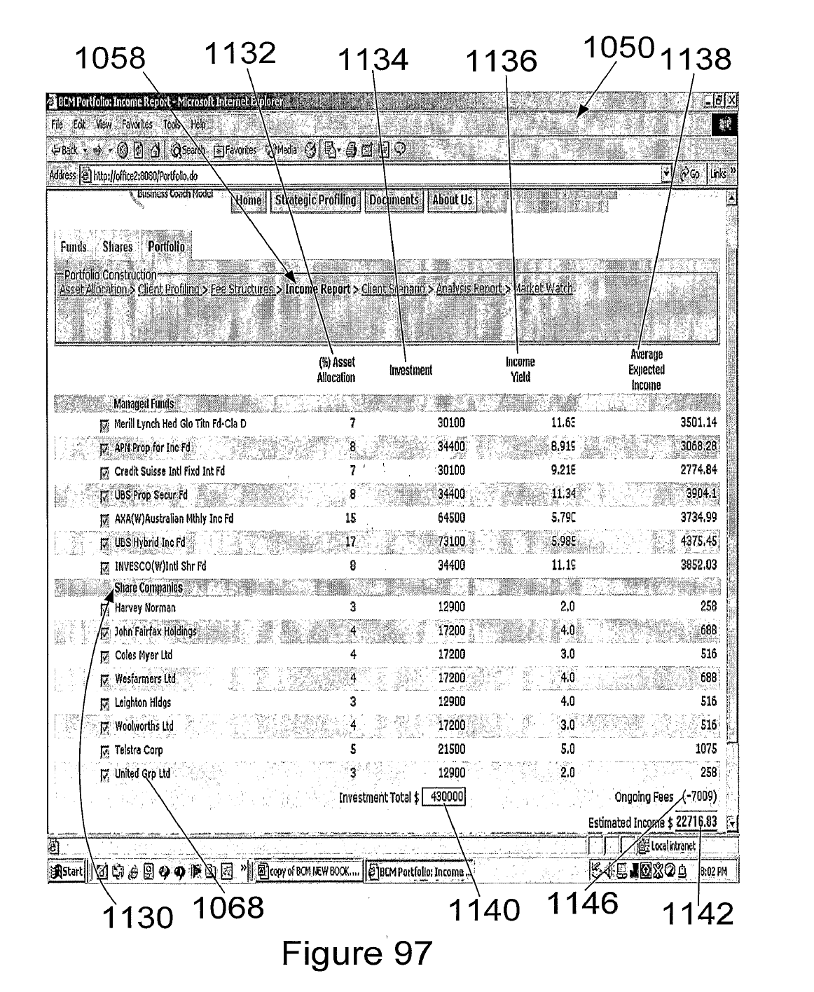

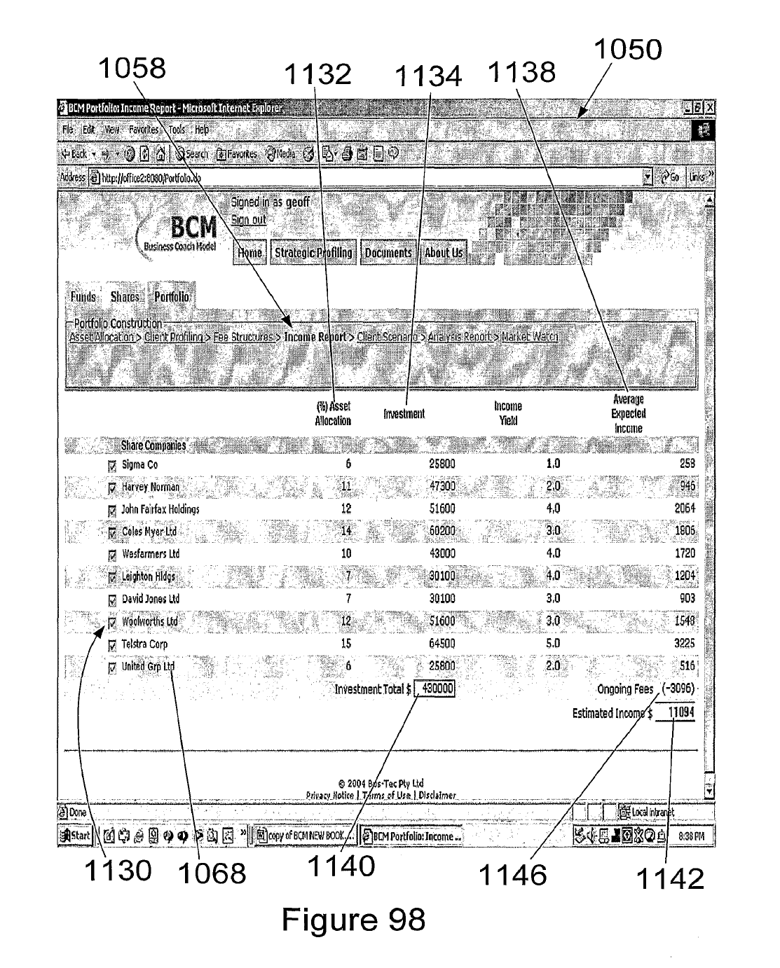

The Income Report display 1058 shown in FIG. 96, generated by the portfolio construction interface 1050, includes a table 1130 listing the investments 1068 selected by the financial planner. Further examples of the Income Report display 1058 are shown in FIGS. 97 and 98. The table 1130 shows the following information for each one of the selected investments 1068:
i. Asset allocation 1132;
ii. Investment 1134;
iii. Income Yield 1136; and
iv. Average expected income 1138.

The income report display 1058 also includes an “Investment Total” data box 1140 in which an amount that an investor wishes to invest in the portfolio can be entered. The income report display 1058 also shows the estimated income and the ongoing fees.

e. Client Scenario 1060

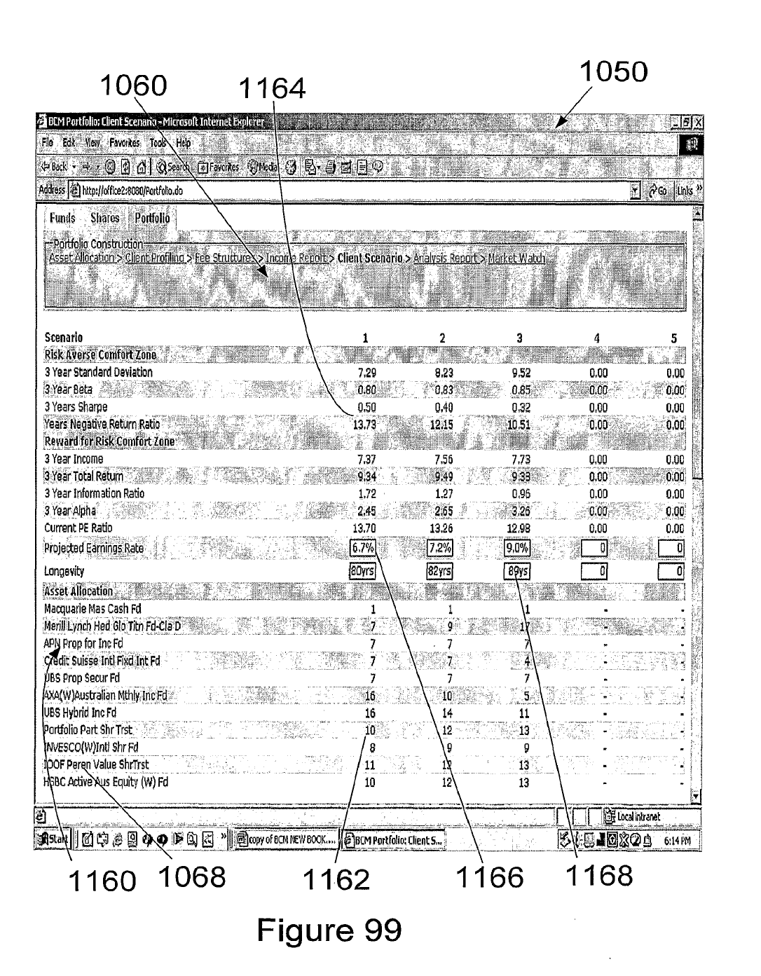

In any new endeavour, there is nothing unusual about someone's goals being initially over-optimistic. More often than not, we have to scale back or modify our ambitiousness in the light of practical considerations. A Financial Planners can use the Client Scenario display 1060 shown in FIG. 99 of the portfolio construction interface 1050 generated by the system 1000 to forecast the client's financial future. The financial planner and the client can review the forecast and to make some adjustments to the investment portfolio to meet the client's future needs.

Financial Planner's are expert in identifying and helping solve the client's financial problems. An undershoot investment portfolio presents an early opportunity to demonstrate that expertise. For example, an undershoot situation can in many cases be seen as an example of overly ambitious initial goals. It highlights a mismatch between: i. The client's shorter-term goals (present lifestyle, personal exertion income, saving/spending trade off, sense of security etc.); and ii. The client's longer-term goals (dependents, education, retirement timing, future lifestyle, bequests, etc.).

Resolving the mismatch which gives use to an undershoot situation will require:
i. increasing the amount to be invested and/or
ii. reducing or deferring or foregoing longer term goals and/or accepting more risk

Nevertheless, notwithstanding the all “Risk Matching Processing”, there are a number of other considerations that are critically relevant to resolving an undershoot situation. A new client being introduced to the issues relevant to a comprehensive, long-term financial plan can feel overwhelmed, even threatened by the strangeness and complexity of it all but may be reluctant to convey this to the Financial Planner for fear of appearing inadequate, for example. Financial Planners on the other hand, are so familiar with what to them are bread and butter matters that it can be difficult for them to sense how strange it all seems to a new client.

The Client Scenario display 1060 includes a table 1160 divided into the following three sections to assist in properly identifying and dealing with the above described problems:
i. Asset Allocation;
ii. Risk Aversion Comfort Zone;
iii. Reward for Risk Comfort Zone

A discussion on each of these aspects is set out below.

i. Asset Allocation Risk Profile Vs Investor Profile

The term “Risk Profile” is sometimes used to denote a description of a client's risk tolerance and sometimes to denote a description of an investment strategy

Financial Planners in the process of selecting Asset Allocation where the Financial Planners triple challenge is:
To determine an asset allocation that will achieve the client's financial goals
To determine whether the asset allocation is consistent with the client's risk tolerance
If there is no asset allocation which meets these first two challenges, then have the process of resolving the mismatch.

ii. Risk Averse Comfort Zone

3 Year Volatility Or Standard Deviation—As with most investments, there can always be long/short-term variances in returns such as the average volatility standard deviation, i.e.

| Market Sector | Average Volatility Range % |
|---|---|
| International Equities | 15-18 |
| Australian Equities | 13-14 |
| Balanced Funds | 6-9 |
| Fixed Interest Securities | 3-5 |
| Property Securities | 8-10 |
| Cash | 0.2-0.4 |

3 Year Beta—A measure of market sensitivity, i.e. the extent to which a Share or Unit

Fund fluctuates with the market. This indicator can be used to help identify Fund Managers likely to be aggressive in an active market as well as those that should behave defensively.

Beta is a mathematical measure that helps to explain the expected movement in unit price that can be attributed to the broad market movement. In other words, unit funds with a beta of 1.3 carry an expectation of outperforming a rising market by 30% on the way up with a minor reversal of 30%> in a market retreat. Such investments are more volatile than a beta of 1.0 but less volatile should be a unit fund with a beta of 0-6. The expectation here is for 60% of the market's performance on the way up and 60% of any market reversal—a significantly less volatile performance.

3 Year Sharpe Ratio (Risk/Reward)—Measures the portfolio efficiency performance of a portfolio's return in risk adjusted terms or simply means the reward receiving for the risk taken. The higher the ratio, it can be considered a very good result while a ratio below 1-0 shows the fund has been ordinarily rewarded.

Years Negative Return Ratio—The dispersion of possible returns around expected returns is measured by the volatility of standard deviation in which the actual returns are likely to deviate from expected return due to random factors. Therefore, if an expected return is 16%) and the standard deviation is 6%>, it would suggest that the actual return would lie within a range of 10% to 22%. The objective of this indicates the probability of negative returns over 6.25 years. The purpose of knowing the level of an active manager makes it very useful when accessing whether a manager's out performance is due to skill or luck or is the client being rewarded for taking the risk.

iii. Reward For Risk Comfort Zone

3 year Income—A portfolio consisting of securities whose principal attractiveness lies in the steady income they provide.

3 Year Total Return—A general term for assets such as shares and property, which provide investment returns, (comprising both capital growth and income), which outperforms inflation. Growth assets compare to debt securities such as fixed interest or cash investments.

3 Year Information Ratio Or Performance Quartiling—Graphically, this is a very good indicator of performance reward for risk. In other words, it is a statistical measure dividing a sample into four numerical equal groups. Thus, the “top quartile” means the top 25%> of a given sample. In this particular case, the sample indicator, i.e. the medium 3 Year moving average of the Australian universe, International Shares and Fixed Interest.

3 Year Alpha—The return of a security or a portfolio would be expected to earn if the market rate of return were zero, i.e. the average benchmark. A positive alpha indicates that an investment has earned on average, a premium above that for the expected for the market variability. A negative Alpha would indicate that the investment received on average a premium lower than that expected for the level of variability. Alphas are used as a performance indicator.

1 Year Price Earnings Ratio—Shows the number of times the share/unit price covers the company's/fund manager's EPS/EPU. It is commonly used to measure how attractive a share/unit is to investors, and to compare shares/units in one company with another.

PE ratio=market price of shares/unit/earnings per share/unit

Longevity Risk—The risk that individuals will spend all their savings before they die. The accumulated value of investments at any date is uncertain. The accumulated value of any investment assets depend upon:
the rate of savings each year up to retirement;
the number of years of pre-retirement;
return on investment; and
the rate of spending in retirement

Snail Trail—A graphical depiction of a fund's risk and return performance over time, relative to industry averages. Risk, measure in terms of the standard deviation of returns, is measured on the horizontal axis, and returns on the vertical axis. The point where the two lines intersect in the middle of the graph represents the average risk and return for all funds surveyed within the sample over the same period. Against this matrix, the historical performance of a particular fund over consecutive time periods is plotted and then joined by a line to create the snail trail. The preferable sector for a fund to be in is the top left-hand

The following range of ECONOMIC INDICES are used to measure the performance of specific asset classes:

| | |
|---|---|
| Cash | UBSWA 90 Day Bank Bill Index |
| Australian Fixed | UBSWA Composite Bond All Maturities Index |
| Interest | SB World ex Australia Government Bond Index |
| | hedged in $A |
| Australian Equities | S&P/ASX 200 Accumulation Index |
| | S&P/ASX 500 Accumulation Index |
| | S&P/ASX Small Ordinaries Accumulation Index |
| International | MSCI World Net Accumulation Index in $A |
| Equities | MSCI AC Far East Free Gross Ace Index in $A |
| Property Securities | S&P/ASX 200 Property Trusts Accumulation Index |

To achieve a desirable lifestyle throughout retirement, realistic objectives must be set and a planned development to achieve them. The most valuable asset for many young and middle-aged people is their income earning ability, which can be viewed as an asset called human capital. An investor's human capital is an important component of wealth with the proviso that it must be viewed as a declining asset whose value will typically fall as retirement approaches and future years of income earning reduces.

The Client Scenario Display 1060 table 1160 includes five combinations of asset allocations 1162 for the selected investments 1068. The Client Scenario Display 1060 table 1160 also includes data 1164 for the 3 Year Standard Deviation, 3 Year Beta, etc for each combination of asset allocations 1162. For each asset allocation 1162, the table 1160 includes the projected earnings Rate 1166 and the longevity 1168 of the client.

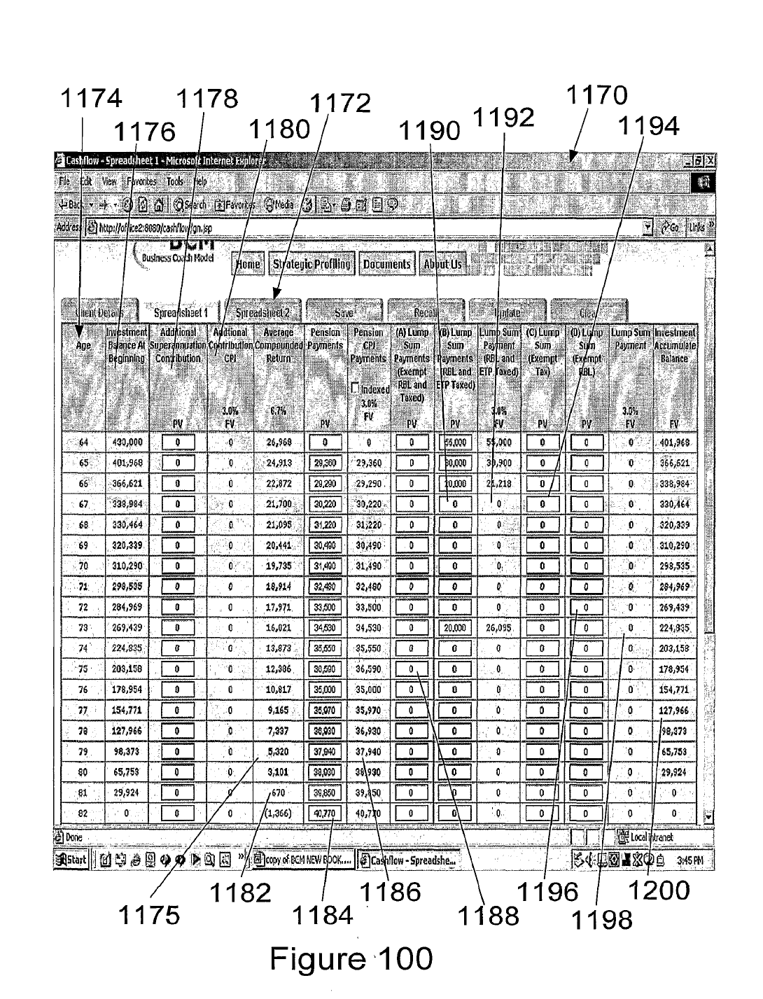

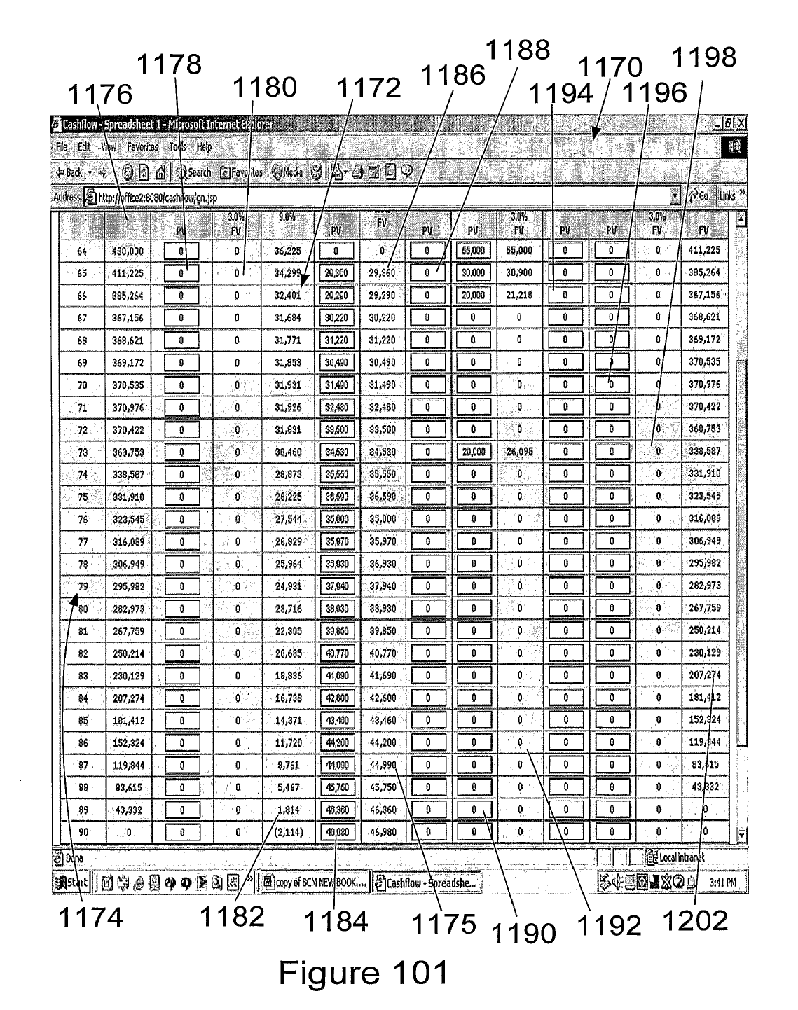

The Portfolio Construction Interface 1050 is in communication with the calculator 1170, shown FIGS. 100 and 101. The calculator includes the following displays, each being accessible by way of a corresponding tab 1172:
i. Client Details; and
ii. Spreadsheet.

The client details display (not shown) is used by the financial planner to enter details about the client into the system 1000. Such details include, for example, the client's current wage, assets, other revenue streams, expenses, etc.

The spreadsheet display 1174 shown in FIGS. 100 and 101 uses data from the client details display and generates annual data 1175 for the spread sheet for the each of the following items:
i. Investment Balance at Beginning 1176;
ii. Additional Superannuation Contribution 1178;
iii. Additional Contribution CPI 1180;
iv. Average Compounded Return 1182;
v. Pension Payments 1184;
vi. Pension CPI Payments 1186;
vii. Lump Sum Payments (Exempt RBL and Taxed) 1188;
viii. Lump Sum Payments (RBL and ETP Taxed) 1190;
ix. Lump Sum Payments (RBL and ETP Tax) 1192;
x. Lump Sum (Exempt Tax) 1194;
xi. Lump Sum (Exempt RBL) 1196;
xii. Lump Sum Payment 1198; and
xiii. Investment Accumulate Balance 1200.

In any financial or investment planning process, there are two important stages:
i. The estimated level of investment risk and return that can be expected from various investments available in the market—recognising that the premium return and market risk is the same for everyone—that investors cannot be expected to be rewarded for risk that can be easily and cheaply avoided through diversification.
ii. The determination of an investor's capacity to carry risk. For example, an investor exposes himself to a single investment or specific sector with all his savings, thinking that he is going to get 5%> premium return but market conditions expected will be considerably different. It's important to recognise that the ability of an investor's capacity bearing market risk depends upon investment horizon—age, experience, wealth, capacity to save and spending patterns.

The risk that individuals will spend all their savings before they die:
i. The accumulated value of investments at any date is uncertain; and
ii. The accumulated value of any investment assets depend upon
   the rate of savings each year up to retirement
   the number of years of pre-retirement
   return on investment
   the rate of spending in retirement

At any time of life, savings reflects a trade-off between spending money now and setting money aside to be spent at some later date. It doesn't matter what the purpose of saving is, the principle is always the same. The greater proportion of income spent on current needs, the less that will be available later, but to lower your wealth risk, the higher your pre retirement years savings rate. If you are going to limit a long-term investment horizon to a class of assets offering a low level of returns because of low volatility risk, you must expect an increase in wealth risk (having insufficient wealth to fund living expenses later in life).

However, on the other hand, the problem with the asset classes with the higher expected returns also carries volatility risk, which also increases the chance that actual returns will be different from the expected returns.

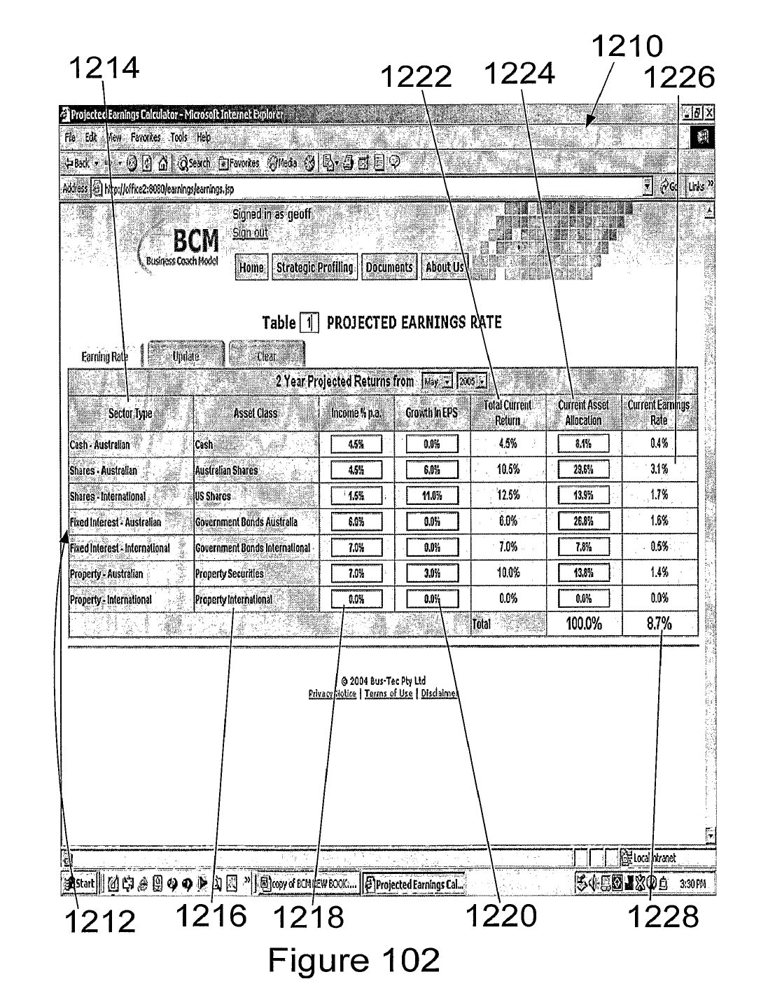

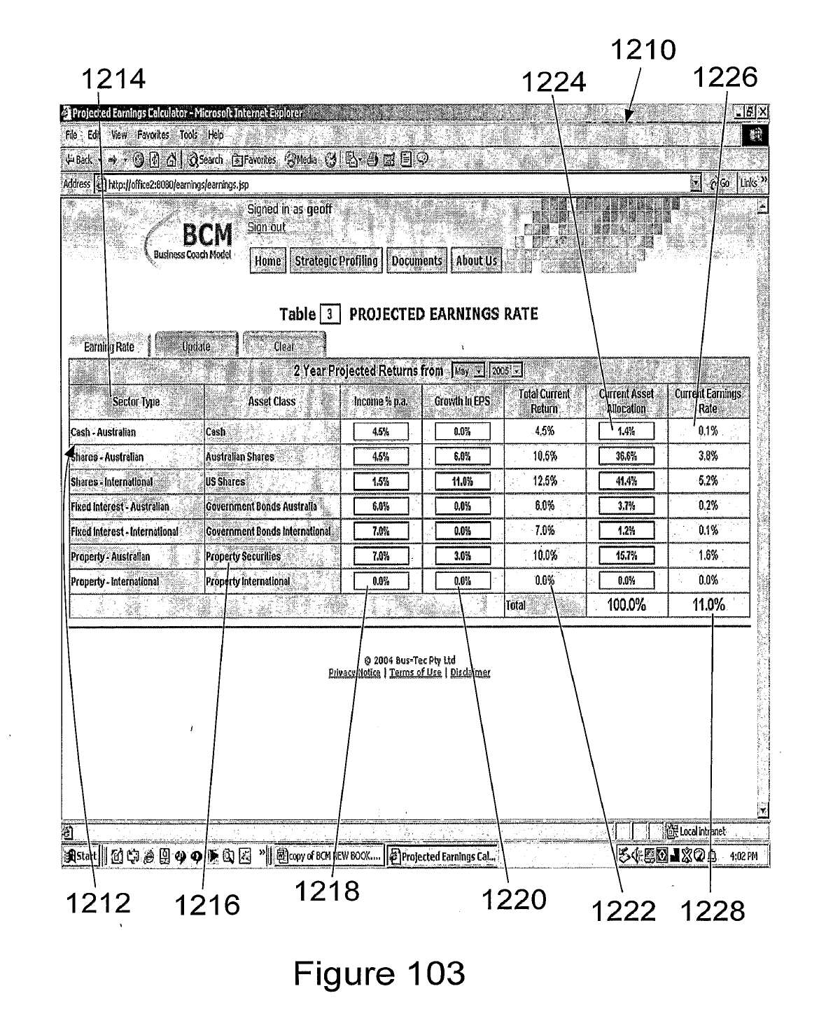

The Portfolio Construction Interface 1050 is in communication with the Projected Earnings Rate Calculator 1210, shown FIGS. 102 and 103. The calculator 1210 includes a table 1212 showing the following details:
i. Sector Type 1214;
ii. Asset Class 1216;
iii. Income % PA 1218;
iv. Growth in EPS 1220;
v. Total Current Return 1222;
vi. Current Asset Allocation 1224; and
vii. Current Earnings Rate 1226.

The table 1212 also indicates the total current earnings rate 1228.

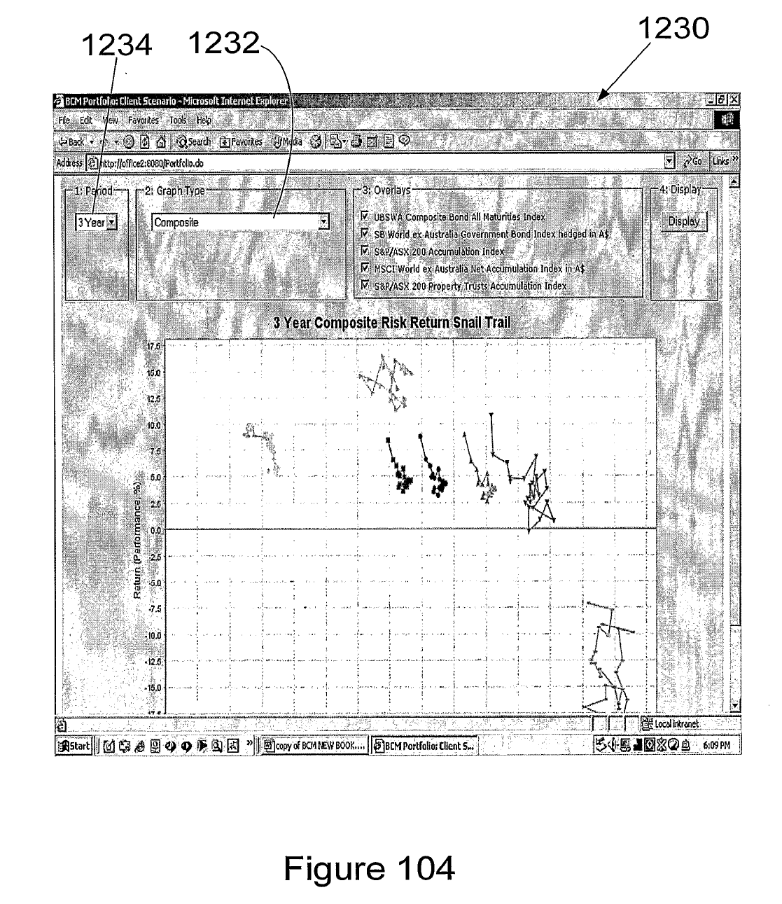

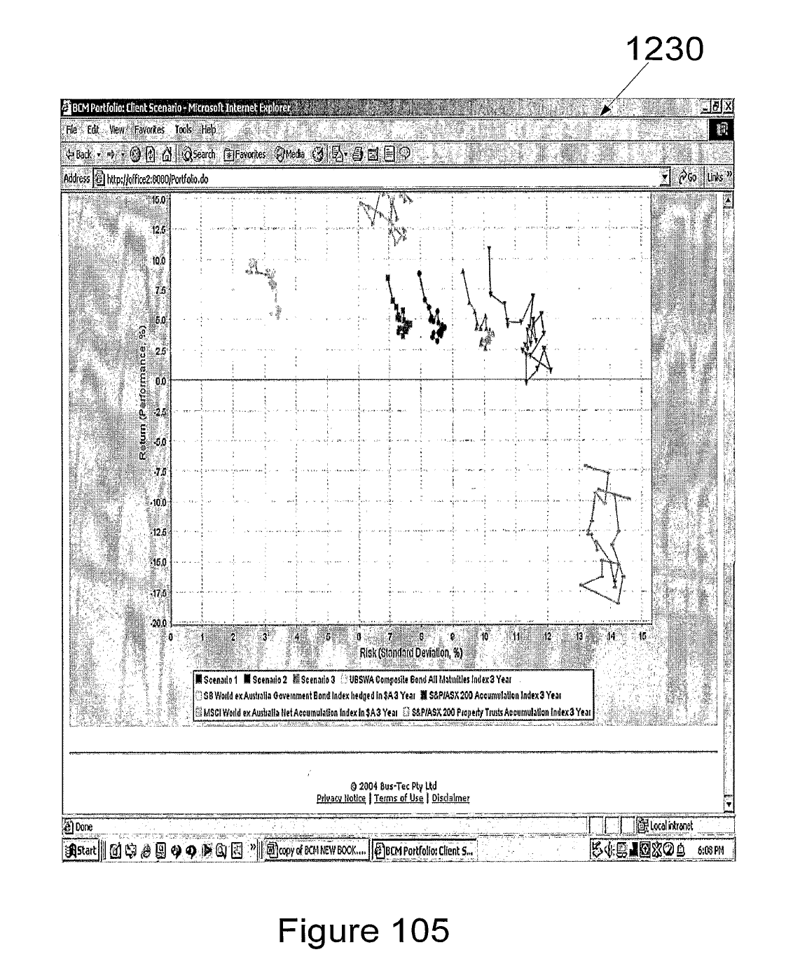

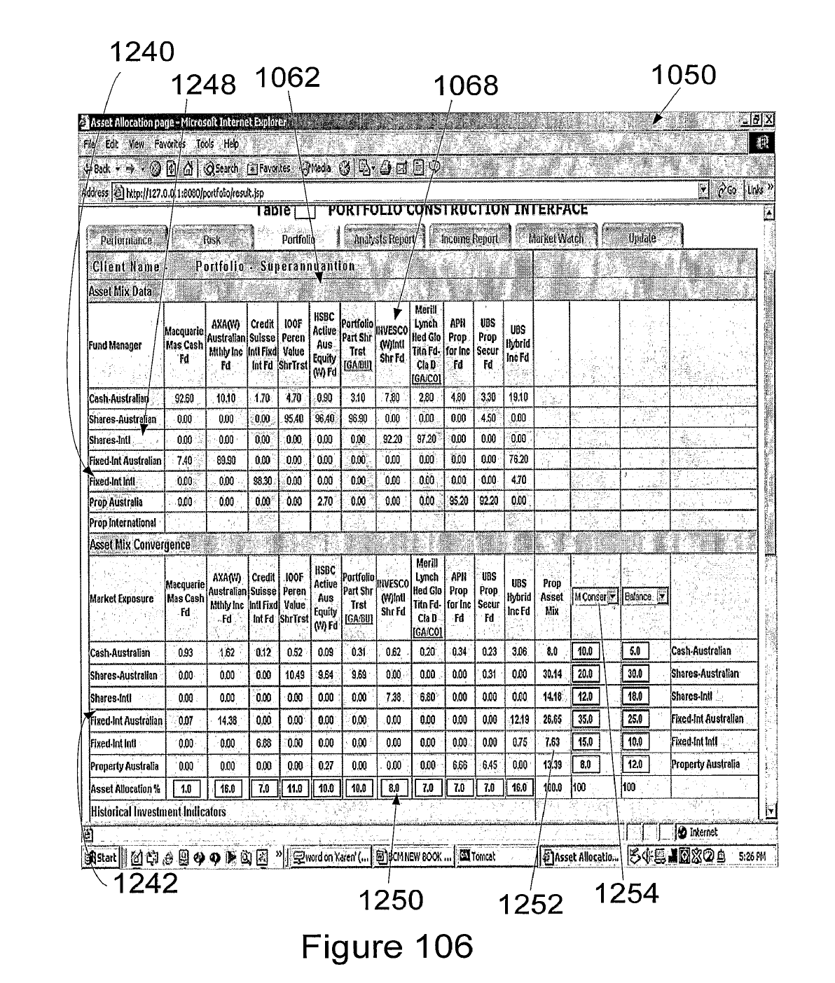

The Portfolio Construction Interface 1050 is also in communication with the Snail Trail display 1230 shown in FIGS. 104 and 106. A financial planner can select a graph type from the “Graph” pull down window 1232. The financial planner can also select the investments 1068 that he or she wishes to see the chosen graphs for. The financial planner can also select the period for the graphs from the “Period” pull down window 1234. The display 1230 shown in FIGS. 104 and 105 show 3 year composite risk return snail trails for each one of the selected investments 1068. A financial planner can use the snail trail display 1230 to graphically compare the performance of the selected investments.

f. Analysis Report 1062 The Analysis Report display 1062 shown in FIG. 106, generated by the portfolio construction interface 1050, includes the following tables:
i. Asset Mix Data Table 1240;
ii. Asset Mix Convergence Table 1242;
iii. Historical Investment Indicators 1244; and
iv. Ongoing'Fee Structure 1246.

The asset mix data table 1240 shows the distribution of assets of each selected investment 1068 across a number of asset classes 1248. For example, the table 1240 shows that Macquarie Mas Cash Fund has 92.6% of its assets in Australian Cash and 7.4% of its assets in Fixed Interest Australian.

The asset mix convergence table 1242 shows the distribution of assets of each selected investment 1068 across a number of asset classes 1248. The table 1242 also shows percentage allocation 1250 of the investor's assets across the selected investments 1068. The financial planner can thereby see the allocated a percentage of the investor's assets to each one of the selected investments 1068.

The sum of the assets of the investments 1068 for each asset class 1248, where the assets of each investment are weighted by the percentage of the investor's assets allocated to the corresponding investment, is also shown as the proposed asset mix 1252. The table 1242 also shows the distribution of assets in each asset class 1248 for a benchmark risk category selected from the drop down window 1254. The financial planner can select the investor's benchmark risk category from the drop down window 1254 and compare the distribution of assets of the benchmark with the proposed asset mix 1252. The financial planner and/or the investor can thereby see how closely the selected investments and the asset allocation correspond to the benchmark risk category of the investor.

The historical investment indicators table 1244 shows data 1256 on the performance of each selected investment 1068 across a number of different historical performance indicators 1258. For each indicator 1258, the table 1244 shows the weighted average 1260 of the data for the selected investments 1068. The financial planner can select the investor's benchmark risk category from the drop down window 1254 and compare the benchmark performance indicators 1262 with the proposed mix 1260. The financial planner and/or the investor can thereby see how closely the selected investments and the asset allocation correspond to the benchmark risk category of the investor.

The ongoing fee structure table 1246 includes fees associated with each one of the selected investments 1068 for:
i. The fund manager;
ii. Portfolio service; and
iii. Financial planner.

The table 1246 also shows the total outgoing fees. The financial planner can attempt to reduce fees by replacing selected fund managers with direct shares having similar performance and risk levels.

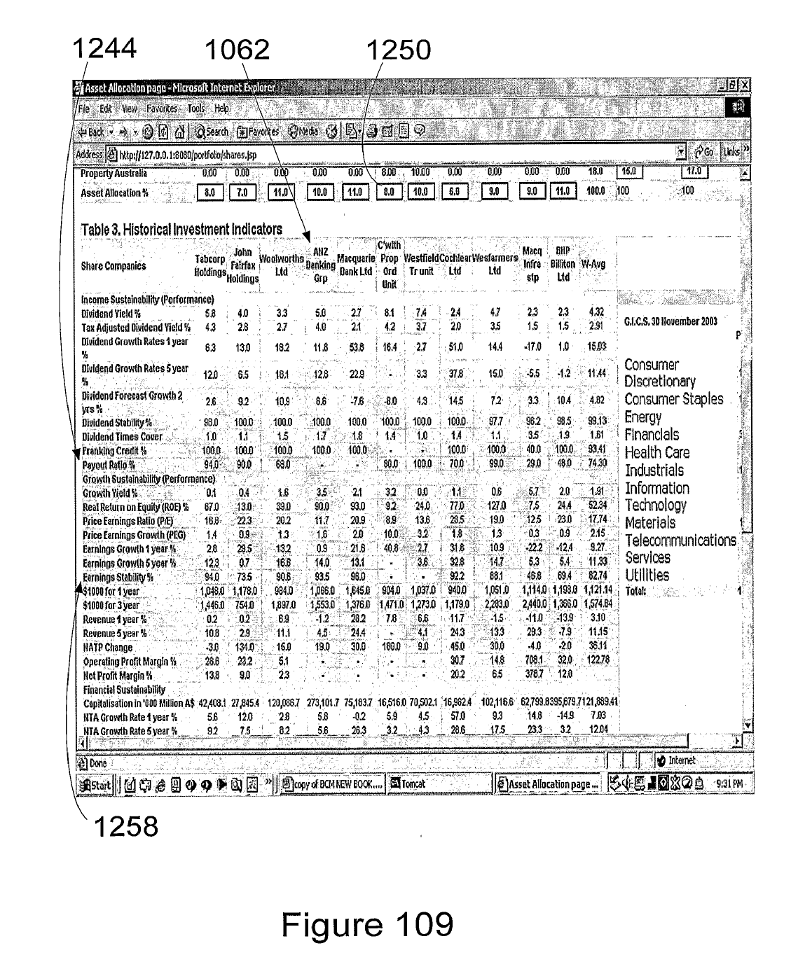

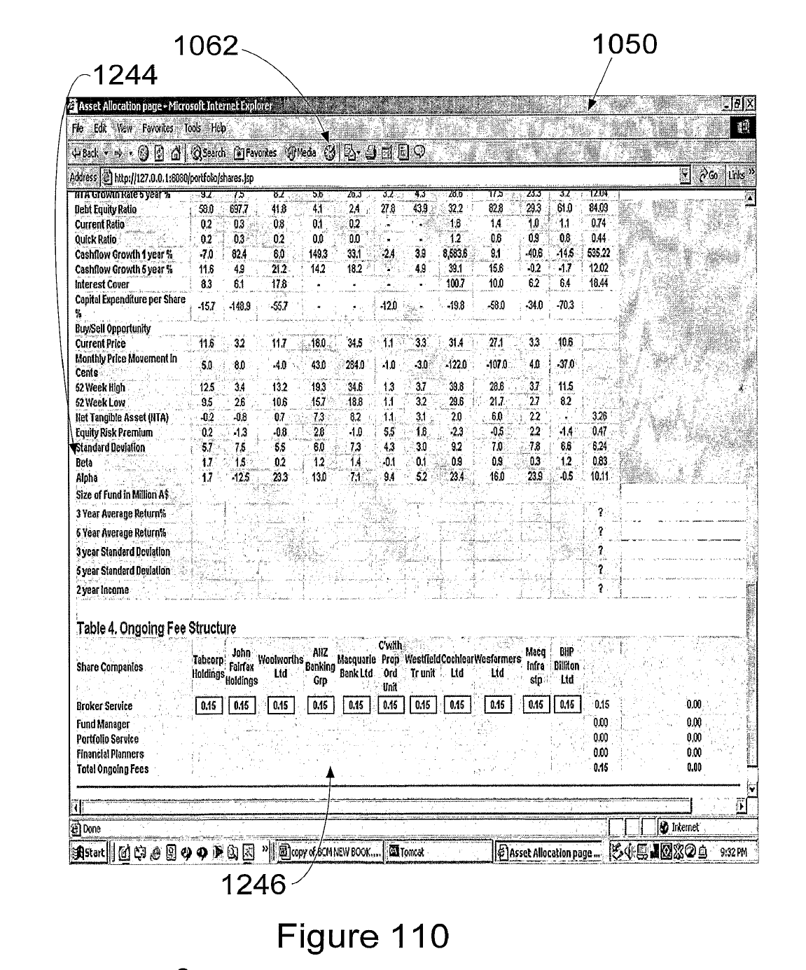

Another example of the Analysis Report display 1062, generated by the portfolio construction interface 1050, is shown in FIGS. 109 to 110.

The computer system 1000 can automatically send the analysis report generated by the portfolio construction interface 1050 to the controller.

g. Market Wrap 1064

The Market Watch display 1064 shown in FIG. 1064, generated by the portfolio construction interface 1050, includes the following tables:
i. Market Watch Entry Price 1270; and
ii. Market Watch Exit Price 1272.

The market watch entry price table 1270 includes a list of the selected investments 1068. The table 1270 also indicates the short term price of each one of the investments. For example, the price for Macquarie Mas Cash Fund is shown for every day between 13 May and 2 May.

The market watch exit price table 1272 includes a list of the selected investments 1068. The table 1272 also indicates the short term price of each one of the investments. For example, the price for Macquarie Mas Cash Fund is shown for every day between 13 May and 2 May.

By watching the short term price of an investment, a financial planner is attempting to gain a little extra with each trade.

Part of the investment process is the Market Watch, which is designed to improve the market timing for buying and selling stocks. The strength of the sign will depend upon the depth and breadth of the earnings revision. The evaluation score ranks stocks by excess retainers and short-term negative earning revision

Investors in a Managed Fund own shares in the fund in a similar way that shareholders own shares in a company. However, the price of a share is determined by demand; that is, if there are more buyers than sellers of a share, the price goes up as much as it is the market that sets the share price.

For Managed Funds, high demand does not necessarily translate to a higher unit price than a less popular fund. Theoretically, there is no limit to the number of units available in a fund. As a new member buys into a fund, the fund manager simply issues out more units. The law of supply and demand does not apply in the same way.

It is the fund manager who determines the unit price by dividing the total assets of the fund by the number of units on issue. The total assets of a fund are in turn determined by the market price of the underlying shares and other securities just as the market value of the underlying assets change every day so does the unit value. What is useful though in measuring the net worth of the unit price is to look at the rate of change of unit price over a period of time as long as it accounts for any distribution in dividends for shares, cash for interest rates and realised capital gains.

Retail Managed Funds are generally listed in the ‘Financial’ section of the newspaper together with both the Buy Price (purchase) and the Exit Price (sell). The difference between these is the buy/sell spread is the administrative fee or MER of management.

Traditional managers are generally handcuffed to benchmarks and therefore find it difficult to manage volatility, and as a result, they simply run their portfolios with a similar volatility profile to the index that they are benchmarked against. Unfortunately, it seems to be acceptable for traditional managers to lose money as long as the index they are benchmarked against loses a greater amount than the manager. If they lose slightly less than the index, then the traditional manager feels he has added value. Such an outcome could be a sub-optimal result for the absolute return for the financial planner whose goal is first to preserve capital followed by pursuit of profits.

Traditional Fund Managers generally put too much emphasis on the continually rising market theory and negative returns would be seen as a good result if the manager had outperformed the index they were benchmarked against, whereas Financial Planners consider capital preservation of client portfolios is paramount and any loss is under-performance.

Fund Managers believe that if you just stick with the market, then you will be OK in the long run; for example, for the period 1964 to 1981, the Dow Jones Index was without increase with periodical ups and downs, thus remained gainless but to a retiree this meant no capital growth. Risk assessed very differently by Financial Planners will define risk as a deviation from the benchmark as a permanent loss of capital, Following the crash of 1929, the bear market was a slow motion featuring no fewer than six major rallies from 1930 to 1932, each one peaking lower than the previous one but the worst was to come; the Dow Jones Index virtually went sideways for some 20 years before the post war boom kicked in, in 1950 and lasted until the mid 1960's. So bear markets come in two varieties:

Short—two to three years characterised by sharp rallies and steeper falls, i.e. 1973 to 1975.

Long Cycles in market stocks take two steps forward and three steps back for up to 2 decades, i.e. 1966 to 1982.

Nevertheless, ironically as a result of a bottomed—out bear market, the portfolio construction process has been strengthened by the introduction of negative earnings, which can be looked on as a penalty revision to the evaluation score. The results of using this technique from a moderate value to a “core” investment style because there is little downside in a rising market.

A very long bull market can be followed by another market of almost equal duration, i.e. 1982-2000 suggesting punishment could go on for 10 years. What is clear is that stock prices have got to go a long way before they met the single digit multiples P E's of previous bear markets.

Should asset allocation be the same in high and low inflation environments or whether markets are at peaks or troughs. Planners must exercise judgment; it's unavoidable even by those who use diversified funds.

Rationality believes because we spread a client's money over the typical Balance type mix, we have achieved proper diversification and sat back and waited for the rewards. Equity performances are more than just an average return and standard deviation; they are about people, investors and short-term disappointments.

Avoid International equities when the value of the Australian dollar is rising and International Securities are falling because:

Both in terms of conversion and exchange rate risk, i.e. purchase in offshore currency and convert to local currency. In other words, the offshore investment has to risk 3% o to 4% just to breakeven.

Similarly, their poor relative performance in recent years, making the same mistake made 10 years ago when they decided to enter the foreign markets.

If growth funds are selected, the Financial Planners have chosen a fundamentally stock market based allocation. As we have found out in the latest global stock market debacle, Fund Managers only play at the edges around their central asset mix mandate.

As a good example of share prices trading at a higher price relative to R.O.E. to justify it, Japan stock market outperformed the rest of the world pre '89 for a good 15 years which provided a compelling reason not to invest overseas which investors tended to ignore. These out performances left Japan markets trading pretty rich values, leaving Japan shares trading 5 times book values which normally should have been 2 times. The same similarity applies to the US share markets in the '90's but not as badly overpriced like Japan's was.

While we have shown and described specific embodiments of the present invention, further modifications and improvements will occur to those skilled in the art. We desire it to be understood, therefore, that this invention is not limited to the particular forms shown and we intend in the append claims to cover all modifications that do not depart from the spirit and scope of this invention.

The term “investment”, and variations thereof, is used throughout the specification to means a representation of an investment. For example, the term “investment” is used to represent property, or other possession, acquired for future financial return or benefit.

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form of suggestion that the prior art forms part of the common general knowledge in Australia.

What is claimed is:

1. A database management system comprising:
a database storage comprising:
a group of data items stored in a first portion of the database storage, each data item associated with one or more data item classes; and
one or more benchmark sets of data items stored in a second portion of the database storage, each benchmark set associated with one or more data item classes and with a risk tolerance;
a database interface configured to provide access to the database storage; and
a processor configured to:
retrieve, via the database interface, each data item in the group from the first portion of the database storage;
obtain a risk tolerance for the retrieved data items;
retrieve, via the database interface, a benchmark set from the second portion of the database storage based at least in part on the obtained risk tolerance;
identify a first distribution of data item classes for each data item in the group over a first set of data item classes associated with each data item;
identify a second distribution of data item classes over a second set of data item classes including each data item class associated with the retrieved benchmark set;
identify a third distribution of data item classes over a third set of data item classes including each data item class associated with the group of data items; and
generate a displayable format of the first distribution, the second distribution, and the third distribution.
